(19) United States
(12) Patent Application Publication
(10) Pub. No.: US 2005/0125318 A1
(43) Pub. Date: Jun. 9, 2005

(54) Methods and systems for accurately representing corporate financial results in light of equity-based compensation and contingent transactions

(76) Inventor: Joel Jameson, Los Altos, CA (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/000,489

(22) Filed: Nov. 29, 2004

Related U.S. Application Data
(60) Provisional application No. 60/525,638, filed on Nov. 29, 2003.
(60) Provisional application No. 60/532,590, filed on Dec. 24, 2003.
(60) Provisional application No. 60/535,724, filed on Jan. 9, 2004.
(60) Provisional application No. 60/538,653, filed on Jan. 22, 2004.
(60) Provisional application No. 60/582,882, filed on Jun. 26, 2004.

(51) Int. Cl. G06F 17/60

(52) U.S. Cl. 705/30

(57) ABSTRACT

A method to appropriately account for employee stock options is disclosed. The method is designed to handle all types of equity-based compensation. The current prior-art paradigm of expensing equity-based compensation is shown to be misguided, thus potentially misleading investors. Besides correctly accounting for equity-based compensation, the invention offers a simplier, more accurate method to account for financial contingencies. In conjunction with what is termed as variate Launching, the invention can be used for planning, deal evaluation, and employee-equity-based-compensation planning and evaluation. The invention entails computer simulation. A special procedure to generate log-normal random numbers that correctly models asset-value appreciation is also disclosed.

### CROSS REFERENCE TO RELATED APPLICATIONS

The present application is a continuation of Provisional Patent Application, Methods and Systems for Accurately Representing Corporate Financial Results In Light of Stock-Based Compensation, Ser. No. 60/467,592 filed on May 2, 2003.

The present application is a continuation of Provisional Patent Application, Methods and Systems for Accurately Representing Corporate Financial Results In Light of Stock-Based Compensation and Contingent Transactions, Ser. No. 60/525,638 filed on Nov. 29, 2003.

The present application is a continuation of Provisional Patent Application, Methods and Systems for Accurately Representing Corporate Financial Results In Light of Stock-Based Compensation and Contingent Transactions, Ser. No. 60/532,590 filed on Dec. 24, 2003.

The present application is a continuation of Provisional Patent Application, Methods and Systems for Accurately Representing Corporate Financial Results in Light of Stock-Based Compensation and Contingent Transactions, Ser. No. 60/535,724 filed on Jan. 9, 2004.

The present application is a continuation of Provisional Patent Application, Methods and Systems for Accurately Representing Corporate Financial Results in Light of Stock-Based Compensation and Contingent Transactions, Ser. No. 60/538,653 filed on Jan. 22, 2004.

The present application is a continuation of Provisional Patent Application, Methods and Systems for Accurately Representing Corporate Financial Results In Light of Stock-Based Compensation and Contingent Transactions, Ser. No. 60/582,882 filed on Jun. 26, 2004.

U.S. patent application Optimal Scenario Forecasting, Risk Sharing, and Risk Trading, Ser. No. 10/696,100 filed on Oct. 29, 2003; and filed as a PCT application on Nov. 24, 2003, Serial No.: PCT/US03/37553, both of which are hereby incorporated by reference for all that is disclosed therein and termed herein as PatSF.

### BACKGROUND TECHNICAL FIELD

This invention regards methods and computer systems for determining per share earnings, dividends, yields and other per share metrics and for determining aggregate corporate metrics in light of equity-based compensation and contingent transactions.

By reference, issued U.S. Pat. No. 6,032,123, Method and Apparatus for Allocating, Costing, and Pricing Organizational Resources, is hereby incorporated. This reference is termed here as Patent '123.

By reference, the following documents, filed with the US Patent and Trademark Office under the Document Disclosure Program, are hereby incorporated:

COMPUTER PROGRAM LISTING APPENDIX

| Title | Number | Date | Location |
|---|---|---|---|
| Employee/Executive Options | 503518 | Apr. 28, | USPTO |
| Expensing | | 2003 | |
| Option Pricing | 538422 | Sep. 12, | USPTO |
| | | 2003 | |
| Option Pricing II | 538800 | Sep. 18, | USPTO |
| | | 2003 | |
| Methods and Systems for | 520024 | Oct. 14, | USPTO |
| Accurately Representing | | 2003 | |
| Corporate Financial Results | | | |
| In Light of Stock-Base | | | |
| Compensation and Contingent | | | |
| Transactions - Draft I | | | |
| Methods and Systems for | 541855 | Nov. 13, | USPTO |
| Accurately Representing | | 2003 | |
| Corporate Financial Results | | | |
| In Light of Stock-Based | | | |
| Compensation and Contingent | | | |
| Transactions - Draft II | | | |

This application includes a computer program listing Appendix submitted on a Compact Disc (two copies). The file on each Compact Disc is named SourceCodeAppendix.ccp, has 159 kbytes, and contains source code written in C++ for the Microsoft Visual C++, Version 6.0, Development Studio. The information on the Compact Discs, including Appendix A, is incorporated herein by reference.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND DESCRIPTION OF PRIOR ART

Whether and how to expense employee stock options has been a controversial issue for many years and has recently come to renewed attention. The Financial Accounting Standards Board (FASB), which establishes accounting rules and procedures for the United States, has recently announced plans to require employee stock option expensing, beginning in June 2005. In response, the U.S. House of Representatives passed the Stock Options Accounting Reform Act, 312 to 111. The Senate has a similar bill. Over fifty Senators have written the Chairman of the SEC expressing concerns regarding FASB's intentions. Alan Greenspan, Chairman of the Federal Reserve System, has written Senator Levin requesting that the Senate not intervene regarding FASB's intentions. Various interests have formed public-relations consortiums regarding this matter. In the past two years, prominent academics have argued both for and against employee stock option expensing in the Harvard Business Review. The ferocity of the debate reflects the fact that both sides of the debate are partly correct, as well as incorrect in their arguments.

In fact, the ferocity of the debate reflects a serious flaw in current accounting theory and practice. As a result of this flaw, currently reported per share earnings and dividends are arguably misleading shareholders and investors. The error occurs because, when attempting to account for equity-based compensation, the current accounting paradigm misapplies the concept of opportunity cost, and fails to separate shareholder interests from the corporation's interests.

In the sub-section immediately below, the hypothetical case of the Soquel Corporation is presented to demonstrate how inaccurate per share earnings can result under current accounting theory and practice when equity-based compensation is expensed. The subsequent sub-sections regard deficiencies with FASB's proposal to expense employee stock options using the Black-Scholes, Binary, and Lattice Models (BBL Models), regard additional deficiencies with current accounting theory and practice, and regard deficiencies in current computer science techniques for generating random numbers.

Sections 6.4.4.1.1 and 6.4.4.2.1 present further demonstation of inaccuracies that can result from equity-based compensation expensing. This demonstration occurs elsewhere, because the present invention needs some introduction before making this case.

3.1. Problems with Expensing Equity-Based Compensation: Case of the Soquel Corporation

Historically, the balance sheet served as the principal financial statement. When investors started demanding “earnings power” metrics, accounting developed the income statement or statement of operations (the “P&L”). However, as will be shown shortly, current income statement procedures to account for equity-based compensation confuse opportunity cost with accounting cost and thus inaccurately represent corporate earnings power.

The hypothetical case of the Soquel Corporation demonstrates how, using current accounting methods, expensing equity-based compensation leads to inaccurate per share earnings estimates for Soquel's investors. The example begins with a balance sheet orientation, i.e., focusing on book value. It then proceeds to an earnings power orientation, i.e., focusing on “going concern”/GAAP earnings.

Before reviewing the hypothetical example of Soquel, consider the current theoretical basis for expensing equity-based compensation: namely, that equity compensation is treated as if it were a cash expenditure with corresponding costs to the corporation. That is, current practice assumes that, if a company sells shares and gives the proceeds to employees, then an expense has occurred; analogously, if the shares are given directly to employees, then the same expense has occurred. Though both cases are equivalent, current accounting methods fail to yield accurate earnings estimates for either. In essence, current and proposed GAAP methods to account for equity-based compensation fail to distinguish between the costs of equity-based compensation for the corporation versus the costs for the shareholders. Shareholders bear a dilution cost when equity-based compensation is used. For the corporation, however, equity-based compensation is actually costless: in the same way that a government can print and circulate money at zero cost, a corporation can print and circulate stock certificates at essentially zero cost. (As with a government, the only cost for a corporation of printing and circulating a large number of stock certficiates is the risk of sullying its reputation.) Current accounting practice of expensing equity-based compensation erroneously treats opportunity cost as an accounting cost, by assuming that opportunity cost diminishes realized gain—i.e., that when a corporation issues shares, there is an opportunity cost that reduces earnings. As our example will show, opportunity cost does not diminish any realized gain. So, for example, the hypothetical company Soquel could be considered to have three choices: A) give 6 shares to employees (as compensation); B) sell the 6 shares on the open U.S. market for $330; or C) sell the 6 shares on the Japanese market for ¥36,000. The opportunity cost of giving employees the 6 shares is $330 or ¥36,000. The opportunity cost of selling the 6 shares in the U.S. market is ¥36,000 or what might have been obtained from employees. At the end of the day, however, for the 6 shares, Soquel receives either A) employee services, B) $330, or C) ¥36,000. It does not obtain, say, employee services minus $330; similarly it does not obtain $330 minus ¥36,000. But this is the serious mistake that current accounting theory and practice makes.

Because opportunity cost does not diminish what a corporation actually gains or accomplishes in a period, to include equity-based compensation as an expense in the income statement understates actual corporate gains. The balance sheet reflects application of this principle, since under current GAAP, total shareholders' equity is unchanged after expensing for equity-based compensation.

For purposes of this example, assume that at the start of 2004, the hypothetical company Soquel was formed with assets and shareholders' equity of $5000, 100 outstanding shares, and a share price of $50.

Income Statement: Dec. 31, 2004

| | |
|---|---|
| Revenue | $800 |
| Costs | |
| Supplies | $225 |
| Depreciation | $150 |
| Total Cost | $375 |
| Gross Income (EarnCore) | $425 |
| Equity Expense (6 Shares @ 55) | $330 |
| (GAAP) Net Income | $95 |
| (GAAP) Per Share Earnings | $0.90 |

During 2004, as shown in the income statement above, Soquel has gross income of $425, which is termed here earnCore. This earnCore does not include any expensing for equity-based compensation. Soquel issues six new shares as equity-based compensation in 2004, and, by current standard accounting procedure, these shares are expensed as shown. (For purposes of this example, assume that the stock price has increased to $55. This is the end of period price, when the equity-based compensation is provided.) This yields GAAP net income of $95 and, dividing by share count (106), yields GAAP per share earnings of $0.90.

Balance Sheet: Dec. 31, 2004

| | GAAP |
|---|---|
| Assets | $5425 |
| Liabilities | |
| Equity | |
| Retained Earnings | $95 |
| Capital | $5330 |
| Total Equity | $5425 |

Soquel's assets increase to $5425, as shown in the balance sheet immediately above. Soquel, as an entity, has a net gain of $425 and bears no cost to issue the six new shares.

Book value is helpful as a starting point to consider this example. With gross income of $425 and the issuance of six additional shares, per share asset (book) value increases by $1.18 (see below). This is the indisputable accounting-oriented per share period gain for the shareholders. In comparison, GAAP per share earnings are 24% less. Hence, by this example, for tallying purposes, equity-based compensation expensing can lead to erroneous results.

| | | | Soquel | Per Share |
|---|---|---|---|---|
| | Outstanding | Share | Asset | Asset (Book) |
| | Shares | Price | Value | Value |
| 2003 | 100 | 50 | $5000 | $50.00 |
| 2004 | 106 | 55 | $5425 | $51.18 |

As stated before, the original purpose of the income statement was to reflect earnings power for investors. Equity-based compensation expensing can yield wildly inaccurate estimates of earnings power, as demonstrated by the resulting earnings numbers not being repeatable. If Soquel were to repeat 2004 operations, performance, and results in 2005, 2006, 2007, etc., using current accounting theory and practice, the income statements would be the same with net income at $95, except that per share earnings would continuously drop because of dilution. Respectively, for 2005, 2006, 2007, etc., per share earnings would be $0.85, $0.80, $0.75, etc. So, with existing methods, per share earnings drop over each period, while the actual corporate earnings remain constant.

Hence, the investor who relies on the $0.90 earnings as suggestive of earnings power is at risk of being seriously misled. Furthermore, as will be shown, Soquel's earnings power for the existing shareholders is significantly different from these $0.90, $0.85, etc. values obtained here with current accounting theory and practice.

3.2. Problems with Expensing Employee Stock-Options

By induction, the above analysis and case of the Soquel Corporation mean that the expensing of any type of equity-based compensation, where proportional shareholder interests may change, leads to inaccurate earnings. Employee stock option expensing meets this criterion and thus leads to inaccurate earnings.

For purposes of completion, however, it is helpful both now and later to also consider employee stock options more fully. Much of this disclosure is focused upon employee stock options because they are the current focus of national debate and because they are mathematically more general than restricted stock grants. Furthermore, because employee stock options have a contingent strike-price premium paid-in component, their analysis serves as solid foundation for considering contingent transactions not involving equity.

Given a decision to expense employee stock options, the method to be chosen for valuing employee stock options is also a major aspect in the controversy. The advocates of employee stock option expensing (including the FASB) almost unanimously argue in favor of using one of the BBL Models.

The major problem with all BBL Models is that they are meant for arbitrage purposes, wherein the arbitrageur initially, and also possibly simultaneously, sells short (buys long) government bonds, buys long (sells short) the underlying stock, and sells (buys) options when the prices of these three financial instruments are not properly aligned as calculated by the models. After the arbitrageur's initial three-way transaction, he waits—possibly only for seconds—for prices to move towards alignment, then liquidates or changes his positions/holdings. The arbitrageur's profits result from the initial misalignment in prices, and his profits are almost certainly vastly less than the option value as originally calculated.

Option value as calculated by the BBL Models is neither an intrinsic value, nor in fact a fair-value that a potential long-term holder of the option would pay. If risk-neutrality is assumed, then it is appropriate to consider expected-mathematical value. Because the mathematically-expected return for a stock is necessarily and theoretically higher than the risk-free interest rate, the BBL Models all underestimate the mathematically-expected value of stock options for a long-term holder. And conversely, if severe or infinite risk-aversion is assumed, then an option has zero value, unless the long-term holder is engaged in arbitrage.

A further problem with the BBL Models is that they fail to recognize the benefit that a company receives when, and if, cash is paid to the company upon option exercise. (For an arbitrageur who uses the BBL Models as they are meant to be used, the cash payment upon option exercise is transferred to others.)

Furthermore, it is difficult for privately held corporations to use the BBL Models, since the models require data (stock-price, volatility) that can be estimated accurately only if the corporation is publicly traded.

Because of these deficiencies, when any of the BBL Models are used to expense employee stock options, the resulting financial results reported to shareholders—and internally used within a business—are inaccurate. Such inaccuracies lead to poor investment decisions, which ultimately leads to sub-optimal functioning of the economy.

3.3. Accounting for Contingent Transactions

Though the issue of expensing employee stock options is perhaps the most critical issue facing the accounting profession today, it is perhaps merely the first in a series of major issues regarding contingent transactions that accounting will be increasingly confronted with as businesses become more adept at structuring contracts that address contingent terms.

For some types of contingent transactions, businesses calculate and use mathematically-expected values as credits and debits, largely as individual accounting entries. To correctly calculate mathematically-expected values, however, can require consideration of statistical correlations, which can be particularly difficult given today's accounting atomistic “linear algebra” worldview. Though financial analysts can create ad hoc spreadsheet models to consider correlations to estimate mathematically-expected values, such models are outside of both current accounting theory and current computer-accounting systems. When multiple financial analysts each create their own spreadsheet models, they are likely to do so independently and hence correlations between the financial analysts are likely not to be considered. In finance departments, unorganized spreadsheet propagation is a major problem and results in inefficiencies and errors. Unfortunately, many financial departments are unable to accurately estimate mathematically-expected values due to staff limitations as regards to training and availability. Further complicating the issue of calculating mathematically-expected values is the recent emphasis on performance based rewards, in which compensation—be it either equity or cash—is made contingent upon certain quantified goals being met, such as increasing sales by 50%, increasing production by 20%, or having The Corporation's stock price out-perform the S&P 500 Index.

A centralized approach to determine mathematically-expected values—while considering correlations—would be helpful to both to the company and to investors.

A further problem with both existing accounting theory and accounting computer-application systems is that by focusing on mathematically-expected values as credit and debit entries, no account is made, nor can be made, of the statistical distribution of these credits and debits. Though risk is the primary driver in finance, investors are left with point estimates of statistical financial distributions regarding The Corporation. In time, more and more pressure will manifest to have companies report financial numbers, in particular earnings, as statistical distributions.

3.4. Accounting for Defined Benefit Pension Plans

Accounting for defined benefit pension plans has always presented problems for accounting. In this type of situation, a company invests funds as part of a retirement plan, on the expectation that the invested funds will sufficiently appreciate to cover future pension liabilities. There is uncertainly regarding the appreciation of the invested funds and uncertainty regarding the liabilities.

One problem is accounting for unusual changes in the value of the invested funds. If the value suddenly appreciates, the corporation has benefited, but should the extra value be included in reported earnings? On the one hand yes, since the corporation has gained. On the other hand no, since such a gain is likely to be subsequently reversed and the purpose of reported earning is to reflect earnings power for investors. Inclusion of such a gain—a random value—distorts earnings.

The current solution to this problem of unusual changes in investment-find value is to amortize each year's unusual gains and losses over subsequent years. This, however, still distorts the reported earnings of subsequent years.

With these distortions, investors are possibly misled. The investor who lacks the sophistication and knowledge to mathematically correct for these distortions—i.e., the small investor—is particularly likely to be misled.

3.5. Terminal Equilibrium Conditions

Frequently in financial analysis, forecasts are made that entail terminal periods. Such terminal periods are assumed to be equilibriums, e.g., a company has reached maturity. The problem is that though such terminal periods might be relevant for a corporation, they might not necessarily relevant for shareholders. This is because the terminal periods may entail equity-based compensation expensing which, as previously discussed under current methods, leads to inaccurate earnings. In other words, with equity-based compensation expensing, terminal equilibrium conditions/values for a corporation are not necessarily terminal equilibrium conditions/values for shareholders.

3.6. Log-Normal Random Number Generation

For simulating financial and economic variates, the predominantly used statistical distribution is the log-normal distribution. The Black-Scholes option valuation model, for instance, assumes this statistical distribution, as does much of modern financial theory.

One well known problem is that Actual (see Glossary) financial variates tend to revert to long-term means, which contradicts the premise of true independent randomness of the log-normal distribution.

More important, however, is the Inflated-Compounding Problem as discussed below.

3.6.1. Inflated-Compounding Problem

The problem with using the log-normal distribution in computer simulations is what is termed here as the Inflated-Compounding Problem.

The Inflated-Compounding Problem is a natural outcome of the difference between using a geometric versus an arithmetic mean. Given a set of heterogeneous numbers, it can be proved mathematically that the arithmetic mean is necessarily greater than the geometric mean. If random numbers are generated to yield a desired geometric mean, then the arithmetic mean of these numbers will be larger than the desired geometric mean. If the random numbers are in turn used in a manner analogous to calculating an arithmetic mean, then the results will reflect a mean value greater than that suggested by the geometric mean. As this applies in the present context, if a log-normal random number generator were used to simulate stock-prices, then the overall appreciation resulting from multiple stock purchases and sales would be too large. This excess is termed here as the Inflated-Compounding Problem.

This is demonstrated in FIGS. 1A, 1B, and 1C. FIG. 1A shows eight stock-prices for Periods 0 through 7. By defining “Factor” as the current stock-price divided by the previous stock-price, the seven Factors as shown in the figure are obtained. Taking the natural logs of these Factors yields the values shown in FIG. 1A, which have an arithmetic mean of 0.095 and a sigma (standard deviation, volatility) of 0.200. This sigma was calculated using 7, rather than 6, in the denominator when doing the sigma calculation: Generally, here, n rather than n−1 is used in the standard formula to calculate sigma, because of a presumption of working with a population, rather than a population sample. Together, this mean and sigma define a log-normal distribution.

Returning to the seven Factors, FIG. 1A shows that they have a geometric mean of 1.1 (the log of which equals 0.095). This geometric mean suggests that in some average sense, the stock appreciates by 10.0% in each period. But as shown in FIG. 1A, the arithmetic mean of the seven factors is 1.123. Hence, one measure indicates that the stock appreciates by 10.0% in each period, while a different measure indicates that the stock appreciates by 12.3% in each period. Which is the correct appreciation to use? Arguably it is the 10.0%, since the 10.0% best fits the data from beginning to end: the Cumulative Trend Factor column ([E]) shows the results of cumulatively multiplying by 1.1, while the Trend Stock-price column ([F]) shows the result of multiplying these cumulative Factors by the original stock-price of 28.224. The last number of the Trend Stock-price column (55.000) ties with the last number of the Stock-price column (55.000). If the 1.123 were used instead of the 1.100, the last entry in the Cumulative Trend Factor column would be 2.252 (1.123⁷), which would result in the last entry in the Trend Stock-price column being 63.573—which is greater than the 55.000. The excess of 63.573 over 55.000 is a manifestation of the Inflated-Compounding Problem.

The Inflated-Compounding Problem manifests, in part, because of the difference between using the geometric versus the arithmetic means. Geometric mean is, and should be, used for investment appreciations purposes, since it addresses the issue of compounding.

The Inflated-Compounding Problem particularly manifests when generating random log-normal values. For example, the 0.095 mean and 0.200 sigma were used as inputs to a log-normal random number generator that yielded 1.0M, 3.0M, and 7.0M values. The average of the 1.0M values was 0.095 as shown in FIG. 1B and these values had a standard deviation of 0.200—exactly what would be expected. However, applying the exponential function to each of these values (applying the anti-log function) converted them into Factors, the mean of which was 1.122. Each of these Factors was multiplied by the original stock-price of 28.224 to obtain a simulated stock-price for the first period of 31.666 (1.122*28.224), which is higher than the Trend Stock-price of 31.046. This is another manifestation of the Inflated-Compounding Problem. If one million simulated single period share-prices were used to calculate the value for a Period 0 investment in Period 1, then the result would erroneously be an average appreciation of 12.2%, rather than 10.0%.

The 3.0M randomly-generated log-normal values were combined into sets of 3 and the values in each set were summed to yield 1.0M values. As would be expected and as shown in FIG. 1B, the mean of these 1.0M values was 0.286 and they had a standard deviation of 0.347. These 1.0M values were converted into Factors, the mean of which was 1.413. Multiplying the individual factors by the stock-price of 28.224 yielded an average simulated third period stock-price of 39.879. Again, this is higher than the Trend Stock-price (37.566) and another manifestation of the Inflated-Compounding Problem. Yet again, if one million simulated third period share-prices were used to calculate the value of a Period 0 investment in Period 3, then the result would erroneously be an average appreciation of 41.3%, rather than 33.1%.

Combining the 7.0M randomly-generated log-normal values yielded the results shown at the bottom of FIG. 1B. As before, if the one million simulated 7^{th} period share-prices were used to calculate the value of a Period 0 investment in Period 7, then the result would erroneously be an average appreciation of 124.1%, rather than 94.9%.

The Inflated-Compounding Problem occurs when mapping values from the log space to values in the Factor space: though values are symmetric about the mean in the log space, they are skewed upwards in the Factor space. This is shown in FIG. 1C where Histogram 101 shows a distribution of the first one million randomly-generated log-normal values, with a mean of 0.095 and a sigma of 0.200. Note the symmetry of the distribution. Histogram 103 shows the distribution obtained by applying the exponential function to each log-normal value. The distribution has a mode of about 1.1, but because the right tail is skewed (as a result of applying the exponential function), the mean is greater than 1.1, namely 1.122.

As a result of the Inflated-Compounding Problem, randomly-generated log-linear numbers that are converted into Factors and that are used in an arithmetic fashion have an upward bias, which can distort computer simulations—even to the extent of rendering simulation results absurd.

3.6.2. Correlated Random Number Generation

The correlation square-root-matrix method can be used to generate correlated random numbers. However, it is not suitable to generate small, stratified samples. See Richardson, James W., Steven L. Klose, and Allan W. Gray, “An Applied Procedure for Estimating and Simulating Multivariate Empirical (MVE) Probability Distributions In Farm-Level Risk Assessment and Policy Analysis,” Journal of Agricultural and Applied Economics, 32, 2, Aug. 2000, p 299-315 for an explanation of the correlation square-root-matrix method.

### SUMMARY OF THE INVENTION

Accordingly, besides the objects and advantages of the present invention described elsewhere herein, the objects and advantages of the present invention are to:
Develop a method to correctly account for all types of equity-based compensation.
Develop a method to consider variable correlations and correctly account for all types of pending, contingent transactions.
Resolve the issue of whether and how to expense employee stock options.
Develop a method to account for employee stock options using realistic and available assumptions.
Develop a method to account for employee stock options that is easily customizable.
Develop a method to account for employee stock options that is applicable for non-publicly traded corporations.
Develop an accounting-complement method to 1) address risk and uncertainty, 2) connect performance and reward, and 3) handle contingent events.
Develop a method to facilitate calculating mathematically-expected values and statistical distributions for contingent transactions.
Develop a method to resolve the Inflated-Compounding Problem so that accurate simulations can be performed.
Develop a method to generate stratified, correlated random numbers.
Develop a method to generate log-normal random numbers with mean revision.

Additional objects and advantages will become apparent from a consideration of the ensuing description and drawings.

The basis for achieving these objects and advantages, which will be rigorously defined hereinafter, is accomplished by programming one or more computer systems as disclosed. The present invention can operate on most, if not all, types of computer systems. A computer system, programmed as disclosed herein, constitutes one embodiment of the present invention.

4.1. Primer: Case of the Soquel Corporation Resolved

To help develop an intuitive perspective on how the present invention determines per share earnings and dividends, a few preliminary remarks are in order, as well as applying the present invention to the case of the Soquel Corporation previously introduced.

Reference-shareholders are the shareholders as of the start of the current accounting period. This invention calculates per share earnings and dividends for them, as of the end of the accounting period, in this case Dec. 31, 2004. Whether individual Reference-shareholders transfer their shares is immaterial, except in special circumstances that do not apply to the case of Soquel.

The calculation strategy for per share earnings and dividends can be best understood with an analogy. Suppose someone wants to determine the thickness of a piece of paper, which is all but impossible using normal rulers. But if 200 similar sheets were stacked upon one another and their aggregate thickness determined, then algebra could be used to infer the thickness of a single sheet. Here calculating earnings employs a similar strategy: the current period is duplicated say 200 times, the duplicates are appended to form a series or chain, and average earnings generated for the Reference-shareholders over time is determined. Continuing the analogy, sheet thickness randomly varies, as do many of the variables used for calculation. While, in fact, the period after the current period will almost certainly be different, assuming that it will be the same in our analysis provides an unbiased starting point for calculation. The purpose here is not to speculate about future performance, but rather to offer a clear view of earnings power as demonstrated in the current period—or, using our paper analogy, to obtain an accurate measurement of the thickness of the original sheet of paper.

While repeatability is not normally considered in accounting, it is taken for granted in the sciences. If nature were not repeatable, then the sciences could not exist. Many scientific measurements are based upon a statistical sample. In other words, rather than measuring a single phenomenon, a sample is taken and an average or mean value is calculated and used for analysis. The present invention computer generates samples using the basic concepts of modem financial theory and these samples become the basis for per share earnings determination. Using phenomena duplication is a strategy used in the medical sciences vis-a-vis culturing a sample. The initial sample is allowed/encouraged to replicate and then the totality analyzed. As in the sciences, repeatability analyzed within a totality can provide more accurate insights than atomistic evaluation.

As previously stated, Soquel has $425 in gross income, which is termed here as earnCore. The $425 earnings are Hicksian and are paid in full as dividends. (This is possibly the simplest case to apply the present invention.)

Soquel's 2004 results are duplicated over the measured period (analogously, 200 sheets of paper). In other words, Soquel has $425 as earnCore for years 2005 through 2203 as shown immediately below. In order to obtain the $425 earnCore in 2004, a 6% equity-interest in Soquel was given as compensation. Again, for years 2005 through 2203, Soquel gives the same 6% equity interest as compensation, and thus the number of shares outstanding will increase as shown. In this vein, Soquel continues to pay the $425 as dividends, which when spread over an ever increasing number of shares, results in per share dividends as shown below.

| | | | | | Reference |
|---|---|---|---|---|---|
| | | | | Present | Share |
| | EarnCorp/ | Outstanding | Per Share | Value | Present |
| Year | Dividends | Shares | Dividend | Factor | Value |
| 2003 | | 100 | | | |
| 2004 | $425 | 106 | $4.01 | 1.00 | $4.01 |
| 2005 | $425 | 112 | $3.78 | 0.90 | $3.40 |
| 2006 | $425 | 119 | $3.57 | 0.81 | $2.89 |
| 2007 | $425 | 126 | $3.37 | 0.73 | $2.45 |
| . | . | . | . | . | . |
| . | . | . | . | . | . |
| . | . | . | . | . | . |
| 2102 | $425 | 32,010 | $0.01 | 0.00 | $0.00 |
| 2103 | $425 | 33,930 | $0.01 | 0.00 | $0.00 |
| . | . | . | . | . | . |
| . | . | . | . | . | . |
| . | . | . | . | . | . |
| 2202 | $425 | 10,860,934 | $0.00 | 0.00 | $0.00 |
| 2203 | $425 | 11,512,590 | $0.00 | 0.00 | $0.00 |
| Sum | | | | | $26.56 |
| | | | | | 10% |

| | |
|---|---|
| SSEq Earnings/Dividends | $2.66 |

Calculations require as a parameter the Reference-shareholder discount rate, which is assumed here to be 10%. (Later, this discount rate will be a parameter.) Accordingly, because this calculation is as of Dec. 31, 2004, per share dividends are discounted by multiplying by the factors shown in the Present Value Factor column to obtain the Reference Share Present Value column. This column sums to $26.56. Given an asset with this present value and the 10% discount rate, the asset would be expected, on average, to yield $2.66 yearly.

This $2.66 is the Steady-state per share earnings power for the Reference-shareholders. As shown below, in its annual and quarterly reports, the hypothetical company Soquel shows $2.66 as per share earnings, alongside, or instead of, currently reported basic and diluted earnings. Soquel also reports dividends of $4.01 for 2004, along with dividends of $2.66. (In this particular example, earnings equal dividends, so Steady-state per share dividends are $2.66 also.) Investors would use these results in the same way that they use currently reported per share earnings and dividends when equity-based compensation is absent: namely for evaluating Soquel's earnings and dividend-payment powers.

| Amounts In Dollars | 2004 |
|---|---|
| Net Sales | 800 |
| Net Income | 425 |
| Per Common Share | |
| Steady-state Earnings | 2.66 |
| Dividends | |
| Paid | 4.01 |
| Steady-state | 2.66 |

Assuming that the current accounting period perpetually repeats, then the Reference-shareholders are in the same financial position, whether Soquel a) has equity-based compensation of 6% and Steady-state earnings of $2.66, or b) has no equity-based compensation and GAAP earnings of $2.66. Accounting periods usually do not perpetually repeat, but if they did, then one would expect that earnings power in the future would prove constant with the current period.

For the investor who purchases a stock based on its PE-ratio (price-to-earnings ratio)—the most basic investment criterion—the present invention provides unbiased earnings power estimates. If such an investor's implicit assumption that the status quo will continue proves correct, then the investor's expectations will be met. As previously demonstrated regarding the $0.90 per share Soquel earnings, current methods of expensing equity-based compensation fail this repeatability test. If the investor's implicit assumption proves incorrect, then at least the present invention yielded an unbiased estimate of earnings power.

For all investors, the present invention provides what is needed: a per share earnings power metric in light of equity-based compensation. The original purpose of the income statement—and the per share earnings calculation first used in the 1920s—is thus served.

### BRIEF DESCRIPTION OF THE DRAWINGS

The invention will be more readily understood with reference to the accompanying drawings, wherein:

FIGS. 1A, 1B, and 1C demonstrate the Inflated-Compounding Problem;

FIGS. 2A, 2B, 2C, and 2D show the relationship between shareholders' expectations/demands and The Corporation's performance;

FIG. 3A shows the analytical splits of The Corporation employed by the present invention;

FIG. 3B shows the reinvestment index being identical to the Shareholder-floor Index;

FIG. 4 shows the time-line employed by the present invention;

FIGS. 5A and 5B show some parameters and compounding levels used in the Elaborate Example;

FIG. 6 shows the Elaborate Example parameters used in the four introductory illustrative cases;

FIG. 7A shows shareholder terminal value when all earnings are paid as dividends;

FIG. 7B shows Reference-shareholder proportional ownership;

FIGS. 8A and 8B show both the start and end of the worksheet used to generate FIGS. 7A and 7B, and demonstrates the problem with using a stock-price in expensing;

FIG. 9A shows shareholder terminal value when all earnings are retained; FIG. 9B shows Reference-shareholder proportional ownership;

FIGS. 10A and 10B show both the start and end of the worksheet used to generate FIGS. 9A and 9B, and demonstrate the problem with using a Stock-price in expensing;

FIG. 11A shows shareholder terminal value when both all earnings are retained and when The Corporation's receiving paid-in strike-price premiums can constitute an advantage for the Reference-shareholders; FIG. 11B shows Reference-shareholder proportional ownership;

FIG. 12 shows both the start and end of the worksheet used to generate FIGS. 11A and 11B;

FIG. 13A shows shareholder terminal value under five scenarios when Stock-options exercise is stochastically simulated; FIG. 13B shows Reference-shareholder proportional ownership under the five scenarios;

FIG. 14A shows a high-level flowchart;

FIG. 14B shows a Contingent Stock Cash Leg (CSCL) being defined, noting simulation data, and loading an scTrans object, which in turn affects simulation data;

FIG. 15 shows CSCLs having extantStarts before, during, and after Period 0, and spanning multiple periods;

FIGS. 16 and 17 show a high-level flowchart regarding multiple scenarios being generated, CSCLs operating, Steady-state values being calculated, and results being passed to other routines for subsequent handling;

FIG. 18 shows the general sequence used to generate random numbers, which in part determines scenario data;

FIG. 19 shows target means, sigmas, and log-correlations for the Elaborate Example;

FIG. 20 shows a normal distribution curve being stratified-sampled;

FIG. 21A shows an initial stratified-sample; FIG. 21B shows the results after improving correlation goodness-of-fit;

FIG. 22A shows scaling to obtain shFloor;

FIG. 22B shows determining a correction for the Inflated-Compounding Problem;

FIGS. 23A, 23B, 23C, and 23D show determining and applying Delta-shift to yield Arc-appreciations;

FIG. 24 shows an application of Arc-appreciations;

FIG. 25 shows the calculation of log-correlations;

FIG. 26 shows the Delta-shifts for appreciation-over-times 1 through 7;

FIG. 27 shows the application of Arc-appreciations for generating earnCoreBase;

FIG. 28 shows the correlation between earnCoreBase and shFloor;

FIG. 29 shows 128 randomly-generated earnCoreBase Scenario-paths;

FIGS. 30A and 30B show the Scenario-paths of various reinvestments;

FIG. 31 shows the application of Arc-appreciations to yield correlated reinvestment Scenario-paths that have end-to-end mean-appreciations equal to shFloor_MeanAppreciation;

FIG. 32 shows FIG. 31 data in Factor graphical format;

FIG. 33 shows applying the third row of FIG. 31 to obtain the Scenario-path for a 794.271 reinvestment made in Period 2;

FIG. 34A shows the calculations to obtain corpScalePrice, based upon earnCoreBase; FIG. 34B shows the calculations to obtain corpScalePrice, based upon assets minus liabilities;

FIGS. 35A and 35B show a full set of scenario data, along with postings by a CSCL that is duplicated seven times;

FIG. 36 shows time-phased data of a single CSCL that is duplicated seven times;

FIG. 37 shows the OrientInit and DoActivity functions of the CSCL_Call class;

FIG. 38 shows the DoLiquidation01 function of CSCL_Call;

FIGS. 39A and 39B show two schedules, both of which need to be cleared in liquidation equilibrium;

FIG. 39C shows liquidation equilibrium levels;

FIG. 40 shows determining liquidation equilibrium levels;

FIG. 41 shows the diminishment of a maximal CSCL transaction;

FIG. 42 shows earnCoreBase means for twelve scenarios and the overall mean as a result of weighting;

FIG. 43A shows a plot of earnCoreBase means for twelve scenarios, before weightings; FIG. 43B shows a histogram after weighting;

FIG. 44 shows the steps, which are iterated, to set scenario weights;

FIG. 45 shows launching variates being disturbed and associated calculations;

FIG. 46 shows the DoActivity function of the CSCL_GrantTrea class;

FIG. 47 shows the DoActivity function of the CSCL_GrantPur class;

FIG. 48 shows the OrientInit and DoActivity functions of the CSCL_{—}2xBk class;

FIG. 49 shows the OrientInit and DoActivity functions of the CSCL_Sales class;

FIG. 50 shows the OrientInit and DoActivity functions of the CSCL_Pension class;

FIG. 51 shows the DoActivity function of the CSCL_Hedge class;

FIG. 52 shows the DoActivity function of the CSCL_JVent class;

FIGS. 53A and 53B show the DoActivity function of the CSCL_CEO class;

FIGS. 54A and 54B show example CSCL data stored in relational database format;

FIG. 55 shows the time-phased relationship amongst earnCore, earnCoreBase, and earnCoreCntg;

FIG. 56 shows a possible computer system on which the present invention can operate;

FIG. 57 shows major conceptual computer-system elements of the present invention;

FIG. 58 shows a very high-level flowchart of the operation of the present invention;

FIG. 59 lists pre-set parameter values;

FIG. 60A presents sample input for the present invention;

FIG. 60B presents sample output results of the present invention; and

FIG. 61 shows the points of comparison between the BBL Models and the present invention as regards to stock options.

### DETAILED DESCRIPTION OF THE INVENTION

6.1. Outline

1. Background Technical Field
2. Cross Reference To Related Applications
3. Background Description of Prior Art
3.1. Problems With Expensing Equity-Based Compensation: Case of the Soquel Corporation
3.2. Problems with Expensing Employee Stock-Options
3.3. Accounting for Contingent Transactions
3.4. Accounting for Defined Benefit Pension Plans
3.5. Terminal Equilibrium Conditions
3.6. Log-normal Random Number Generation
3.6.1. Inflated-Compounding Problem
3.6.2. Correlated Random Number Generation
4. Summary Of The Invention
4.1. Primer: Case of the Soquel Corporation Resolved
5. Brief Description Of The Drawings
6. Detailed Description Of The Invention
6.1. Outline
6.2. Introduction
6.2.1. Introductory Remarks
6.2.2. Elaborate Example
6.2.3. Glossary
6.3. Economic Theory of the Invention
6.3.1. Employee Stock-options—A Corporate/Shareholder Expense?
6.3.1.1. Stock-options as Two Components
6.3.1.1.1. Share Issuance—Almost Economically Costless for The Corporation
6.3.1.1.2. Receipt of Paid-in Strike-price Premiums—A Clear Economic Benefit
6.3.1.2. Implications of Stock-options as Two Components for The Corporation
6.3.1.3. Employee Stock Options as a Corporate Opportunity Cost
6.3.1.4. Implications for Reported Aggregate Corporate Earnings
6.3.1.5. Impact on Shareholders: Positive? or Negative?
6.3.2. Steady-state Per Share Earnings
6.3.3. Shareholder-floor Index
6.3.4. EarnCore, DividendCore, Reinvestment
6.3.5. Log-normal Random Numbers
6.4. Mathematical Theory of the Invention
6.4.1. Introductory Remarks
6.4.2. Timeline/Accounting Periods
6.4.3. Elaborate Example Default Parameters
6.4.4. Additional Example Cases (AEC)
6.4.4.1. AEC #1: All Earnings Paid as Dividends
6.4.4.1.1. Further Demonstration of Prior-Art Inaccuracy
6.4.4.2. AEC #2: All Earnings Reinvested
6.4.4.2.1. Further Demonstration of Prior-Art Inaccuracy
6.4.4.3. AEC #3: Reference-shareholders Directly Benefit from Options Plan
6.4.4.4. AEC #4: Incorporation of Stochastic Considerations
6.4.5. Simulation Overview
6.4.5.1. Contingent Stock-Cash Leg (CSCL)
6.4.5.2. Simulation Flow
6.4.5.3. Legacy CSCLs
6.4.5.4. RepeatPeriod
6.4.6. Simulation Elements
6.4.6.1. Log-normal Random Number Generation
6.4.6.2. Arc-appreciations
6.4.6.3. Theorem
6.4.6.4. EarnCoreBase Generation
6.4.6.5. Investments/Reinvestments
6.4.6.5.1. Simple Investments
6.4.6.5.2. Corporate Reinvestments
6.4.6.6. Stock-price Simulation
6.4.6.7. Internal Corporate Scale-variates
6.4.7. Simulation Unification
6.4.7.1. Master-driver-variate Generation
6.4.7.2. EarnCoreBase/dividendCore Generation
6.4.7.3. Initialization
6.4.7.4. CSCL Creation and Loading
6.4.7.5. Period 0 Closing
6.4.7.6. Open Period
6.4.7.7. CSCL DoActivity
6.4.7.8. Close Period
6.4.7.9. CSCL Duplication
6.4.8. Calculate Reporting Aggregates
6.4.8.1. Steady-state Earnings
6.4.8.2. Steady-state Dividends
6.4.8.3. Liquidation01
6.4.8.4. Forward/Look-back Calculations
6.4.9. Variance Control
6.4.9.1. Sample Size
6.4.9.2. EarnCoreBase Alignment
6.4.10. Corporate Internal Planning and Valuation
6.4.11. External Forecasted Earnings
6.4.12. CSCL Member Functions and Operations
6.4.12.1. Structure
6.4.12.2. Example CSCLs
6.4.12.2.1. CSCL_GrantTrea
6.4.12.2.2. CSCL_GrantPur
6.4.12.2.3. CSCL_{—}2xBk
6.4.12.2.4. CSCL_Sales
6.4.12.2.5. CSCL_Pension
6.4.12.2.6. CSCL_Hedge
6.4.12.2.7. CSCL_JVent
6.4.12.2.8. CSCL_CEO
6.4.13. CSCL Multi-Period Alignment
6.4.13.1. Period Spanning
6.4.13.2. EarnCoreBase, EarnCoreCntg, EarnCore, and CSCLs
6.4.14. Comparison with BBL Model Valuation Expensing
6.5. Example Embodiment
6.6. Conclusion, Ramifications, And Scope
7. Claims
8. Abstract
   6.2. Introduction
   6.2.1. Introductory Remarks

Much of this disclosure is focused upon employee stock options because they are the current focus of national debate and because they are mathematically more general than restricted stock grants. Furthermore, because employee stock options have a contingent strike-price premium paid-in component, their analysis serves as solid foundation for considering contingent transactions not involving equity.

Following this introductory section, there are three major sections:
6.3. Economic Theory of the Invention—presents the economic theory of the present invention. The discussion builds upon standard economic theory and constitutes the foundation for further development.
6.4. Mathematical Theory of the Invention—presents the mathematical theory of the invention and discusses the invention's elements. This is the largest section, which has its own introductory remarks section.
6.5. Example Embodiment—introduces the source code that is included on a CD (Compact Disc™ [Sony trademark]) as a part of the present disclosure.

The general flow in this document is from qualitative concepts, to quantification and methods, and finally to software embodiment.

“The Corporation” is an entity that is the subject of the present invention. It can be a publicly traded corporation or a closely- (privately-) held corporation; it can also be a business partnership, cooperative, a non-profit corporation, or other type of organization, assuming sufficient parallels to what is described here. For expository convenience, much of the discussion here is in reference to “The Corporation.”

“Reference-shareholders” are the common stock holders as of the start of the Actual current period, Period 0. The present invention is mainly concerned with determining per share earnings and dividends for these Reference-shareholders using their perspective, as of the end of Period 0. (See Glossary for more details.)

Pseudo code is based on the C++ programming language. In this specification and in the accompanying drawings, only the most salient considerations and code-segments are presented and may constitute a simplified version of what is shown in the source code. The reader is referred to the accompanying source code, written in C++, for a more detailed specification. Some points are discussed here but are not included in the source code. Other points are included in the source code but are not discussed here.

All data tables were formatted using Microsoft Excel. Besides being labeled with expository descriptions, columns are labeled “[A]”, “[B]”, “[C]”, . . . . Spreadsheet-like formulas are provided at the tops of some columns. Operator “\hat{ }” is a power operator, e.g., 2\hat{ }3=8. Subscripts to the “[ ]” identifier usually reference the relative row, though they can reference an absolute row: the orientation is self-evident. Occasionally, this nomenclature is used in a reverse manner, where “[A]”, “[B]”, “[C]”, . . . reference rows rather than columns.

Most mathematical calculations, including those shown as examples, were done using 64 bits of precision. Hence, results might not reproduce exactly when only the shown digits of precision are used.

6.2.2. Elaborate Example

This teaching is accomplished by presenting an Elaborate Example implementation in sections 6.4 and 6.5. Since employee stock options are the present focus of national interest, and since stock options are one of the more mathematically general types of equity-based compensations, this teaching will tend to focus on employee stock options. Though the general implication here is that the counter-party receiving the equity-based compensation is always an employee, the counter-party, in fact, could be any type of legal entity, e.g., a raw materials supplier.

The Elaborate Example presented here goes beyond employee stock options to demonstrate handling other types of equity-based compensation and contingent transactions.

The Elaborate Example consists of four Master-driver-variates, nine CSCLs (Contingent Stock-Cash Legs), three Scale-variates, and various supporting computer-programmed objects.

The four Master-driver-variates are as follows:
Shareholder-floor Index—a special index that will be described in detail.
IndIndex—hypothetical Industry Index.
SP500—Standard and Poor's 500 Stock Price Index.
WWP—hypothetical World Widget Production Index.

The Master-driver-variates are log-normal random variates and are generated prior to most calculations. They directly or indirectly, drive and affect almost all calculations.

The nine CSCLs are as follows:
CSCL_Call—for employee stock (call) options.
CSCL_GrantTrea—for treasury stock grants.
CSCL_GrantPur—for open-market-purchase stock grants.
CSCL_{—}2xBk—for employee stock purchases.
CSCL_Sales—for sales-growth-based bonuses.
CSCL_Pension—for define-benefit pension plans.
CSCL_Hedge—for a hedge strategy.
CSCL_JVent—for modeling a joint venture.
CSCL_CEO—for a custom CEO incentive plan.

The three Scale-variates are as follows:
Revenue
IWP—hypothetical internal widget production index.
Number of employees.

Scale-variates are necessarily internal to The Corporation and typically represent internal-operations metrics.

Of the four Master-driver-variates, nine CSCLs, and three Scale-variates, only the Shareholder-floor Index is required in the preferred implementation of the present invention. Depending upon the circumstance, the other three Master-driver-variates, nine CSCLs, three Scale-variates, and supporting computer-program objects can be used or not used, imitated or not imitated, adapted or not adapted as deemed appropriate.

Furthermore, given the present teaching, appropriate similar additional Master-driver-variates, CSCLs, Scale-variates, and supporting objects can be developed and used in an implementation of the present invention. These three Master-driver-variates, nine CSCLs, Scale-variates, and supporting computer-program objects should not be construed as limitations on the scope of the present invention; but rather, as an exemplification of a preferred embodiment thereof.

The major advantage with the Master-driver-variate and CSCL framework presented here is that random variate generation and correlation handling is separated from calculating intermediate and final contingent results. As a consequence, such calculations are ultimately much simpler to program for execution on a computer.

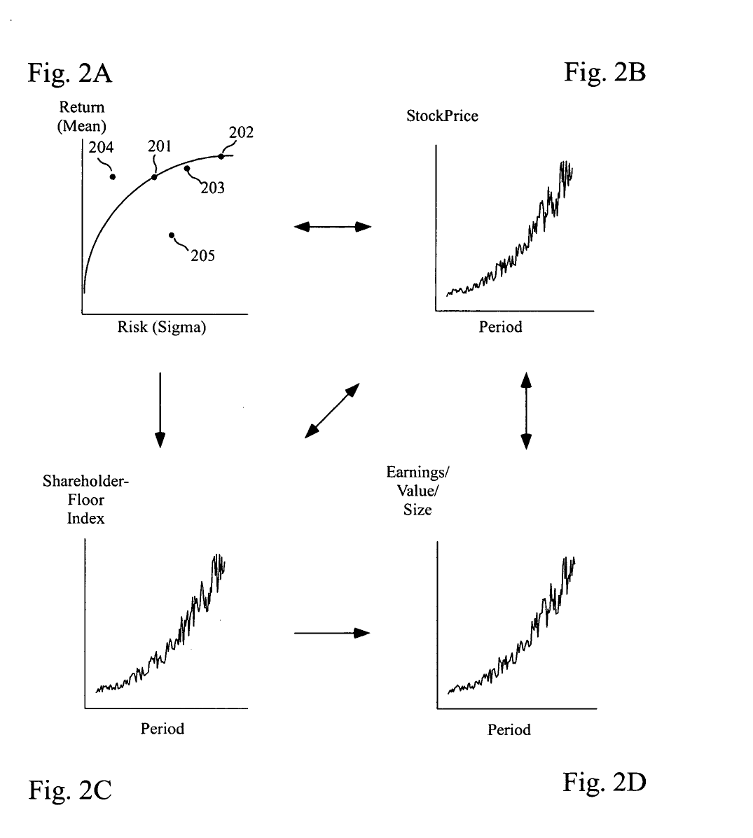

6.2.3. Glossary

| Term | Definition |
|---|---|
| Actual | An adjective. References an objective or |
| | subjective datum or circumstance that is |
| | exogenous to the present invention. |
| aml | A variable. Represents the abbreviation of |
| | standard accounting term: assets minus |
| | liabilities. a.k.a. AmL and shareholders' equity. |
| Anchoring | A transformation. Scaling a set of deviates to |
| | have a desired geometric mean. |
| aPeriod | A variable. Represents an accounting period. |
| | Also APeriod. Ranges from 0 to nPeriod-1, |
| | inclusive. See iPeriod. |
| Arc-appreciation | A transformation. A random variate's |
| | appreciation between two periods that reflects a |
| | correction for the Inflated-Compounding Problem. |
| BBL Models | Black-Scholes, Binary, and Lattice Models - |
| | for option valuation. |
| Cal01LiquidationEquilibrium | A function. Determines equilibrium share-price |
| | should liquidation occur between Periods 0 and 1. |
| Company (with capital C) | The Corporation. It can also be a business |
| | partnership, cooperative, a non-profit |
| | corporation, or other type of organization, |
| | assuming sufficient parallels to what is |
| | described here as regards The Corporation. |
| Corp_CSCL_Ag_Charge | An output variable of SSCal stored in SSBuf. In |
| | the event that Steady-state earnings cannot be |
| | conveniently reported, Corp_CSCL_Ag_Charge |
| | can be used as a P&L charge; this results in per- |
| | share earnings that are Steady-state per share |
| | earnings and that are based upon the number of |
| | outstanding-shares at the end of Period 0. |
| corpScale | A variable. Represents an index of The |
| | Corporation's scale, determined by reinvestment |
| | and corpScalePrice. Determines Scale-variate levels. |
| corpScalePrice | A variable. Represents the required investment |
| | to increment corpScale by one unit. |
| CSCL | Contingent Stock Cash Leg. A generic C++ |
| | class object. Simulates both contingent stock |
| | and/or contingent cash transactions. All CSCL |
| | sub-classes are derived from CSCL_Base. |
| CSCL_2×Bk | A CSCL class. Models employee stock |
| | purchases and buy-backs based upon pricing |
| | shares at twice book value. |
| CSCL_Base | Base class for CSCLs. Provides general CSCL support. |
| CSCL_Call | A CSCL class. Models employee stock option calls. |
| CSCL_CEO | A CSCL class. Models an extensive incentive |
| | package given to a CEO. |
| CSCL_GrantPur | A CSCL class. Models employee stock grants, |
| | assuming that The Corporation makes open |
| | market purchases of granted shares. |
| CSCL_GrantTrea | A CSCL class. Models employee stock grants, |
| | assuming that The Corporation issues granted |
| | shares from its treasury. |
| CSCL_Hedge | A CSCL class. Models a hedging strategy |
| | employed by The Corporation. |
| CSCL_JVent | A CSCL class. Models a joint venture. |
| CSCL_Pension | A CSCL class. Models a defined-benefits pension plan. |
| CSCL_Sales | A CSCL class. Models a sales-bonus incentive plan. |
| Delta-shift | A variable. Cumulative sums of log-normal |
| | deviates are decremented by Delta-shift so that |
| | when the exponential function is applied, the |
| | resulting values have an arithmetic mean equal |
| | to the original geometric mean. This is done to |
| | correct for the Inflated-Compounding Problem. |
| dividendCore | A variable. Represents dividends declared by |
| | the core business. In Perpetual-repetition, it is |
| | a fixed proportion of earnCoreBase. |
| Distribution | See statistical distribution. |
| DoActivity | A CSCL member function. Triggers transactions |
| | (posted to a SCTrans object) in each accounting |
| | period that the CSCL is extant. |
| DoLiquidation01 | A CSCL member function. Determines CSCL |
| | liquidation transactions, given a stock-price. |
| dot-product | Common mathematical operation entailing |
| | multiplying corresponding elements of two |
| | vectors and summing the mathematical products. |
| earnCore | A variable. Represents earnings of core business. |
| | Equals what is normally termed “net income” |
| | for The Corporation in Period 0, but without |
| | any expensing for equity-based compensation. |
| | Hicksian earnings: i.e., earnings that can be |
| | paid-out to common shareholders. Consists of |
| | two components: earnCoreBase and earnCoreCntg. |
| earnCoreBase | A variable. Represents earnings of core |
| | business that are not handled by a CSCL. |
| | Generally non-contingent earnings. |
| earnCoreBaseMean | A variable. Overall, unweighted, mean of |
| | earnCoreBase across all nScenarios and nPeriods-1. |
| earnCoreBaseMean_Scen | A vector. Contains the raw mean of |
| | earnCoreBase in each scenario. |
| earnCoreBaseMeanWt | A variable. Overall, weighted, mean of earnCoreBase |
| | across all nScenarios and nPeriods-1. |
| earnCoreCntg | A variable. Represents earnings of core |
| | business that are handled by CSCLs. Generally, |
| | contingent earnings. |
| earnCoreCntg_Scen | A vector. Contains the value of earnCoreCntg |
| | in each scenario. |
| earnReInvest | A variable. Represents current period's |
| | reinvestment earnings. |
| Equity-based compensation | Legal consideration given by The Corporation |
| | as part of a contract, that is associated with, |
| | consists of, or might consist of, an equity in The |
| | Corporation. Includes stock appreciation rights, |
| | restricted and unrestricted stock grants, stock |
| | options, stock issued in exchange for cash, |
| | warrants, and the like. |
| Equity-interest holder | Entity that owns equity-based compensation. |
| | e.g. stockholder; holder of options or stock |
| | appreciation rights issued by The Corporation. |
| extantEnd | A variable. Represents aPeriod in which a |
| | CSCL is last extant/active. |
| extantStart | A variable. Represents aPeriod in which a |
| | CSCL first becomes extant/active. |
| Factor | A more recent price divided by an older/prior |
| | price. Usually one period's price divided by the |
| | previous period's price. A more recent level |
| | divided by an older prior level. |
| Forward/Look-back | A perspective from the distant future (i.e., |
| | period nPeriod-1, terminal period) looking back |
| | to Period 0. |
| fwLkB_OutstandingShares | A variable. Represents Forward/Look-back, |
| | outstanding shares. For the Reference- |
| | shareholder, from the perspective of the distant |
| | future (terminal period, nPeriod-1) looking |
| | back, each Reference-share constitutes a: |
| | 1.0/fwLkB_OutstandingShares |
| | proportional interest in The Corporation. |
| fwLkB_PS_BkValPost | A variable. Aml, as of the end of Period 0, |
| | divided by fwLkB_OutstandingShares. |
| fwLkB_PS_iWP | A variable. Internal widget production, divided |
| | by fwLkB_OutstandingShares. |
| fwLkB_PS_Revenue | A variable. Represents Period 0 revenue/ |
| | fwLkB_OutstandingShares. |
| GAAP | An acronym. Generally accepted accounting procedures. |
| GetArcAppreciationDivReInvest | A function. Returns an Arc-appreciation of a |
| | stock, assuming that dividends are reinvested in |
| | additional shares. |
| GetArcAppreciationNoDividend | A function. Returns an Arc-appreciation of a |
| | stock, assuming that dividends are not received |
| | or reinvested, but rather given to others, who |
| | can be and are ignored. |
| GetSD (Get Standard Deviation) | A function. Returns the standard deviation of an |
| | accumulated series of numbers, using “n-1” as the |
| | denominator in the standard statistical formula. |
| GetSDInf(Get Standard Deviation | A function. Returns the standard deviation of |
| Infinite) | an accumulated series of numbers using “n”, |
| | rather than “n-1”, as the denominator in the |
| | standard statistical formula. |
| IndIndex | A hypothetical log-normal random variate. An |
| | index of The Corporation's industry. What it |
| | regards is not material here. It could regard |
| | sales, profitability, capacity, or other variates. |
| Inflated-Compounding Problem | Given a set of log-normal random deviates and |
| | after applying the exponential function (ex), the |
| | resulting set has an arithmetic mean that is |
| | greater than the geometric mean. Assuming that the |
| | resulting geometric mean is what is sought, to use |
| | the resulting set to simulate the appreciation of a |
| | variate results in the appreciation, on average, |
| | being excessive, which is termed here as the |
| | Inflated-Compounding Problem. |
| iPeriod | A variable. Represents internal period within a |
| | CSCL. When a scenario is being simulated, |
| | aPeriod is an index representing the current |
| | simulated accounting period. iPeriod is relative |
| | to aPeriod and is an offset. The advantage is |
| | that a CSCL can be written (programmed) with |
| | reference to when an agreement for a contingent |
| | transaction is first made, irrespective of the |
| | aPeriod. |
| IWP | A variable. Represents The Corporation's |
| | internal widget production. |
| k^{th} Parties | Third parties that are not central to the |
| | calculations of the present invention - other |
| | than their impacts on The Corporation and in |
| | turn the interests of the Reference-shareholders. |
| Launch | To launch a variate is to specify one or more |
| | variate values. These specified values are |
| | randomly disturbed and used in a simulation. |
| Level | Analogous to price, quantity, index-value, |
| | and/or monetary value, depending upon context. |
| | Used here, as is sometimes done in investment |
| | circles to facilitate exposition. |
| Liq01Trans | A simplification of class SCTrans. Used for |
| | determining liquidation stock-prices. |
| liquidation01_Ag_AmL | A variable. Represents the aggregate value of |
| | assets minus liabilities, should liquidation occur |
| | between Periods 0 and 1. |
| liquidation01_OutstandingShares | A variable. Represents the number of |
| | outstanding-shares should liquidation occur |
| | between Periods 0 and 1. |
| liquidation01_PS_iWP | A variable. Internal widget production, divided |
| | by number of shares in Liquidation01. |
| liquidation01_PS_Revenue | A variable. Revenue, divided by number of shares |
| | in Liquidation01. |
| liquidation01_StockPrice | A variable. Represents liquidation clearing- |
| | equilibrium stock-price, i.e., |
| | liquidation01_Ag_AmL/liquidation01_OutstandingShares. |
| log-correlation | A correlation calculation based upon Factors. |
| | Entails calculating the natural logs of such |
| | Factors, and then applying the standard |
| | statistical correlation formula. FIG. 25 shows an |
| | example calculation. |
| Master-driver-variates | Log-normal random variates; generated prior to |
| | most calculations. They directly or indirectly, |
| | drive and affect almost all calculations. |
| MIS | An acronym. Management information system. |
| nCSCL | A variable. Represents number of CSCLs. |
| nPeriod | A variable. Represents number of accounting periods per |
| | scenario. |
| nScenario | A variable. Represents number of scenarios in a simulation. |
| nShares | A variable. Represents number of shares. |
| OrientInit | CSCL function. Orients and initializes the class-instance. |
| outstandingSharesRestricted | A variable. Represents number of restricted outstanding- |
| | shares. Is included/aggregated in outstandingShares. |
| P&L | Accounting term. Profit and loss statement; a.k.a. |
| | income statement. |
| paraCSCL_corpScaleType_ReInvest_AmL | A defined parameter. Used to set corpScalePrice. |
| | 1 = basis of reinvestment; 2 = basis of AmL. |
| paraCSCL_minShareTransactionProporation | A defined parameter. Minimum share |
| | transaction proportion. Used to set nPeriod. |
| paraCSCL_standardErrorAsProportionofMean | A defined parameter. Used to set nScenario so |
| | that the expected standard error of termValWhole, |
| | as a proportion of the expected mean of termValWhole, |
| | is less than this defined parameter. |
| paraCSCL_trialSampleSize | A defined parameter. Trial sample size for a |
| | simplified simulation used to determine nPeriod |
| | and nScenario. |
| paraLnRnd_fitAddSubtract | A defined Boolean parameter. If TRUE, then |
| | stratified normal deviates vectors are added |
| | together to yield desired correlations. |
| paraLnRnd_fitBubble | A defined Boolean parameter. If TRUE, then |
| | stratified normal deviates are swapped in a pair- |
| | wise manner to yield desired correlations. |
| Perpetual-repetition | In the scenario simulations, The Corporation's |
| | core business perpetually repeats. Both |
| | earnCoreBase and contingent agreements (as |
| | handled by CSCLs) are perpetually repeated for |
| | nPeriod-1 periods and are subjected to |
| | stochastic disturbances. Reinvestments are |
| | made based upon positive and negative cash |
| | flows and are tracked separately. This leads to |
| | terminal values that are used to determine |
| | Steady-state earnings and other metrics. |
| Probabilistic-classification | Using scaled log-normal deviates to determine, |
| | within a simulation, whether an event has occurred. |
| Reference-shares | A variable. Represents common-stock shares owned |
| | by Reference-shareholders. |
| Reference-shareholders | Common stock holders of The Corporation at |
| | the start of Period 0. The present invention |
| | assumes their perspective. Such shareholders |
| | may transfer their interests, which may or may |
| | not be tracked by the present invention: the |
| | former case occurs when Reference-shareholders |
| | sell some of their interest back to The Corporation; |
| | the latter case occurs when Reference-shareholders |
| | sell (assign) some of their interest to parties |
| | distinct and outside of the preview of the present |
| | invention. If The Corporation makes an open market |
| | purchase or open market sale, such a transaction |
| | is handled on a pro-rated basis, wherein the |
| | Reference-shareholders proportionately participate |
| | in the transaction. |
| reInvestAtRepeatPeriod | A vector. Contains projected reInvestNets by |
| | period, for periods subsequent to repeatPeriod. |
| | Used to prevent reInvestNet from incorrectly |
| | including reinvestments made prior to repeatPeriod. |
| reInvestNet | A variable. Represents the current value of |
| | reinvestments in aPeriod. Reflects appreciations and |
| | depreciations of reinvestments made prior to aPeriod. |
| repeatPeriod | A variable. Represents the period being |
| | perpetually repeated. |
| rShCumDividend_PV | A variable. Represents Present-value, |
| | Reference-shareholder cumulated dividend, for |
| | Periods 0 through nPeriod-1. |
| rShCumDividend_Scen | A vector. Contains Reference-shareholder |
| | Cumulative Dividend. |
| rShCumEoDividend_PV | A variable. Represents cumulative present-value |
| | of extraordinary dividends paid by The Corporation |
| | and received by the Reference-shareholders. These |
| | extraordinary dividends occur when The Corporation |
| | makes an open market purchase of its shares. |
| | An open market purchase (sell) of The Corporation's |
| | shares by The Corporation can be pro-rated between |
| | the Reference-shareholders and the non-restricted/ |
| | non-Reference-shareholders. Proceeds flowing to |
| | Reference-shareholders, via open market purchases, |
| | are cummulated in rShCumEoDividend_PV. |
| rShDiscount | A variable. Represents cumulative, Reference- |
| | shareholder discount. |
| rShOutstandingShares | A variable. Represents number of Reference- |
| | shareholder outstanding-shares. |
| rShProportion | A variable. Represents Reference-shareholder proportional |
| | ownership, i.e., rShOutstandingShares/outstandingShares. |
| rShProportion_Scen | A vector. Contains Reference-shareholder |
| | Proportional Ownership. |
| rShPVTermToEternityDividend | Reference-shareholder, present-value, terminal |
| | period to eternity dividend. |
| | The present-value of an infinite series of: |
| | rShProportion * dividendCore |
| | starting in period nPeriod, where rShProportion |
| | is as of nPeriod-1. |
| rShTerminal_PV | A variable. Represents terminal present-value |
| | of the Reference-shareholders' interest in The |
| | Corporation. Includes rShCumDividend_PV. |
| rShTerminalPv_Scen | A vector. Contains Reference-shareholder Terminal |
| | Present-value. |
| rSh_FwLkB_Proportion | A variable. Forward/Look-back Reference- |
| | shareholder proportional interest in The |
| | Corporation in Period 0. Same as Reference- |
| | shareholder proportional interest in terminal |
| | period, i.e. nPeriod-1. |
| Scale-variates | Variates internal to The Corporation that |
| | linearly scale according to corpScale. (Constant |
| | economies of scale are assumed.) In the Elaborate |
| | Example presented here, Scale-variates are revenue, |
| | IWP, and number of employees. |
| Scenario-path | A time-series scenario or path that a variate |
| | follows. FIG. 2B shows a Scenario-path for a |
| | stock price. A Scenario-path can be based upon |
| | Actual data, or it can be based upon randomly- |
| | generated data. |
| ScenStep | An object. Contains scenario data. |
| SCTrans | A class. Transfers stock and cash from and to |
| | The Corporation and k^{th} Parties. |
| scTransNet | SCTrans class instance. Contains the net of all |
| | transactions for aPeriod. |
| scTransPeriod0 | SCTrans instance. Contains the transactions for |
| | Period 0 that are neither contained in CSCLs nor |
| | in other initializing data. |
| Shareholder-floor Index | A variable. Represents an index representative |
| | of shareholder demands/expectations of The |
| | Corporation. Is generated based upon |
| | shFloor_MeanAppreciation and shFloor_Sigma. |
| | Used to generate random disturbances to |
| | earnCoreBase and to calculate reinvestment |
| | appreciations. Abbreviated as shFloor. |
| shFloor | A variable. See Shareholder-floor Index. |
| shFloor_Discount | A variable. Represents discount factor employed by |
| | shareholders. |
| shFloor_MeanAppreciation | A variable. Represents mathematically expected |
| | return demanded by shareholders. |
| shFloor_Sigma | A variable. Represents tolerated sigma (volatility) |
| | in return demanded by shareholders. |
| Sigma | A mathematical term and a variable. Synonymous |
| | with standard deviation and volatility. |
| SP500 | An acronym. Standard and Poor's 500 Stock Price Index. |
| SSBuf | Steady-state buffer class. Contains input (and |
| | output) for (and generated by) SSCal. |
| SSCal | Master function. Calculates Steady-state values |
| | and other metrics. |
| Statistical distribution | Any of the formal theoretical statistical |
| | distributions such as normal, binomial, etc. |
| | Any empirical distribution, which consists of a |
| | set of empirical observations regarding a |
| | variate. No differentiation between a theoretical |
| | and empirical distribution is made here. |
| | Occasionally called simply “distribution.” |
| Steady-state | Methodolgy of present invention. Accounts for |
| | equity-based compensation and contingent transactions. |
| steadyState_Ag_Dividend | A variable. Represents Steady-state aggregate earnings; |
| | aggregate earnings for all Reference-shareholders. |
| steadyState_Ag_Earnings | A variable. Represents Steady-state aggregate earnings; |
| | aggregate earnings for all Reference-shareholders. |
| SteadyState_PS_Dividend | A variable. Represents Steady-state per share dividend. |
| SteadyState_PS_Earnings | A variable. Represents Steady-state per share earnings. |
| SteadyState_PS_PERatio | A variable. Represents Steady-state per share price- |
| | to-earnings ratio. |
| SteadyState_PS_Yield | A variable. Represents Steady-state per share yield, |
| | i.e., SteadyState_PS_Dividend/stock-price |
| surrenderProbability | A variable. Represents the probability that a k^{th} |
| | party will surrender an interest as modeled by a CSCL. |
| termValWhole | A variable. Represents the value of The Corporation at |
| | nPeriod-1. |
| Tie | Accounting term. Means equal, match, congruent. |
| The Corporation | The entity that is the subject of the present |
| | invention. Can be a publicly traded corporation |
| | or a closely- (privately-) held corporation. Can |
| | also be a business partnership, cooperative, or a |
| | non-profit corporation, or other type of |
| | organization, assuming sufficient parallels to |
| | what is described here. |
| TSEarnDiv | Time-series Earnings Dividends class. Generates |
| | simulated earnCoreBase and dividendCore. |
| TSlsp | Time-series Long/Short Position class. Simulates |
| | the value of positions in a financial instrument. |
| | Such positions can either be long or short. |
| TSlspFP | Time-series Long/Short Position Funnel Point |
| | class. Same as TSlsp, except that the return |
| | from any period to Period nPeriod-1 equals the |
| | mean expected return. |
| TSSeq | Time-series Sequence. Simulates a log-normal variate. |
| TSStockPrice | Time-series Stock-price class. Simulates The |
| | Corporation's stock-price, considering the |
| | effects of dividends. |
| VecLDbl | A vector class. Contains floating-point values. |
| Weight_Scen | A vector. Contains the weight assigned to each scenario. |
| WWP | A variable. Represents World Widget Production. |
| XIndex | A generic index-variate. Used for expository |
| | convenience and used to explain various |
| | functioning, particularly Arc-appreciations. |
| | Inclusive of shFloor. |

(Note that in printing the above table, a definition can span two pages.)
6.3. Economic Theory of the Invention

Sub-section, 6.3.1, will reconsider concepts and considerations previously presented, but now in regards to employee stock options. The previous conclusions and implications are affirmed. Afterwards, various economic theory considerations needed by the present invention are presented in sub-sections 6.3.2 through 6.3.5.

6.3.1. Employee Stock-options—A Corporate/Shareholder Expense?

Within this section, there are five major sub-sections:
6.3.1.1. Stock-options as Two Components—Separates a stock option into two components and briefly introduces the implications of each for both The Corporation and for shareholders.
6.3.1.2. Implications of Stock-options As Two Components for The Corporation—Discusses the implications of the first sub-section for The Corporation.
6.3.1.3. Corporate Opportunity-cost—Refutes the well-used opportunity cost based arguments for expensing stock options.
6.3.1.4 Implications for Reported Aggregate Corporate Earnings—Discusses the implications of the first sub-section for calculating and reporting corporate earnings.
6.3.1.5. Impact on Shareholders: Positive? or Negative?—Discusses the implications of the first sub-section for shareholders.

In order to keep the exposition simple, employee stock options are assumed to be given to motivate employees to work long hours. (In common practice, stock options are given for many reasons.)

The first issue that needs to be addressed is whether the granting of employee stock options constitutes an expense for The Corporation. The answer is “No”!

6.3.1.1. Stock-Options as Two Components

The first step to seeing that stock options do not constitute an expense for The Corporation is to analytically split a stock option into two elemental components: the eventual issuance of shares by The Corporation and the receipt by The Corporation of paid-in strike-price premiums.

6.3.1.1.1. Share Issuance—Almost Economically Costless for The Corporation

Perhaps the simplest perspective to see that share issuance is almost economically costless for The Corporation is to make an analogy with governmental sovereignty. In an analogous way that a government can print and distribute currency (money, legal tender), The Corporation can print and distribute stock certificates. The immediate cost for each is simply the printing costs, which can be ignored. (Printing costs are zero if the printers are compensated with a portion of what they print.)

More formally, from the theoretical perspective of the present invention, The Corporation can issue (i.e., put into circulation) any number of additional shares, and thus increase the total number of outstanding-shares—almost with impunity. Such issuance scarcely imposes any economic sacrifice or forbearance: The Corporation can do almost anything that it would have otherwise done. The only limiting consideration for The Corporation in issuing a potentially infinite number of additional shares is the risk of sullying its reputation: If The Corporation is perceived as being unfair to some shareholders, then both existing and potential shareholders might be reluctant to own and buy shares. Such reluctance may hinder, at a future date, The Corporation's ability to raise additional capital.

So, for example, consider three cases:
Case A1: The Corporation, as part of a stock split, issues an additional share in complement to each previously issued outstanding share. Both the shareholders and The Corporation are economically unaffected.
Case A2: The Corporation, as part of a stock split, issues an additional share in complement to each previously issued outstanding share. The shareholders sell half their shares to others. The circumstance of The Corporation is economically unaffected.
Case A3: The Corporation doubles the number of outstanding-shares by issuing shares to multiple previously-uninterested parties, but receives no value in exchange. The circumstance of The Corporation is economically unaffected.

In all three cases, The Corporation is economically unaffected by the issuance of additional shares: It can do whatever it would have otherwise done, except that the previously mentioned limiting consideration comes into play in Case A3. In this case, the original shareholders simply and immediately lose half their interest in The Corporation. Since they have been (unfairly) hurt, they and others will be reluctant to directly invest in The Corporation in the future.

Hence, with the exception of risking sullying its reputation, The Corporation can issue additional shares with impunity, and without any sacrifice or forbearance—in other words, it can issue additional shares at zero cost to itself.

(Shareholders' Rights, a body of law, explicitly combats variations on Case A3. The necessity of this type of law supports the argument that The Corporation can issue additional shares at almost zero cost to itself. Historically, schemes benefiting some interests at the expense of some shareholders often are a variate of Case A3. Arguably, the alleged abuses of employee stock options in the 1990s are simply new and sophisticated variations on Case A3.)

6.3.1.1.2. Receipt of Paid-in Strike-Price Premiums—A Clear Economic Benefit

The other component of the stock option is the paid-in strike-price premiums paid upon exercise. Clearly, this is a benefit for The Corporation, since it represents an unencumbered infusion of cash. Since The Corporation is benefiting, the shareholders also benefit.

6.3.1.2. Implications of Stock-Options as Two Components for The Corporation

Given that options are exercised, the stock component is almost costless for The Corporation and that the paid-in strike-price premium is a benefit, The Corporation only economically gains as a result of stock options!

Apart from the analysis thus far presented, The Corporation's gains are further enhanced since in exchange for the stock options, The Corporate also receives additional value, e.g., employees who work longer hours.

6.3.1.3. Employee Stock Options as a Corporate Opportunity Cost

Some argue that stock options entail an opportunity cost and consequently such costs should be expensed on the P&L. So, for instance, suppose that The Corporation grants employees stock options covering 5 shares for long hours. Further, suppose that the open market price for these options is $28. It is correct to say that granting the options had an opportunity cost of $28, since $28 could have been obtained on the open market. From this, some people argue that the options should therefore be expensed at $28. These people sometimes reformulate the argument as follows: The Corporation could have sold the options for $28, incremented paid-in capital by $28, given the $28 to employees, and then finally expensed the $28 given to employees. They go on to conclude that therefore the granting of the stock options constitutes an expense of $28.

As will be shown, these arguments to expense the options at $28 constitute both an incorrect usage of opportunity cost and constitute a failure to differentiate between the economist's and the accountant's costs.

Adapting Adam Smith's, the 18^{th} Century founder of economics, best known example regarding opportunity cost, consider a hunter who has a choice between getting a deer or a beaver on a day's hunt. The hunter faces no risk or uncertainty: either a deer or a beaver is always obtained. If at the start of the day the hunter decides to seek a deer, the hunter has foregone hunting a beaver and thus has an opportunity cost of losing a beaver. If at the start of the day the hunter decides to seek a beaver, the hunter has foregone hunting a deer and thus has an opportunity cost of losing a deer. As an economic decision making tool, it is correct to think: deer for the (opportunity) cost of a beaver, versus/or beaver for the (opportunity) cost of a deer. However, once the hunter has committed to a decision, say, to seek a deer, the opportunity cost vanishes: The hunter can no longer seek a beaver. At the end of the day, however, the hunter does get the deer.

The hunter does not get a deer minus a beaver. But concluding that the hunter does get a deer minus a beaver is the analogous but erroneous conclusion drawn by those that argue for expensing stock options based upon opportunity cost. When The Corporation sells the five options on the open market, it gets $28; when it gives the five options to employees, it gets long employee hours. In the former case, it does not get $28 minus long employee hours; in the latter case, it does not get long hours minus $28. (James Buchanan, 1986 winner of the Nobel prize in Economics, makes this specific point—that opportunity cost vanishes once a course of action is decided.)

Historically, accounting has focused on determining and recording cash transactions or equivalents, has focused on attempting to align revenue with costs by accounting period (matching), and has, most importantly, focused on creating and maintaining an historical record. Its methodology and results can be used for decision making that might entail ad hoc opportunity cost calculations, but such calculations—except peculiarly for equity-based compensation—are never included in permanent accounting records that are maintained per GAAP. This is because accounting is focused on creating and maintaining an historical record. In isolation, accounting makes no attempt to optimize the future. The concept of opportunity cost, however, is applicable only when a decision regarding future actions is being formulated and optimized. After the decision is made, a previously calculated opportunity cost is irrelevant. Hence, to include opportunity costs in accounting records is to include data that is fundamentally not compatible with traditional accounting data.

Consider the one last remaining argument: The Corporation could have sold the options for $28, incremented paid-in capital, given the received $28 to the employees, and then finally expensed the $28. To use this $28 to argue for expensing also constitutes a failure to distinguish between the economist's and the accountant's cost. Assuming that the options are initially sold for $28, from a simplistic accounting perspective, the $28 arguably should be expensed. From an economic perspective and from the perspective of The Corporation, however, there is no cost and only a gain: the receipt and pay-out of $28 cancels, and The Corporation gets the long hours from its employees.

Somewhat ironically, accounting also indirectly recognizes the $28 cancellation: when an option sale is made, the $28 is entered as an increment to paid-in capital. Expensing naturally hits the P&L, which in turn reduces shareholder's equity. Hence, the net impact on the balance sheet is zero.

6.3.1.4. Implications for Reported Aggregate Corporate Earnings

Given the above analysis, the present invention prescribes that corporations should not expense employee stock options when calculating and reporting net corporate earnings.

For creditors, potential creditors, suppliers, potential suppliers, customers, and potential customers, the existence of employee stock options is largely irrelevant. These entities are concerned with the corporation as a whole and are mainly concerned as to whether it can handle its obligations. For them, including employee stock options as an expense in corporate financial reports only diminishes the usefulness of such reports. Including paid-in strike-price premiums in cash flow statements, however, would be useful.

6.3.1.5. Impact on Shareholders: Positive? or Negative?

In Case A3 above, the original shareholders clearly lost: they lost half of their interest in The Corporation. Hence, employee stock options, because they include a stock issuance (dilution) component, can be undesirable for shareholders.

However, the paid-in strike-price premium component of stock options is clearly desirable for shareholders. Conceivably, if the paid-in strike-price premium is sufficiently large, then it could more than compensate for the loss resulting from the stock issuance or dilution.

Hence for the shareholders, there is a tension between the tradeoffs of dilution and increased valuation. Shareholders lose proportional interest when stock is issued (dilution). Shareholders gain by way of the Corporation increasing in value from 1) paid-in strike-price premiums, and 2) the option-basis contributions made by stock option recipients (which increases valuation). The former is negative for the shareholders, while the latter is positive; the balance between the two is contingent upon the particulars of the situation.

The present invention calculates Steady-state earnings and other metrics to reveal the net effects of these two considerations for the Reference-shareholders to yield an “earnings power” perspective.

6.3.2. Steady-State Per Share Earnings

Newton's First Law of Motion states:
Every object in a state of uniform motion tends to remain in that state of motion unless an external force is applied to it.

Here, it is argued that human perception and expectation is analogous: as a first approximation, a person assumes that what has immediately occurred will roughly continue to occur. After this first approximation, a person may consider “external forces” to modify the assumption that what has immediately occurred will roughly continue to occur.

As this applies in the present context, upon learning of a Corporation's per share earnings, a person's first assumption is that the given per share earnings will approximately repeat. The person may subsequently modify the assumption by considering his or her world-view—considering “external force is applied” to the given per share earnings.

The present-day language of investment supports this argument. Investors (brokers, et. al.) speak of a stock's yield—the latest dividend divided by the current share-price. Such a datum, however, would be useless were it not assumed that the same dividend would be paid again—and that the stock-price would remain the same for the immediate future. Investors also speak of the price-to-earnings ratio—stock-price divided by current earnings—and this too would be a useless datum were it not assumed that what immediately occurred will roughly continue to occur, subject to “external forces.” Stated differently, a stock's yield and price-to-earnings ratio are reference points from which future estimates are frequently based.

Accounting's philosophy of depicting a business “as a going concern” also supports this argument, since “going concern” implies continuation of the status-quo. (Traditionally, accounting has focused on “going concern” and explicitly dismissed speculative forecasts of what the future may be.)

The history of accounting also supports this argument. During the 19^{th} Century in the United States, the balance sheet was the primary financial statement. Investors started to demand “earnings power” metrics and as a consequence, the income statement or statement of operations (the P&L) was developed, starting in the early 20^{th} Century, as was the per share earnings calculation. The purpose was to depict a company's ability to generate earnings for shareholders.

Accordingly, the present invention transforms aggregate corporate earnings into per share earnings, such that if what occurred in the current accounting period is perpetually repeated—subject to certain considerations—the assumption that the given per share earnings will approximately perpetually repeat is valid. Stated differently, the present invention transforms aggregate corporate earnings into per share earnings that reflect per share “earnings power.” Such per share earnings are termed here as Steady-state per share earnings. Analogously, Steady-state per share dividends are also determined. The “subject to certain considerations” entails two aspects: first, that many variates are subject to stochastic disturbances, and second, that The Corporation continues to perform at a minimum level as dictated by the shareholders. Computer simulation is used to model the Perpetual-repetition and do the necessary calculations.

Steady-state earnings and dividends are useful for monitoring The Corporation and for comparing The Corporation with other corporations. The concept of Steady-state is like representing a business “as a going concern,” which is a goal of accounting.

Assuming a present-value orientation, these resulting Steady-state per share earnings and Steady-state dividends are fully compatible, and logically comparable, with per share earnings and dividends obtained when employee-stock options and other types of equity-based compensation are absent.

Steady-state metrics provide a basis for accurately comparing per-share interests between corporations. This is the main benefit of the present invention.

Steady-state, in regards to equity-based compensation accounting, is very different from current accounting methods that attempt to determine mathematically-expected, or arbitrage, values—using for instance the BBL Models—and then using such values as an expense. Steady-state considers equity-based compensation to be costless for a corporation, and hence the current procedures to expense of equity-based compensation inappropriate. However, there is a financial impact on current shareholders of equity-based compensation, which the present invention accounts for, from the perspective of the Reference-shareholders.

One of the main advantages of the present inventions is side-stepping many of the arcane and complex aspects associated with current and proposed methods to account for equity-based compensation.

Part of the task of shareholder monitoring is to decide whether to liquidate The Corporation, by perhaps selling it as a whole or in parts. In traditional accounting, it is per share book value that helps shareholders decide whether to liquidate a corporation. However, contingent obligations undermine the accuracy of per share book value. This issue is addressed by what is termed here as Liquidation01, which calculates liquidation value for each common share for the point in time between Periods 0 and 1. Besides Liquidation01, shareholders frequently use additional per share metrics to monitor their investments. As with per share book value, the accuracy of these additional per share metrics can be undermined by contingent obligations. This is addressed here by the concept of Forward/Look-back, which computes current numbers from the perspective of a distant future (terminal period, nPeriod−1) perspective looking back. Relative to Steady-state earnings and dividends, Liquidation01 and Forward/Look-back are simple to explain and will be explained in detail later.

6.3.3. Shareholder-floor Index

For now, The Corporation is assumed to be publicly traded, retain all earnings, and not issue any additional shares. Later, these assumptions will be changed.

As is well and generally accepted, in market equilibrium, investors face a trade-off between risk and return (reward): higher risk yields higher reward. Assuming at least a rough market equilibrium, the relationship between the two can be plotted as shown in FIG. 2A. This curve is known as the Efficiency Frontier (a.k.a. the Investment Opportunity Set or the Capital Market Line). Empirically, it tends to have the shape shown. For the purposes of the operation of present invention, what is important is that The Corporation can be modeled with the two parameters of mean (return) and sigma (risk), also known as mean/variance in financial literature.

Since, for the moment, The Corporation is assumed to be publicly traded, it may be characterized by a point on the Efficiency Frontier, say Point 201.

The Efficient Market Hypothesis states that the price of a publicly traded stock reflects a highly accurate assessment of The Corporation and its prospects. Hence, the stock-price is highly correlated with The Corporation's present and future earnings/value/size (assuming constant economies of scale) as shown in FIGS. 2B and 2D. (Here, FIGS. 2B and 2D, depending on context, contain either conceptual or historic data, or contain randomly-generated data depicting a possible future scenario.) Assuming FIG. 2B represents historic data, such data can be used to determine or estimate Point 201 of FIG. 2A.

Much of current economic and financial theory assumes that shareholders and potential shareholders are quite passive in the management of their companies: they are assumed to either hold, buy, or sell the company's stock. Hence, causality goes from FIG. 2D to FIG. 2B to FIG. 2A.

But to at least some extent, shareholders can, and have the full legal right to, oversee and control their corporations. From the perspective of the present invention, the shareholders demand that The Corporation perform in a manner aligned with Point 201 and the shareholders will not tolerate any future-expected performance that is substandard to Point 201. In the event that future-expected performance falls short of Point 201, say Point 205, the shareholders will demand company restructuring and/or liquidation, so that they can, again, return to a future-expected performance that is aligned with Point 201. The shareholders are assumed to be sufficiently vigilant that when future-expected performance falls short of Point 201, the shortfall is quite small and generally within shareholder expectations. Once such a shortfall occurs, the shareholders will demand company restructuring and/or liquidation.

Point 205 is clearly inferior to Point 201, since Point 205 entails both higher risk and lower return. Point 202 is also inferior to Point 201, even though it is also on the Efficiency Frontier. The inferiority occurs because the shareholders are assumed to have selected Point 201, of all the points on the Efficiency Frontier, as being optimal for them. If The Corporation were to be at Point 202, say because of a fundamental change in The Corporation's industry, then the existing shareholders would sell their interests to others, for whom Point 202 would be optimal.

Now suppose that causality starts with Point 201 in FIG. 2A. Given the coordinates of this point (mean, sigma) and an arbitrary starting value, a random-value cumulative time-series variate, called the Shareholder-floor Index, can be generated as shown in FIG. 2C. This Shareholder-floor Index can be used as a deterministic index of shareholder-realized-demanded performance by The Corporation: when the Shareholder-floor Index goes up by x %, shareholder-realized-demanded future-expected earnings/value/size goes up by x %; when the Shareholder-floor Index goes down by y %, shareholder-realized-demanded earnings/value/size goes down by y %.

Hence, the Shareholder-floor Index can be used to generate simulated company earnings/value/size as depicted in FIG. 2D.

It is extremely important to realize that the Shareholder-floor Index and the resulting earnings/value/size derived from the Shareholder-floor Index do not necessarily have any relationship to any Actual future-expected corporate performance. If Actual future-expected performance of The Corporation is below that suggested by the Shareholder-floor Index, then the shareholders demand company restructuring and/or liquidation, so that they can again obtain the performance aligned with the Shareholder-floor Index. If Actual future-expected performance of The Corporation is above the Shareholder-floor Index, the shareholders are content, since their demands are being more than met.

The Shareholder-floor Index has the connotation of shareholder demand, while stock-price has the connotation of shareholder expectation. In equilibrium, however, the two will be identical: if the stock-price suggests an expected return greater than that demanded (presumably, realistically) by some shareholders, then those shareholders will sell their stock. Conversely, if the stock-price suggests an expected return less than that demanded by some shareholders, then those shareholders will purchase additional shares.

Because of this equivalence, in a computer simulation the Shareholder-floor Index can be used to determine (drive) both stock-price and earnings/value/size. Also, because of this equivalence, log-normal means and sigmas for historic stock-price movements can be determined and used to generate the Shareholder-floor Index as shown in FIG. 2C.

(It is well known in the art how to determine a stock's log-normal mean and sigma. The present invention does not contribute to the understanding of the determination of a stock's empirical log-normal mean and sigma. Note that when determining a stock's log-normal mean and sigma, standard appropriate accounting is made of dividends paid and the stock splits. The FASB's, October 1995, Statement of Financial Accounting Standards No. 123 provides an example of calculating sigmas on page 144. Conceivably, one could apply autoregressive conditionally heteroscedastic techniques [ARCH] when generating random the Shareholder-floor Index.)

If The Corporation is privately held, then the Shareholder-floor Index log-normal means and sigmas can be derived from:
Established stock-price indices, such as the SP500,
Stock-price histories of stocks in companies that are similar to The Corporation,
Return-on-asset indices.

In addition, subjective estimates for the mean and/or sigma can be used. Fundamental business drivers can also be used. So, for example, the partners of a small local wholesale florist can, amongst themselves, agree on, and use, a Shareholder-floor Index mean appreciation of 15.0%. They can also determine that their business is highly correlated with local retail sales, and as a consequence, calculate and use a sigma derived from an index of local retail sales.

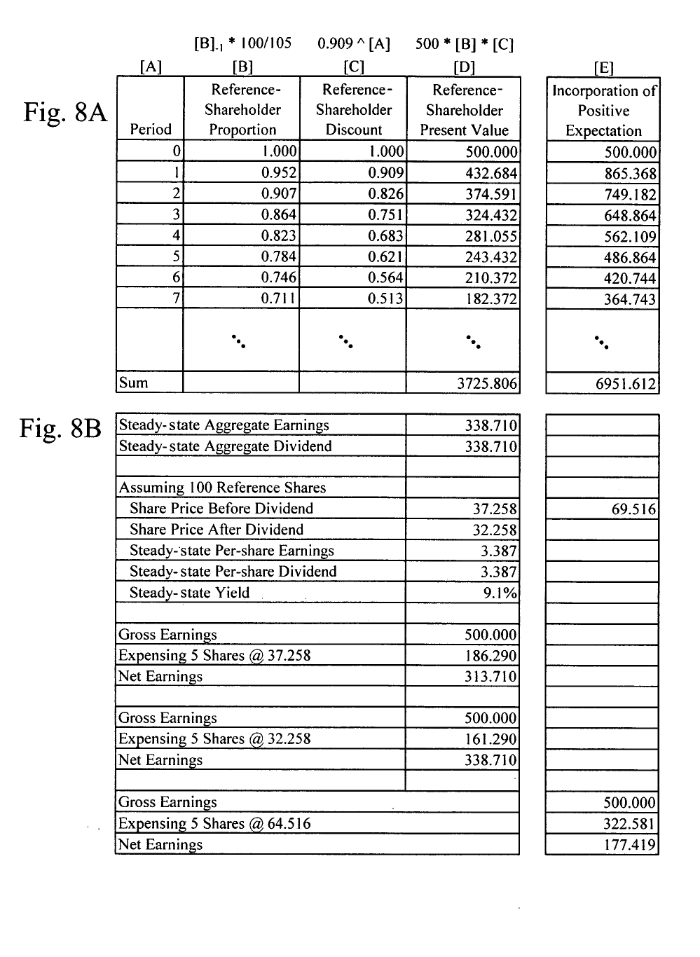

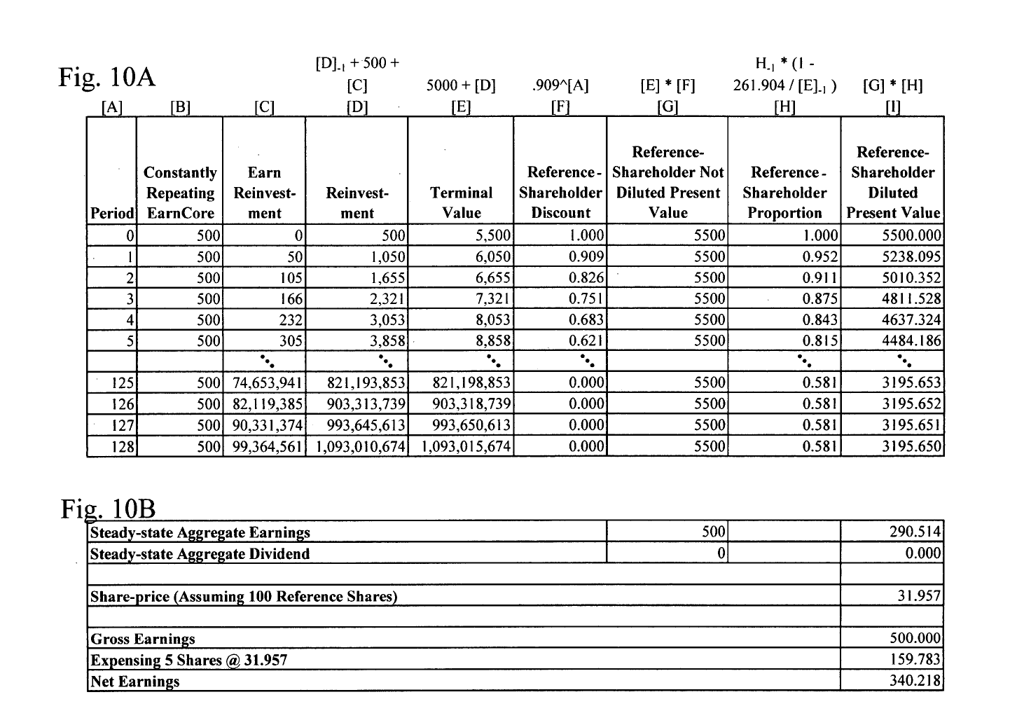

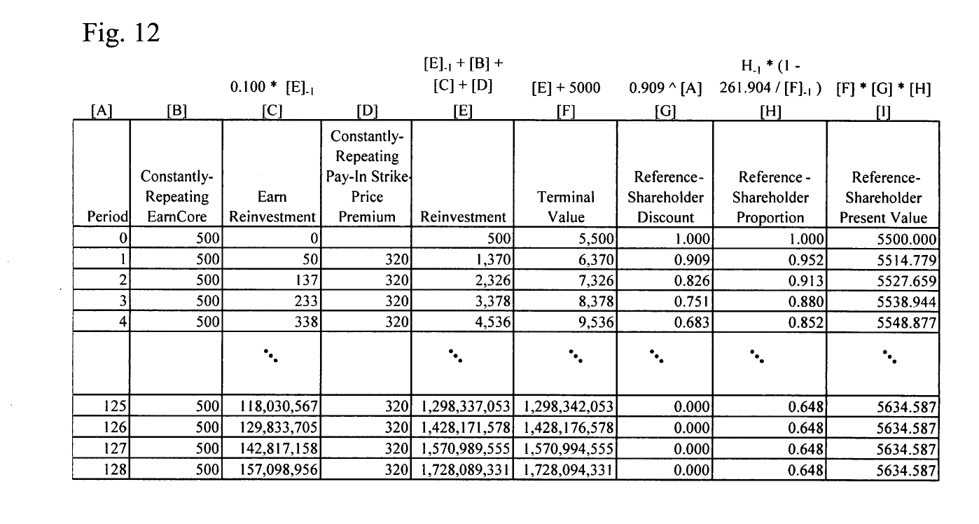

As mentioned before, the Shareholder-floor Index is required by the preferred-embodiment of the present invention. A stock-price, however, is not necessarily generated or needed. (In the case of Soquel, Shareholder-floor Index was not absolutely needed because it paid earnCore as dividends. Similarly, for the case shown in FIGS. 8A and 8B. Furthermore, Shareholder-floor Index can be implicit, as in FIGS. 10A and 12.)

6.3.4. EarnCore, DividendCore, Reinvestment

Now suppose that The Corporation has all but closed its books for the last accounting reporting period and tentatively expects to declare earnings of $500. It faces a choice: either pay the shareholders the $500 as dividends, retain the $500 for reinvestment, or do some combination of dividend payment and reinvestment.

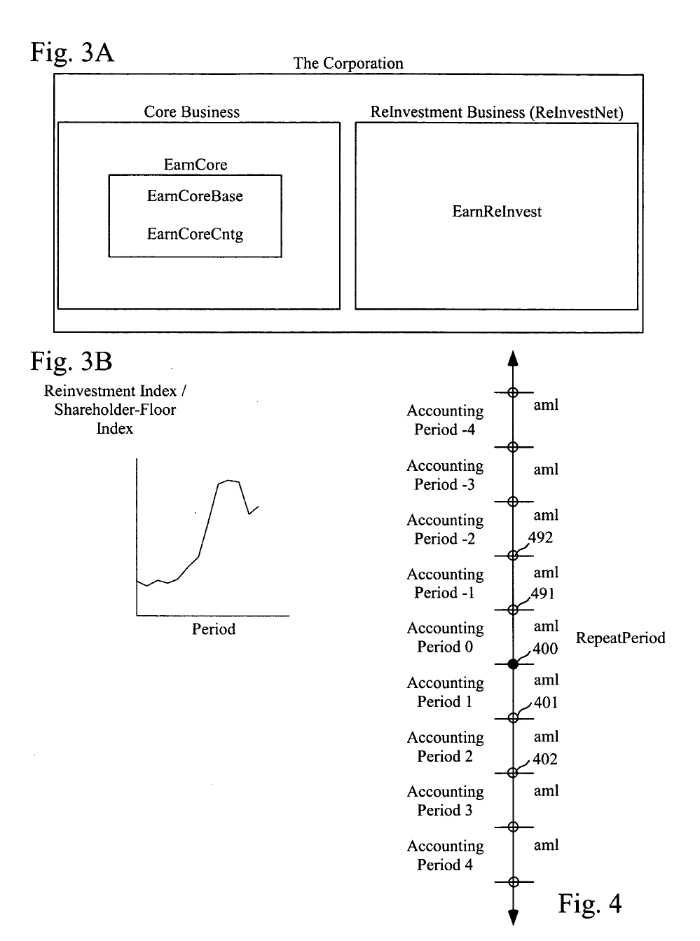

FIG. 3A shows a very important conceptual split of The Corporation that is employed throughout the present invention: a split between the core business and the reinvestment business. The core business earns earnCore and pays dividend dividendCore in each accounting period that will be perpetually repeated.

EarnCore has two components: earnCoreBase and earnCoreCntg. EarnCoreBase is simple period earnings, while earnCoreCntg is contingent period earnings. If The Corporation buys a box of apricots for $6 and then immediately sells it for $10, then both earnCoreBase and earnCore increase by $4. If The Corporation enters a contract to deliver a box of apricots in the future and plans on purchasing the box for an unknown price, then the mathematically-expected profit from the transaction is reflected in an increase in both earnCoreCntg and earnCore.

Both earnCore and dividendCore are aggregates, as opposed to per share values. EarnCore, earnCoreBase, and earnCoreCntg can be negative, meaning a loss for the period. DividendCore is non-negative. The reinvestment business has a net beginning investment or value of zero in Period 0. The excess of earnCoreBase minus dividendCore, plus what might be paid-in by the CSCLs (e.g., contingent payments [earnCoreCntg], paid-in strike-price premiums when call stock options are exercised) is reinvested. If dividendCore is greater than earnCoreBase (earnCore), then reinvestment can be negative, in which case a fictitious entity, analogous to the shareholders, is assumed to loan The Corporation's reinvestment business the shortfall on terms dictated by the Shareholder-floor Index. This shortfall loan is repaid only in the terminal period.

EarnCore is assumed to represent The Corporation's best efforts to earn a profit in the current accounting period. Employing the assumption that the current accounting period perpetually repeats leads to the conclusion that earnCore never changes. Later, stochastic, disturbances to earnCore will be incorporated. Note that though The Corporation may have great plans to increase earnCore and earnCore might not (yet) reflect an optimal capital allocation, such considerations are irrelevant here: the current accounting period is assumed to perpetually repeat—as is. Similarly, if The Corporation has idle funds waiting to be invested, what might be done with such funds is irrelevant: the current accounting period is assumed to perpetually repeat—as is. Note that the idle funds may earn a small interest and such an interest is included in earnCoreBase. Since the current accounting period is assumed to perpetually repeat—as is, that small interest is a component of earnCoreBase in each repeating period.

Now returning to the issue of whether to pay the shareholders the $500 or reinvest it, standard economic theory states that the decision between dividend payment and reinvestment is contingent upon whether The Corporation can, through reinvestment, earn more than that dictated by the expected mean appreciation of, what is termed here, the Shareholder-floor Index.

But besides meeting the minimum mean return demanded by the Shareholder-floor Index, the reinvestment returns and risks need to exactly mirror/follow the Scenario-path of the Shareholder-floor Index. To see this, consider the two possible cases where mirroring conceivably does not occur: First, suppose that a reinvestment opportunity corresponds to Point 202 of FIG. 2A. If such an investment were undertaken, then on average, The Corporation would not be on the Efficiency Frontier. Instead, it would be at a point such as Point 203, which is a weighted average of Points 201 and 202. This violates the shareholder dictate, and market expectation, that The Corporation shall operate at Point 201 of the Efficiency Frontier. Hence, the reinvestment opportunity of Point 202 is rejected (or conceivably sold). Second, suppose that the reinvestment opportunity corresponds to Point 201 of FIG. 2A, with the same mean and sigma as the Shareholder-floor Index, yet with a Scenario-path different from the Shareholder-floor Index. In other words, the investment opportunity is not perfectly correlated with the existing Core Business. If such a second reinvestment were undertaken, The Corporation would be above the Efficiency Frontier, at a point like Point 204, directly left of Point 201: The Corporation is able to diversify its risk, yet retain the same overall expected return. This violates the shareholder dictate that The Corporation operates at Point 201 of the Efficiency Frontier. Hence, The Corporation only considers reinvestments that exactly mirror the Scenario-path suggested by the Shareholder-floor Index. (Conceivably, an investment opportunity represented by Point 204 would be sold, rather than simply abandoned.)

Hence, the vertical axis of FIG. 3B, which is a blow-up of a tiny section of FIG. 2C, is labeled both Reinvestment Value Index and Shareholder-floor Index. Each reinvestment appreciates or depreciates according the Shareholder-floor Index.

As stated, the core business is assumed here to perpetually repeat with earnCore earned in each repeating accounting period. Though it is tempting to assume that earnCore's earnCoreBase component is constant, such an assumption would violate the assumption that The Corporation is operating on Point 201 of the Efficiency Frontier. The violation occurs since a constant earnCoreBase would constitute a riskless stream of future cash payments. Hence, earnCoreBase is stochastic. Since the shareholders dictate that The Corporation operate as suggested by Point 201, when perpetually repeating, earnCoreBase needs to vary as suggested by Point 201. As previously discussed, since risk diversification is not allowed, earnCoreBase further needs to vary in a way that mirrors/follows the Shareholder-floor Index. But two problems emerge: First, the Shareholder-floor Index and earnCoreBase are fundamentally not compatible since they are of different dimensions. The Shareholder-floor Index has an instantaneous dimension of time and represents a level, while earnCoreBase has a dimension of period and represents a quantity. Second, the Shareholder-floor Index has a positive log-normal mean appreciation (since the shareholders expect a positive return), while earnCoreBase should have a zero log-normal mean appreciation (since in Perpetual-repetition, it should have no trend). The solution employed here is to generate the earnCoreBase Scenario-path with a zero log-normal mean appreciation and with a good log-correlation with the Shareholder-floor Index. Details of generating the Scenario-path for earnCoreBase will be presented later.

6.3.5. Log-Normal Random Numbers

The Inflated-Compounding Problem poses a dilemma. On the one hand, a log-normal distribution has many desirable properties and is the natural distribution for modeling financial and economic phenomena. On the other hand, because of the Inflated-Compounding Problem, it introduces a systematic cumulative error.

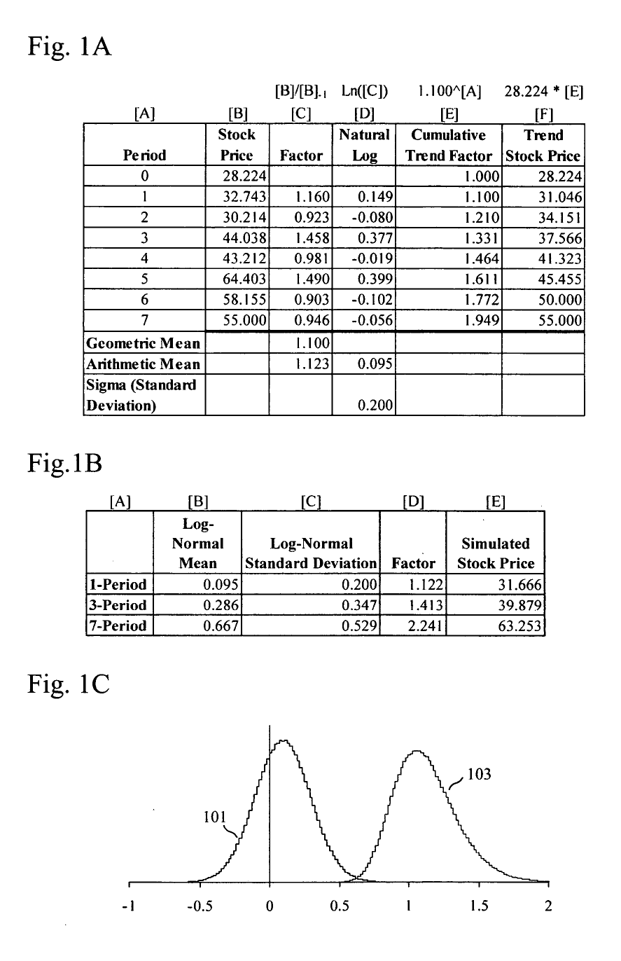

Rather than trying to solve the dilemma, the approach used here is to correct for The Inflated-Compounding Problem. This correction, however, distorts probabilities. So, for example, in FIG. 1A the frequencies of Factor being over and under 1.100 are almost equal—exactly what would be expected. If the correction to be presented were applied, then the frequencies would be biased towards being under 1.100. Hence, the original log-normal distribution is used to determine what is called Probabilistic-classification. So in the simulation, for example, the original log-normal distribution is referenced to determine whether in a particular period Factor is above 1.100. However, the correction, called Arc-appreciation, is used to determine appreciations between periods in order to avoid the Inflated-Compounding Problem.

6.4. Mathematical Theory of the Invention

6.4.1. Introductory Remarks

This section builds upon the previous section (6.3). This section sequentially builds upon itself by first introducing aspects of the present invention and then providing detail. This is in preparation for the final major section (6.5) that introduces an example embodiment that includes source code. Within this section, the sub-sections are as follows:
6.4.2. Timeline/Accounting Periods—presents time period nomenclature.
6.4.3. Elaborate Example Default Parameters—presents default parameters of the Elaborate Example. As much as possible, the same parameter values are used in order to promote consistency in the presented examples.
6.4.4. Additional Example Cases (AEC)—presents additional example cases to demonstrate fundamental principals of the present invention not covered in the case of the Soquel Corporation. Additionally, the first two examples conclude with comparisons of the present invention and prior-art expensing.
6.4.5. Simulation Overview
6.4.6. Simulation Elements
6.4.7. Simulation Unification—unifies sections 6.4.5 and 6.4.6.
6.4.8. Calculate Reporting Aggregates—shows how the results from multiple simulation scenarios are aggregated to yield Steady-state earnings and other metric data.
6.4.9. Variance Control—discusses strategies to control and reduce variance of yielded metric data.
6.4.10. Corporate Internal Planning and Valuation—discusses how the above, coupled with a positive repeatPeriod, is used for internal forecasting.
6.4.11. External Forecasted Earnings—discusses how the above is used for external forecasting.
6.4.12. CSCL Member Functions and Operations—presents further CSCL operation detail, along with eight example CSCL classes.
6.4.13. CSCL Multi-Period Alignment—explains CSCL multi-period alignment, which can entail a CSCL being both applicable and compensatory for more than a single period.
6.4.14. Comparison with Expensing Based Upon BBL Model Valuations.
   6.4.2. Timeline/Accounting Periods

FIG. 4 shows a timeline used by the present invention. The Actual present point in time (present instant) corresponds to solid Point 400, which is just at the end of Period 0 and before Period 1. The books for Period 0 have almost been closed. Generally, Period 0 data corresponds to the end of the period, in other words, Point 400. The next period is Period 1 and generally data for this period corresponds to Point 401. The period previous to Period 0 is Period −1 and generally data for this period corresponds to Point 491. (Period 0 corresponds to what is sometimes termed “the current period” in financial circles, i.e., if the date is between March 25 and April 5, say, the current accounting period [that is the focus of attention] might be the first quarter: January-March.)

There is one main exception to the rule that data corresponds to the end of the period: assets minus liabilities (aml, shareholders' equity) are in reference to the start of the period, in particular for Period 0.

Reference-shareholders are the common-stock shareholders of The Corporation at the beginning of Period 0. The present invention assumes their perspective. So, for example, assume there are 100 outstanding common shares at the start of Period 0 and that during Period 0, The Corporation issues 6 additional shares. In this case, there are 100 reference outstanding-shares. If an Actual period of time were to pass, (i.e., after the next accounting period) then the period numbers would shift, i.e., Period 0 becomes Period −1, Period 1 becomes Period 0, etc., and for the resulting Period 0, there would be 106 reference outstanding shares.

6.4.3. Elaborate Example Default Parameters

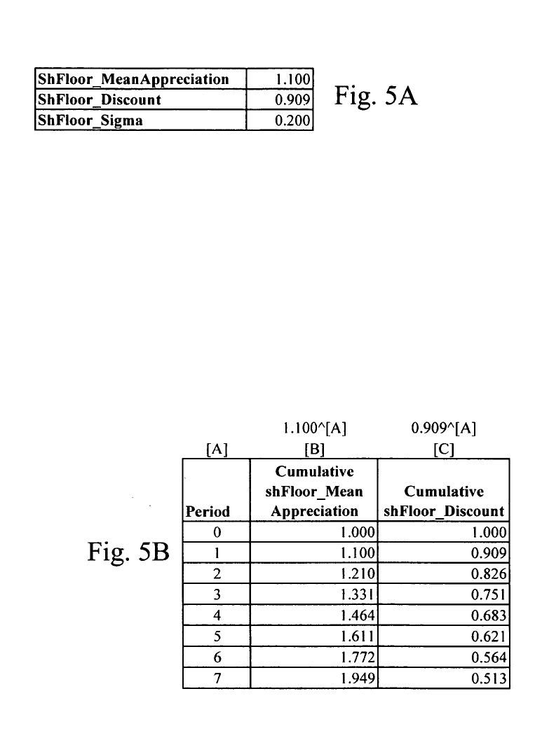

FIG. 5A shows some default parameter values used in the Elaborate Example that follows. For explanatory purposes, the Shareholder-floor Index has a mean appreciation of 10.0% per period. Within the source code, this mean is variable shFloor_MeanAppreciation. The Shareholder-floor Index, itself, is represented by variable shFloor in the source code. Generally speaking, the Factor form of representation is used here. Hence, the 10.0% per period mean appreciation is represented as 1.100. The Shareholder-floor Index/shFloor has a sigma of 0.200 and this is variable shFloor_Sigma in the source code. Given shFloor_MeanAppreciation of 10.0%, then the shareholders have a discount rate of 9.091% (1−1/1.1). Within the source code, 1.0 minus the shareholder discount rate is stored in variable shFloor_Discount, which in this instance has a value of 0.909, which is a Factor form. FIG. 5B shows the results of compounding these parameters, which should be familiar to any financial professional: over the course of four periods, for instance, the shareholders expect a return of 46.4%. This is shown as Factor 1.464 in FIG. 5B. The result of compounding shFloor_Discount is shown to the right in FIG. 5B ([C]).=So, for instance, a value four periods into the future is multiplied by 0.683 to obtain its Present-value. As would be expected, on an element-by-element basis, the multiplication of the second column ([B]) with the third column ([C]) equals 1.0, since shFloor_Discount is the inverse of shFloor_MeanAppreciation. These parameter values are used because they are simple and maintain consistency across the examples. Naturally, in a real implementation of the present invention, these variates would be set to be reflective of the circumstance under which the present invention is being used.

6.4.4. Additional Example Cases (AEC)

The case of the Soquel Corporation introduced several fundamental principals of the present invention. However, additional example cases should be considered prior to the presentation of the invention's systemization. Below are four such additional example cases. After each of the first two example cases, the current prior-art paradigm of expensing equity-based compensation is applied to futher demonstrate how it can lead to inaccurate earnings.

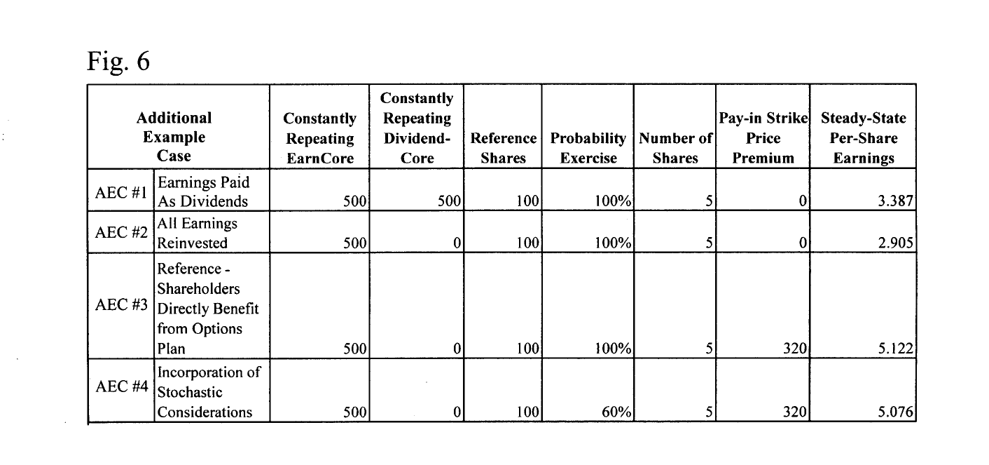

Additional parameters for the four example cases, along with resulting Steady-state earnings, are shown in FIG. 6. EarnCoreBase is a constant $500, which is either fully paid as dividends or fully retained for reinvestment. (earnCoreBase=500; earnCoreCntg=0 or 320 (discounted); dividendCore=0 or 500.) Initially, there are always 100 Reference-shares and 5 shares in play as either an outright grant or as a stock option. As shown in FIG. 6, grants have zero pay-in strike-price premiums, while options have positive pay-in strike-price premiums.

The first three example cases were designed to demonstrate extremes, assuming a deterministic perspective. The last example case is designed to demonstrate the incorporation of stochastic considerations. Stock price considerations, which would significantly complicate the analysis, will be addressed in the final numerical example (FIGS. 35A and 35B).

6.4.4.1. AEC #1: All Earnings Paid as Dividends

Now suppose that:
The Corporation has earnings (earnCore) of $500 for Period 0;
The Corporate has decided to pay the full $500 as dividends (dividendCore);
There are 100 Reference-shares;
The $500 period earnings (earnCore) repeat perpetually;
The discount rate for the Reference-shareholders is 9.091%.

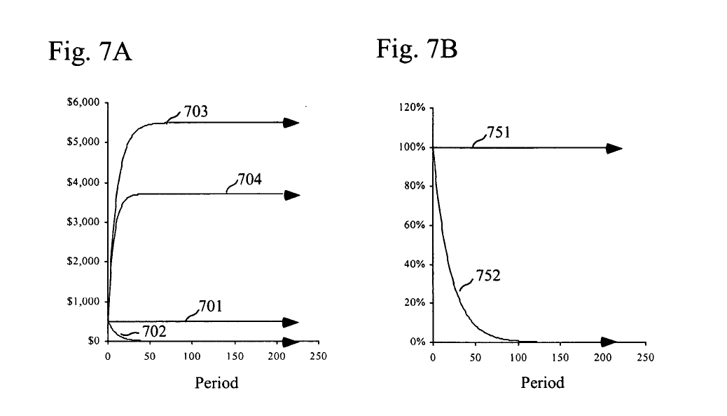

Using a well-known formula yields a Present-value of $5500 in aggregate or $55 on a per share basis. This is shown in FIG. 7A where Line 701 shows the $500 period earnings being repeated perpetually, Curve 702 shows the Present-value of each period's earnings (which approaches zero), and Curve 703 shows an aggregation of the $500 Present-values. Notice how Curve 703 approaches an asymptote of $5500. Line 751 in FIG. 7B shows the Reference-shares constituting 100.0% of outstanding-shares. Somewhat making the discussion circular, given the 9.091% discount rate, the $5500 valuation, and a requirement that earnings be constant, period earnings must therefore be $500 in order for all implicit equations to hold.

Suppose that in order to earn the $500 in Period 0, The Corporation promised to give all employees an aggregate total of five shares, as an aggregate unrestricted stock grant, immediately after Period 0. This means that at the beginning of Period 1, there are 100 Reference-shares and 105 outstanding-shares; the Reference-shareholders own 95.2% of The Corporation. As part of Perpetual-repeating, in Period 1 earnings are again $500, and again between Periods 1 and 2, The Corporation gives employees a new 5.0% interest in The Corporation. This means that at the beginning of Period 2, there are 100 Reference-shares and 110.250 outstanding-shares; the Reference-shareholders own 90.7% of The Corporation. This Perpetual-repeating is done for Periods 3, 4, . . . . Curve 752 in FIG. 7B shows the resulting ownership proportion for the Reference-shareholders: the proportion approaches zero as period approaches infinity.

It is extremely important to realize that in each period the stock grant is identical from the perspective of the recipient: each time the recipient receives 5.0% of The Corporation. By giving the recipient the same as given in Period 0, the recipient will give the same to The Corporation, and so The Corporation can perpetually repeat obtaining the same $500 earnCoreBase earnings.

As part of Perpetual-repetition, The Corporation pays the $500 earnCoreBase earnings as dividends in each period. But after Period 0, the Reference-shareholders are required to share the $500 with the new shareholders. Because the Reference-shareholder proportion continuously diminishes, they receive a smaller and smaller portion of the $500. Furthermore, this smaller and smaller portion is increasingly discounted. Nevertheless, a Present-value can be calculated. This is shown in FIG. 8A where the second column from the left ([B]) shows Reference-shareholder proportion. The third column ([C]) is cumulative Reference-shareholder discount (from FIG. 5B). The fourth column ([D]) is the mathematical product of the second and third columns with $500. This fourth column has the elemental Present-values of the dividend stream for the Reference-shareholders. As an infinite series, it sums to 3725.806. (Curve 704 of FIG. 7A shows the cumulative value of this series, which has an asymptote of 3725.806.) A simple way to see this is to combine the progressive fractional ownership (100/105) with the discount rate of 9.091% for a net equivalent discount of:
(100/105)*1.0/1.1=0.865
   And then using the standard formula and assuming a $500 payment in each period to obtain:
500*(1/(1−0.865))=3725.806
   Hence, with the repeating stock grant, the Reference-shareholders have a Terminal Present-value of $3725.806. Now given this Present-value and assuming a discount of 9.091%, if someone were to swap the stream of Column [D], FIG. 8A, for a stream that yields a constant value in each period, what would that constant value be? The answer is $338.710 since
338.710*1/0.091=3725.806.

This 338.710 is termed here as Steady-state earnings and, since all earnings are paid as dividends, in this case Steady-state earnings are identical to Steady-state dividends. If The Corporation's Period 0 performance was to perpetually repeat, then the Reference-shareholders would be in the same position as if they owned stock in a company that earned $338.710 in each period, that paid the $338.710 as dividends in each period, and that had no equity-based compensation. As shown in FIG. 8B, on a per Reference-share basis, since there are 100 Reference-shares, this leads to Steady-state per share earnings, and Steady-state per share dividends, of $3.387.

Since the Present-value of the Reference-shares is $3725.806 and assuming 100 Reference-shares and that Perpetual-repetition is an accurate depiction, the per share price prior to dividend payment is $37.258 and after dividend payment it is $32.258 (3725.806/100−500/100).

Assuming that the current stock-price is 37.258, Steady-state yield is Steady-state per share dividend divided by the current stock-price, or 9.1%. If one were to purchase a single share at 37.258 and if Period 0 were to perpetually repeat, then the shareholder would receive an equivalent 9.1% yield.

6.4.4.1.1 Further Demonstration of Prior-Art Inaccuracy

Now suppose that, rather than calculating Steady-state earnings and dividends as shown above, The Corporation expenses the 5 granted shares, as per current prior-art methodology. Using the pre-dividend share-price of 37.258 results in a charge of $186.290, which results in net earnings of $313.710—about 8% less than the Steady-state earnings (See FIG. 8B). Which are the correct earnings to use?

Now suppose that the post-dividend share-price is used in expensing the 5 granted shares. This result is a charge of $161.290, which results in net earnings of $338.710, which is the same as the Steady-state earnings. Which are the correct earnings to use?

If the Reference-shares are publicly traded and if the stock market assessment concurs with what is shown in Column [D] of FIG. 8A, then there is no difference between Steady-state earnings and earnings calculated by expensing using an ex-dividend share-price. However, the odds are against such a concordance, since the perspectives are different: the Steady-state earnings are determined assuming that the Period 0 perpetually repeats—as is, while the Stock Market price reflects an assessment of The Corporation's future prospects.

So, for example, suppose towards the end of Period 0 some international event occurs and that the general assessment is that The Corporation's future business and future earnings will double as a result. The fifth, or rightmost, column of FIG. 8A ([E]) shows such a doubling. Summing this column as an infinite series yields 6951.612, which means that each Reference-share has a pre-dividend value/price of $69.516 and a post-dividend value/price of $64.516. Now expensing the five granted shares using a unit price of 64.516 results in the conclusion that the Reference-shareholders earned $177.419, which is less than the other previous net earnings: 313.710 and 338.710 (See FIG. 8B). This is a major problem: The result is the reverse of what should arguably occur. Given the international event, if any change were to be made to the Period 0 earnings, there should be an earnings increase.

Though one may quibble with the results on the far right of FIGS. 8A and 8B, the important points remain. If the original earnings of $500 do not reflect a positive expectation that is incorporated in a stock-price, use of the stock-price for expensing results in an understatement of earnings. The converse is also true: if the original earnings of $500 do not reflect a negative expectation that is incorporated in a stock-price, use of the stock-price for expensing results in an overstatement of earnings. Now, inevitably, the original earnings of $500 cannot reflect all the expectations that are incorporated in a stock-price. The $500 is what is earned in Period 0—without regard to uncertain future speculative possibilities. The stock-price represents assessments of all such future speculative possibilities. It is because of this difference, coupled with previously discussed considerations, that leads to inaccurate earnings when equity-based compensation is expensed, as done under the current prior-art paradigm.

6.4.4.2. AEC #2: All Earnings Reinvested

Now suppose that:
The Corporation has earnings (earnCore) of $500 for Period 0;
The Corporate has decided to retain the full $500 for reinvestment;
There are 100 Reference-shares;
The $500 period earnings (earnCore) repeat perpetually;
The discount rate for the Reference-shareholders is 9.091%;
shFloor_MeanAppreciation is 1.1;
shFloor_Sigma is 0.

At the end of Period 0, the fact that The Corporation is reinvesting the $500 period earnings should not affect the value of The Corporation for the Reference-shareholders. Hence, as stated before, the Present-value is $5500 for the Reference-shareholders at the end of Period 0. See FIG. 10A, first entry in the Terminal Value Column ([E]).

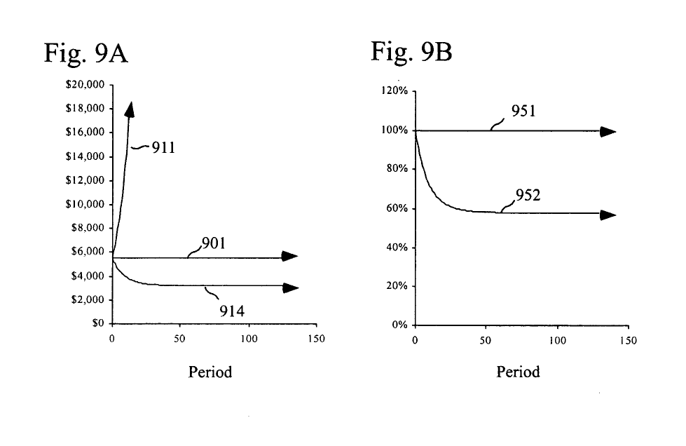

As might be recognized by some financial analysts, since the appreciation is the inverse of the discount rate, there is no particular advantage for the Reference-shareholders in reinvestment. Explicitly, if the Period 0 earnings of $500 are reinvested, then at the end of Period 1, they have earned $50 and thus the investment is worth $550. This $550, plus the original $5500, sets the terminal value of The Corporation at $6050 at the end of Period 1. The $550 plus the $500 that is earned in Period 1 leaves $1050 for reinvestment at the end of Period 1. At the end of Period 2, this $1050 earned $105. This $1050+$105+the original $5500 sets the terminal value of The Corporation at $6655 at the end of Period 2. And this reinvestment can be perpetually repeated as shown in the left five columns of FIG. 10A, which shows the tallying results through Period 128. Curve 911 of FIG. 9A shows the exponential increase in the terminal value of The Corporation. Such appreciation is all well and good, but from the perspective of the Reference-shareholders, it is arguably for naught, since applying their discount to each terminal value results in the same Present-value for the Reference-shareholders, as shown in the Reference-shareholder Not Diluted Present-value Column ([G]) of FIG. 10A. This is shown as Line 901 in FIG. 9A. (Line 951 in FIG. 9B shows the constant 100.0% Reference-shareholder ownership.)

But nevertheless, given a terminal value of $5500, and somewhat making the discussion circular, answer the following question: what is the perpetual required period earnings in order to reach a terminal value of $5500 at some distant point in the future? The answer is $500.

As before, now suppose that in order to earn the $500 of Period 0, The Corporation promised to give employees five shares, as a simple unrestricted stock grant, after Period 0. This means that, as in the previous example, at the beginning of Period 1, there are 100 Reference-shares and 105 outstanding-shares; the Reference-shareholders own 95.2% of The Corporation. As part of Perpetual-repeating, in Period 1 earnings are again $500, and again between Periods 1 and 2 The Corporation promises employees a new interest in The Corporation. The interest is not 4.762% (1−100/105), however, because with the retained earnings, The Corporation is worth more that it was worth in Period 0. In Period 0, the employees were promised 4.762% (1−100/105) of a $5500 “value going forward”, or in net a $261.904 value going forward. In Period 1 the value going forward is 6050. Hence, the employees get 4.314% of The Corporation (261.904/6050) after Period 1. This leaves the Reference-shareholders with a 91.1% interest in The Corporation at the end of Period 2:
0.911=(100/105)*(1−261.904/6050)

In Period 2, the value going forward is 6655. Hence, the employees get 3.998% of The Corporation (261.904/6550) between Periods 2 and 3. This leaves the Reference-shareholders with an 87.5% interest in The Corporation at the end of Period 3:
0.875=(100/105)*(1−261.904/6050)*(1−261.904/6550)

Now this Perpetual-repeating is done for Periods 4, 5, . . . . Curve 952 in FIG. 9B shows the resulting ownership proportion for the Reference-shareholders: the proportion approaches an asymptote as period approaches infinity. The Reference-shareholder Proportion Column in FIG. 10A shows the declining ownership proportion for the Reference-shareholders. The asymptote is 58.1%. An asymptote is necessarily reached since terminal value increases exponentially, while the value going forward numerator (261.904) is a constant.

As before, it is extremely important to realize that in each period the stock grant is identical from the perspective of the recipient: each time the recipient receives the same value going forward. By giving the recipient the same as given in Period 0, the recipient will give the same to The Corporation, so The Corporation can perpetually repeat obtaining the same $500 earnCoreBase earnings.

Now if the Reference-shareholder Not Diluted Present-value Column is multiplied by the Reference-shareholder Proportion Column of FIG. 10A, the result is the Reference-shareholder Diluted Present-value Column ([I]), which approaches an asymptote terminal present-value of about $3195.650. This is the distant future value of The Corporation for the Reference-shareholders. (See Curve 914 in FIG. 9A).

Given a terminal present-value of $3195.650, answer the previously posed question: what are the perpetual earnings required in order to reach a terminal present-value of $3195.650 at some distant point in the future? The answer is $290.514. The simple way to see this is to multiply $3195.650 by the discount rate:
290.514=3195.650*(1−1/1.1)

Another way to see this is to backtrack and determine a proportion: 500 is to 5500 as “what” is to 3195.650? The “what” is 290.514.

The Steady-state earnings are thus $290.514 or $2.905 on a per share basis. Steady-state dividend is zero, since no dividends are being paid. Note that the Reference-shareholders are in the same position as if they owned a corporation that had retained earnings of $290.514, paid no dividends, and did nothing to dilute shareholder future interest.

Why are the Steady-state per share earnings now less than previously: $2.905 v. $3.387? It is because the Reference-shareholders of AEC#1, section 6.4.4.1, were able to retain for themselves Period 0 earnings, most of Period 1 earnings, etc; while the Reference-shareholders of the current example AEC #2, section 6.4.4.2, apportion the ending appreciated value of Period 0 earnings, the ending appreciated value of Period 1 earnings, etc. with all the new shareholders.

6.4.4.2.1 Further Demonstration of Prior-Art Inaccuracy

Now given that the present-value of The Corporation is $3195.650 for the Reference-shareholders, the per share price is thus $31.957.

If the five shares are expensed, as shown in the bottom right of FIG. 10B, the result is net earnings of $340.218. But this contradicts the Steady-state earnings of $290.514 and the earnCore of $500.

Which are the correct earnings? Which best represents earnings power? For The Corporation, the answer is $500, because if The Corporation could repeat its actions, its gain would be $500. Similarly, if The Corporation could repeat its actions, the Reference-shareholders would gain, on average, $290.514. Hence, the earnings of $340.218 under equity-based expensing are bogus.

6.4.4.3. AEC #3: Reference-shareholders Directly Benefit from Options Plan

In the two examples just presented, the Reference-shareholders would have been in a better position if it were possible to have had the $500 period earnings without The Corporation granting stock to the employees. This is not necessarily the case with all types of equity-based compensation. In the case of employee stock options, Reference-shareholders can directly benefit. This can occur because the employees can seemingly “pay too much”—relative to earnings—when exercising their right to buy shares.

As an example of this and building on the example just presented, suppose that because of future prospects, the public stock-price is high, say $80.000—over twice the 31.957 stock-price previously used. Suppose further that option per share strike price is $63.914. The employees would be willing to pay such a strike-price because the public stock-price, $80.000, is higher than $63.914. Thus in Period 1 the employees pay The Corporation $63.914*5 to exercise options on 5 shares. As before, this results in Reference-shareholders having a 95.2% (100/105) interest in The Corporation at the end of Period 1. Now with this extra $319.565 ($320), The Corporation increases its reinvestment in Period 1 from $1050 (of FIG. 10A) to $1370 (of FIG. 12) in Period 1. As part of Perpetual-repeating, in Period 1, the employees are given the same opportunity: they pay $319.565 for a percentage interest in The Corporation. The percentage interest is not 5/105, since The Corporation is now worth more than before. In Period 0 the employees received 4.762% (1−100/105) of a $5500 value going forward. In Period 0, the value going forward is $6370, so for the $319.565, the employees get a 261.904/6360 proportion of The Corporation. Hence, in Period 2, the Reference-shareholders have a 91.3% interest:
0.913=100/105*(1−261.904/6360)

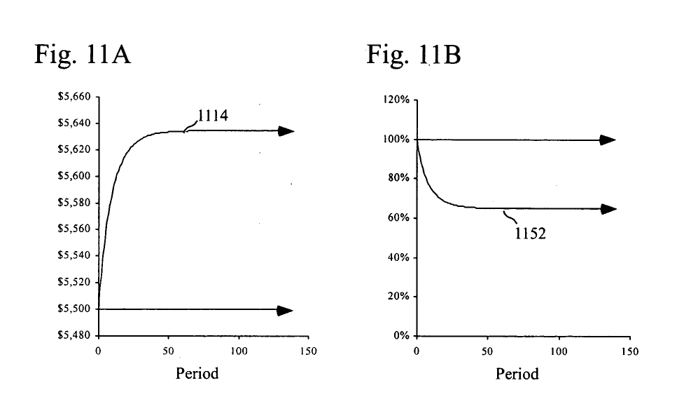

Now as before, this Perpetual-repetition is done for Periods 3, 4, . . . . Curve 1152 in FIG. 11B shows the resulting ownership proportion for the Reference-shareholders. As can be seen by comparing Curve 1152 with Curve 952, the Reference-shareholders are able to retain a higher proportional interest. This can be seen also by comparing column Reference-shareholder Proportion in FIG. 12 ([H]) with the column of the same name in FIG. 10A ([H]). This higher proportion comes about because the terminal value of The Corporation is growing faster, and as a consequence, a smaller proportion needs to be given to the employees in each period.

As before, it is extremely important to realize that in each period the transaction is identical from the perspective of the employees: each time they get an option, with a strike price of $319.565, on the same value going forward. By giving the employees the same as given in Period 0, the employees will give the same to The Corporation, so The Corporation can perpetually repeat obtaining the same $500 earnCoreBase earnings.

Now with more money being reinvested, terminal value is larger (as compared with FIG. 10A). With a larger terminal value and a larger retained proportion, the terminal Reference-shareholder Present-value, at 5634.587, is higher than before. (See Curve 1114 in FIG. 11A.)

This $5634.587 yields Steady-state aggregate earnings of $512.235 (5634.587*(1−1/1.1)) and Steady-state per share earnings of $5.122.

The Reference-shareholders have gained as a result of offering the employees an opportunity to purchase stock. The gain has come about because the employees are paying twice the “per share value”, relative to earnings, which benefits the Reference-shareholders. This is an example of stock options directly benefiting Reference-shareholders.

6.4.4.4. AEC #4: Incorporation of Stochastic Considerations

In the previous examples, the employees always exercised their rights to either convert restricted stock grants to outright grants or to exercise stock options.

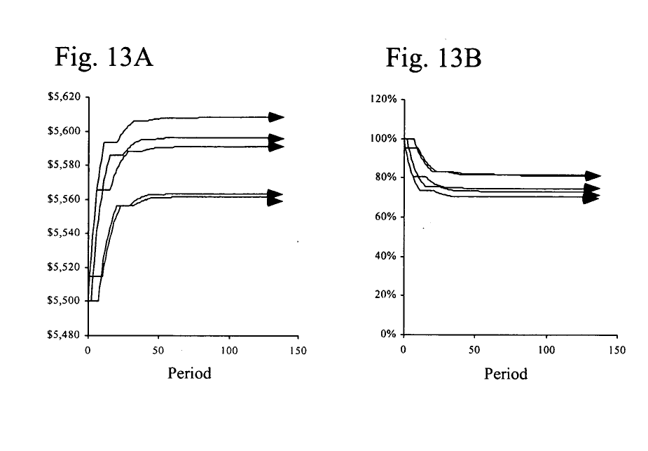

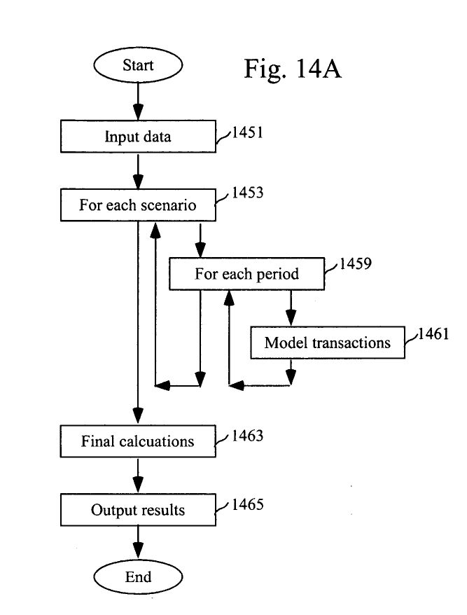

The next conceptual step is to replace the certainty of rights execution with stochastic/probabilistic considerations. So, building on the previous example, suppose that there is only a 60.0% probability that employees will exercise their rights to purchase stock in each period. To consider such a situation requires computer simulation (sometimes called Monte Carlo Simulation). Such a simulation was run and the results are shown in FIGS. 13A and 13B: The Terminal Reference-shareholder Present-values ranged from $5561 to $5608 and had an arithmetic mean of $5584. Given this mean and assuming that the sample is representative yields a Steady-state earnings of $507.636 (5584*(1−1/1.1)). Since there are no dividends, Steady-state dividends are $0.000. In terms of mathematically-expected value, the Reference-shareholders are in the same position as if they owned a company that had perpetual earnings of $507.636, that paid no dividends, and that had no employee stock options. (In the simulation, Reference-shareholder proportion ranged from 0.705 to 0.819 and had a mean of 0.763 as shown in FIG. 13B.)

6.4.5. Simulation Overview

At this point, there are three issues that need to be addressed:
How to handle possible correlations in stock option exercise. In the previous example, the exercise of stock options was modeled by a simple random number generator. This resulted in each period's probability of exercise being statistically independent. If a significant correlation exists between period exercises, then such independence could bias results.
How to incorporate a stock price in the calculation.
How to systematize what has thus far been presented.

In general, as was done in the last example, to calculate Steady-state earnings and dividends requires considering a number of scenarios; and within each scenario, considering a number of periods. As the previous examples showed, however, handling the Perpetual-repetition and tallying results can be a cumbersome, seemingly ad hoc, process.

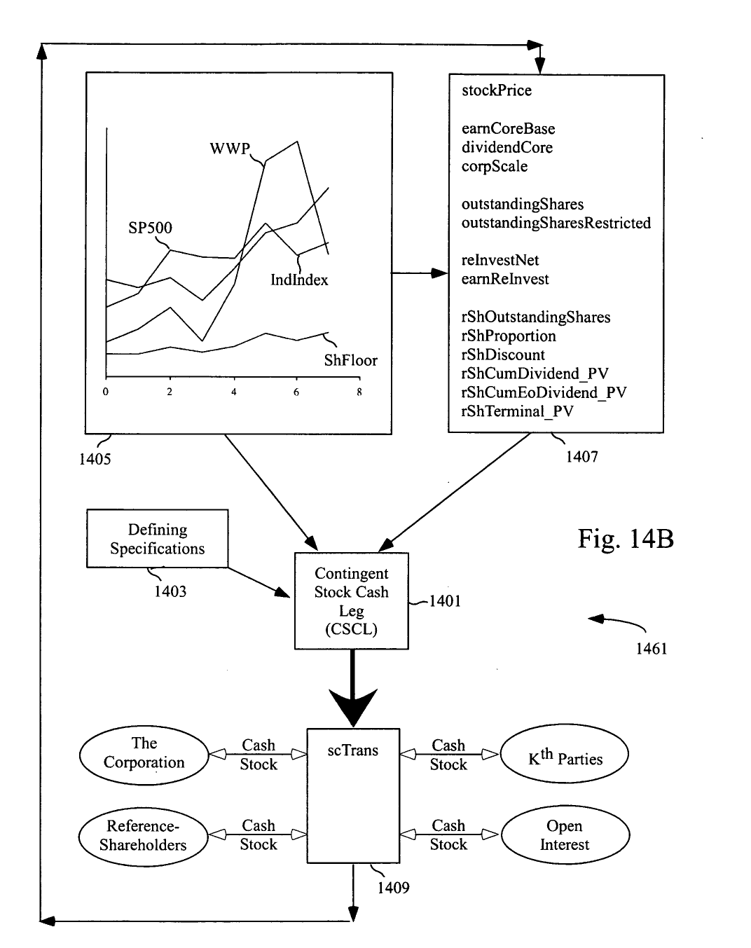

Before starting to consider the details of the systematization, it is helpful to consider FIG. 14A, which shows an abstract view of the functioning of the present invention. As shown in Box 1451, the invention starts with inputted data; then as shown in Box 1453, a loop controller to cycle through a number of scenarios is established; and within each scenario, in Box 1459, another loop controller to cycle through a number of periods is also established. In the inner loop, Box 1461, transactions of the period are modeled, as will be introduced in FIG. 14B. Once all the scenarios are complete, final calculations are made (in Box 1463) and results outputted (Box 1465).

6.4.5.1. Contingent Stock-Cash Leg (CSCL)

Handling Perpetual-repetition and tallying is systemized on a period-by-period basis as shown in FIG. 14B, which is an enlargement of Box 1461 of FIG. 14A. The Contingent Stock-Cash Leg (CSCL) plays a central role in this systemization. CSCL 1401 is defined by the Specification 1403 that either originates in a database or another CSCL. After definition, CSCL 1401 is oriented and initialized with respect to both Master-drivers-variates 1405 and status-variates 1407. Afterwards, for one or more simulated accounting periods, CSCL 1401 monitors both Master-drivers-variates 1405 and status-variates 1407. During each accounting period of the monitoring, it sets (shown by large arrow) transfer directives in an scTrans (Stock-Cash Transfer) object 1409. Such directives, for example, can specify:
The Corporation's receiving $100 and issuing 5 shares,
The Reference-shareholders' receiving $20 for 1 share,
k^{th} Parties' paying $80 for 4 shares.

ScTrans object 1409 transfers stock and cash amongst The Corporation, Reference-shareholders, k^{th} parties, and Open Interest:
k^{th} Parties are entities having a contingent relationship with The Corporation. In the previous examples, the k^{th} Parties were the employees. The present invention is primarily concerned with The Corporation and the interests of the Reference-shareholders. The k^{th} Parties are really 3^{rd} parties that are not central—other than their impacts on The Corporation and in turn the interests of the Reference-shareholders. They are called k^{th}, rather than 3^{rd}, Parties in order to highlight the fact that they might constitute multiple, differing, entities.
“Open Interest” refers to the general market place and is used to pro-rate transactions involving Reference-shareholders and non-Reference-shareholders. So, for example, if The Corporation makes an open market purchase of stock, the scTrans object is then set to indicate that shares transfer from Open Interest to The Corporation and that cash goes in the opposite direction. In subsequent handling, the transaction is pro-rated between Reference and non-Reference-shareholders.

At the end of each simulated period, the data in the scTrans object, along with Master-drivers-variates 1405, are used to update status-variates 1407. The accounting period is incremented and the process repeated.

CSCL is a conceptual C++ class object that simulates both contingent stock and/or contingent cash transactions. In the source code, all CSCL classes are derived from CSCL_Base. The Corporation enters into contingent contracts, each of which consists of one or more transactions. Each transaction, in turn, entails at least one accounting credit and at least one accounting debit, both of which can be called legs. At a simplistic level, a CSCL can model one leg, while the other leg is aggregated in EarnCoreBase, another CSCL, or some other variate. At a more advanced level, a CSCL can model both legs of a transaction. At an even more advanced level, a CSCL can model multiple transactions of a single contract. A CSCL object may, for its own purposes, store histories, for example, that the k^{th} Parties paid $80 for 4 shares. Such stored transactional histories are for subsequent use by the CSCL.

Values contained in the CSCLs are used to tally EarnCoreCntg. Via posting to scTrans objects, a CSCL updates status-variates 1407, specifically variables regarding reinvestment. No distinction is made here between retained earnings and paid-in-capital that accrue in the current period: from the perspective of the present invention, either can be used to fund dividendCores and reinvestments.

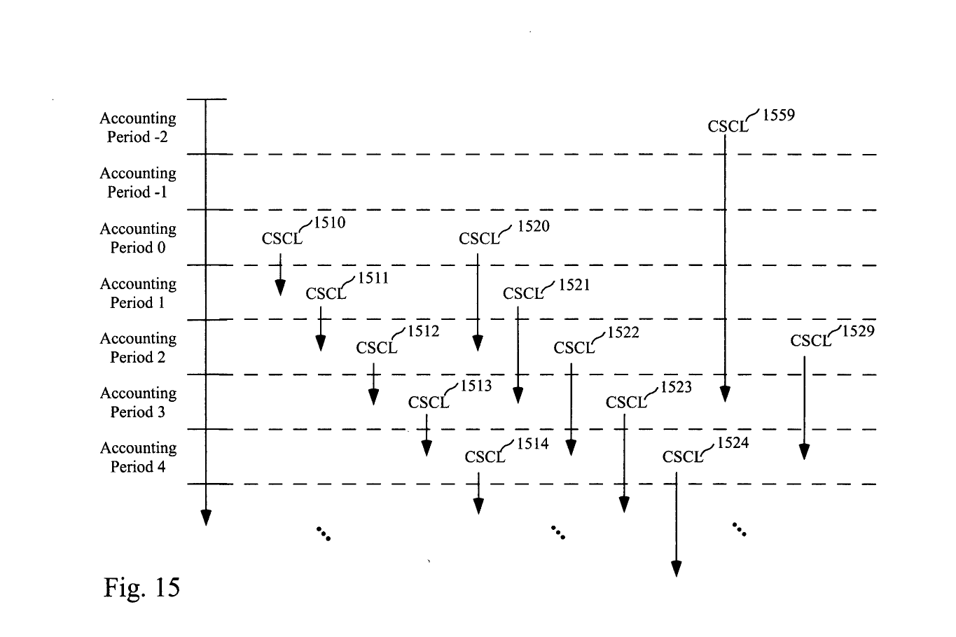

Multiple CSCLs can simultaneously exist and have varying starting and ending periods. FIG. 15 shows the life spans of twelve CSCLs. CSCL 1510 is extant between Periods 0 and 1, inclusive; CSCL 1511 is extant between Periods 1 and 2, inclusive. Note that CSCL 1559 is first extant in Period −2, while CSCL 1529 is first extant in Period 2. Special consideration regarding CSCL 1559 and 1529 will be presented after the following section.

6.4.5.2. Simulation Flow

One of the major advantages of the present invention is the development of Master-drivers-variates 1405, status-variates 1407, and CSCLs. These independent structures are relatively easy to maintain, address the current needs for accurate equity-based compensation accounting, and address the needs for accounting for contingent transactions. As will be subsequently demonstrated, Master-drivers-variates 1405 are appropriately correlated, and thus determining mathematical expectations is more accurate. Furthermore, each scenario provides at least one datum for each tracked variate, and a statistical distribution of each tracked variate can be generated—thus fulfilling a need for both theory and technology so that Companies can report financial numbers, in particular earnings, as statistical distributions.

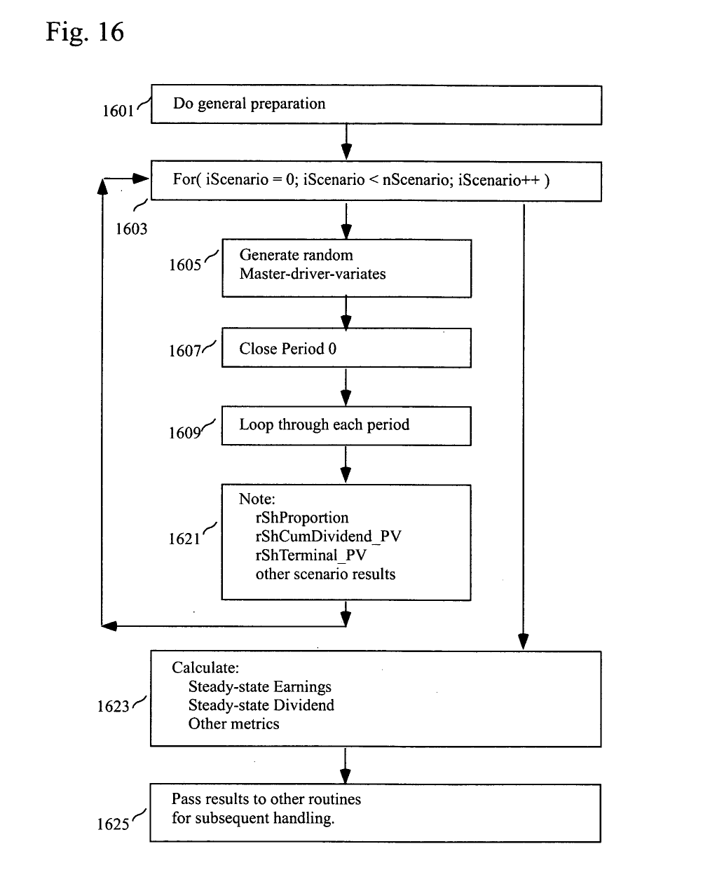

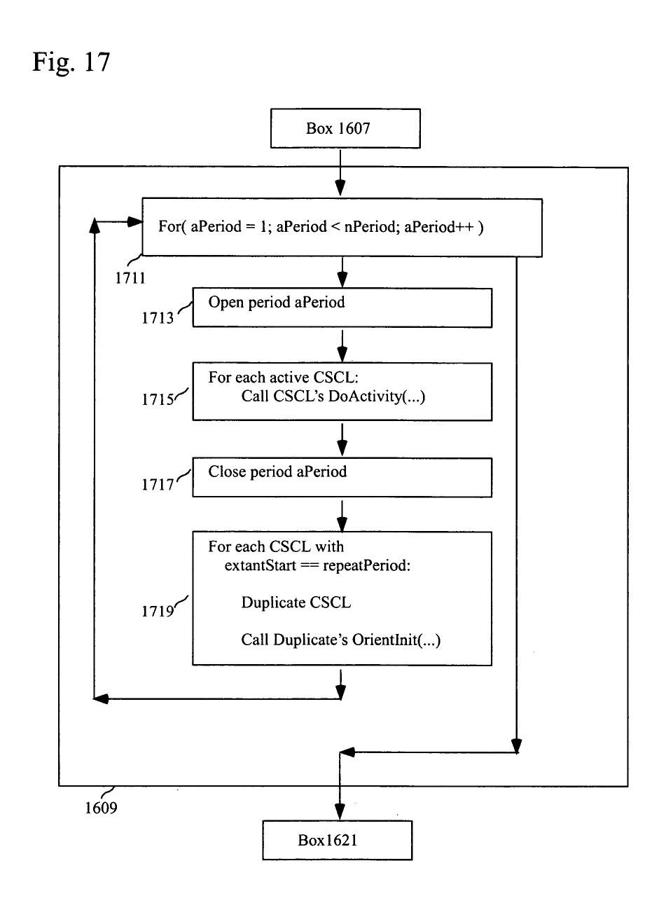

FIGS. 16 and 17 show a flow diagram of the present invention's operation, and expands upon FIG. 14A. (Box 1451 corresponds to Box 1601; Box 1453 to 1603; 1459 to 1711; 1461 to 1713 thru 1719; 1463 to 1621 and 1623; and 1465 to 1625.)

In Box 1601, general preparation is done: parameters are set, status-variates 1407 initialized, and CSCLs loaded. For the example here, initially assume a single CSCL 1510. This CSCL is a simple employee stock option, is loaded based upon a record in a database, and contains the stock-price as of the end of Period 0. (Class CSCL_Call has the capability of exceeding what is described here for CSCL 1510.) If there are no dividends, then stockPrice is the same as shFloor, except for a possible multiplicative constant.

In Box 1603, a loop controller to cycle through nScenario scenarios is established (for FIG. 13A, nScenario equaled five). This loop spans Boxes 1605 through 1621.

In Box 1605, Master-drivers-variates 1405 (of FIG. 14) are generated.

In Box 1607, Period 0 is closed. This results in an update of status-variates 1407, reflective of Actual transactions that occurred in Period 0.

In Box 1609, a loop or cycle through each period is performed. This is shown as a detailed blow-up in FIG. 17.

In Box 1711 of FIG. 17, a loop controller to cycle through nPeriod−1 periods is established. Note that this loop starts with Period 1. (For FIG. 12, nPeriod equaled 129.) This loop spans Boxes 1713 through 1719.

In Box 1713, Period aPeriod (accounting period) is opened. Status-variates 1407 are updated in light of the scTrans entries and Master-drivers-variates 1405 values.

In Box 1715, member function DoActivity of each CSCL that is currently extant is called, with a complete set of Master-drivers-variates 1405 and status-variates 1407 as arguments. This complete set includes historic data, simulated data, and data derived from simulated data. DoActivity considers the instance's defining Specifications 1403, internally stored instance data, and the passed arguments, then decides upon stock and cash transfers between The Corporation, k^{th} Parties, Reference-shareholders, and Open Interests, and then posts such transfers to a ScTrans object. So, for example, in Period 1, CSCL 1510 notices that the stock-price is higher than in Period 0. Hence, the employee stock option is exercised. CSCL, in this case, sets scTrans data members as follows:
corpToOpenStock=0;
corpToOpenCash=0;
corpToRefShareholdersStock=0;
corpToRefShareholdersCash=0;
corpTokthPartyStock=5;
corpTokthPartyCash=−5*55;
corpTokthPartyStockRestricted=0;
   where 55 is the strike-price.

Open Interests is handled so that whatever stock or cash is transferred, to or from The Corporation, the transfer is pro-rated between the Reference-shareholders and non-Reference-shareholders. This will be described in detail later.

In Box 1717, Period aPeriod is closed. Status-variates 1407 are updated in light of the scTrans entries and Master-drivers-variates 1405 values.

In Box 1719, each CSCL that has an extant start of repeatPeriod is duplicated. RepeatPeriod has not been introduced, but it is usually 0, which is the case for the moment here. So, for example, the result of duplicating CSCL 1510 is CSCL 1511. After duplication, member function OrientInit of CSCL 1511 is called, with a complete set of Master-drivers-variates 1405, status-variates 1407, and CSCL 1510 as arguments. This function both orients and initializes the CSCL: initializations are performed and the defining specifications are reset in light of the received arguments. For example, defining specifications 1403 that were used to define CSCL 1510 may indicate a strike-price of 55 and 5 shares in play. OrientInit of CSCL 1511 might notice that, according to status-variates 1407, the stock-price is now 82. Analogous as before, since each share is now worth more, fewer shares are required to compensate the employees at the same level. Specifically, employee stock options covering only 275/82 shares with a strike-price of 82 need be granted. OrientInit performs this analysis and appropriately orients and initializes CSCL 1511.

Note now, as in all the previous examples, the goal is to put The Corporation's counter party (k^{th} Party) in the same position as before in Period 0 (or whatever the repeatPeriod happens to be): assuming a log-normal distribution, the value of 5 calls with a strike and current price of 55 is the same as the value of 275/82 calls with a strike and current price of 82. Thus the value (as a legal consideration) of the transaction being offered/accepted within the Perpetually-repeating contract remains constant in the midst of uncertainty.

The loop spanning Boxes 1713 through 1719 is repeated nPeriod−1 times. Each time, CSCL 1510 is duplicated, which results in CSCLs 1511, 1512, 1513, and 1514 of FIG. 15. (If nPeriod−1 is greater than 4, then more accounting periods are simulated and more CSCL duplication is done. Hence, FIG. 15 might continue with Periods 5, 6, 7, . . . . ) In Box 1621, the resulting rShCumDividend_PV, rShTerminal_PV, rShProportion, and other scenario results are noted. (See Glossary for definition of these variables.)

In Box 1623, after the loop controller of Box 1603 is complete, Steady-state earnings and dividends are calculated along the lines as shown in the previous five examples. Besides these two Steady-state metrics, other metrics, in particular Liquidation01 (the current per share value if The Corporation were liquidated between Period 0 and Period 1, the current point in time) and Forward/Look-back (any current per share metric as seen from a distant-future perspective looking back to the current period), are calculated as will be described later. Optionally within this box, but before all other calculations, scenarios can be weighted to improve accuracy as will be described.

In Box 1625, Steady-state earnings and dividends, possibly along with the other metrics, are passed to other routines for subsequent handling. Such subsequent handling could be as simple as printing, or displaying on a CRT, Steady-state earnings and dividends. It could be as complex as using the present invention's results to determine a subsequent execution of the present invention—as part of an elaborate simulation and/or optimization exercise.

Multiple and differing CSCLs can be simultaneously handled. So, for example, CSCL 1510 and CSCL 1520 could be initially loaded in Box 1601. Note that CSCL 1520 has twice the life span (extant life) as compared with the CSCL 1510. In Box 1719, both CSCLs would be duplicated and member function OrientInit of the duplicates called. The result is CSCLs 1510, 1511, 1512, 1513, 1514, 1520, 1521, 1522, 1523, and 1524. Multiple initial CSCLs would occur if The Corporation gave stock options on different terms to different employee groups. Multiple initial CSCLs could also occur as the result of multiple differing contingent contracts.

6.4.5.3. Legacy CSCLs

A CSCL can be extant, even though its extantStart is prior to Period 0. In other words, CSCLs with extantStarts prior to Period 0 are grandfathered into the analysis. So, for example, CSCL 1559 has an extantStart of Period −2. (See FIG. 15) This CSCL could regard some stock options given to a special supplier in Period −2. Since this special supplier still has rights that can be exercised, possibly resulting in dilution for the Reference-shareholders, this CSCL 1559 is included as part of what is handled in FIGS. 16 and 17. Though it is tempting to exclude CSCL 1559 from consideration, the resulting Steady-state earnings would be an overstatement: even if Period 0 were to repeat perpetually and exactly, the Reference-shareholders of Period 0 could not obtain the equivalent of such resulting Steady-state earnings, since part of such stated Steady-state earnings would be shared with the special supplier. Conceivably, CSCL 1559 could be a net benefit for the Reference-shareholders, since as shown in FIG. 11A, Reference-shareholders can gain, given the right circumstances, as the result of employee stock option exercise. If this applies, then excluding CSCL 1559 would result in an understatement of Steady-state earnings: even if Period 0 were to repeat perpetually and exactly, the Reference-shareholders of Period 0 would obtain more than suggested by the Steady-state earnings.

6.4.5.4. RepeatPeriod

RepeatPeriod is simply the period that is being perpetually repeated. As stated before, it is usually 0. Hence CSCL 1559 (See FIG. 15) is not duplicated nor its OrientInit function called in Box 1719. Note that CSCL 1559's extantStart (−2) does not equal the repeatPeriod of 0. RepeatPeriod is set to a positive integer when the present invention is used as a planning or evaluation tool, possibly by The Corporation itself or by investors. So, for example, The Corporation might have forecasts through and including Period 2; CSCL 1529 (See FIG. 15) might be included in the analysis because it is reflective of a planned contingent arrangement starting in Period 2. Thus far such a use has not been considered and such a possible use should not be interpreted to undermine what has thus far been presented. As will be described later, for evaluation or planning purposes, the user of the present invention might:
Pre-define earnCoreBase, dividendCore, other variates, and CSCLs for the first few periods,
Have the present invention perpetually repeat the last pre-defined period, which is termed repeatPeriod,
Use the results for evaluation and/or optimal planning.
   Unless explicitly stated, repeatPeriod is assumed 0 throughout this disclosure.
   6.4.6. Simulation Elements
   6.4.6.1. Log-Normal Random Number Generation

Generating random numbers, addressing the Inflated-Compounding Problem, and properly handling stochastic variates are key components of the present invention. These will be presented next. Master-drivers-variates 1405 and status-variates 1407 are generally stored in the ScenStep (Scenario Step) object, which also contains other data.

This explanation of the proper handling of stochastic variates will culminate in a tabular time-phase depiction of example data, shown in FIGS. 35A and 35B. For these figures, nPeriod equals 8 and thus data for Periods 1 thru 7 will be generated.

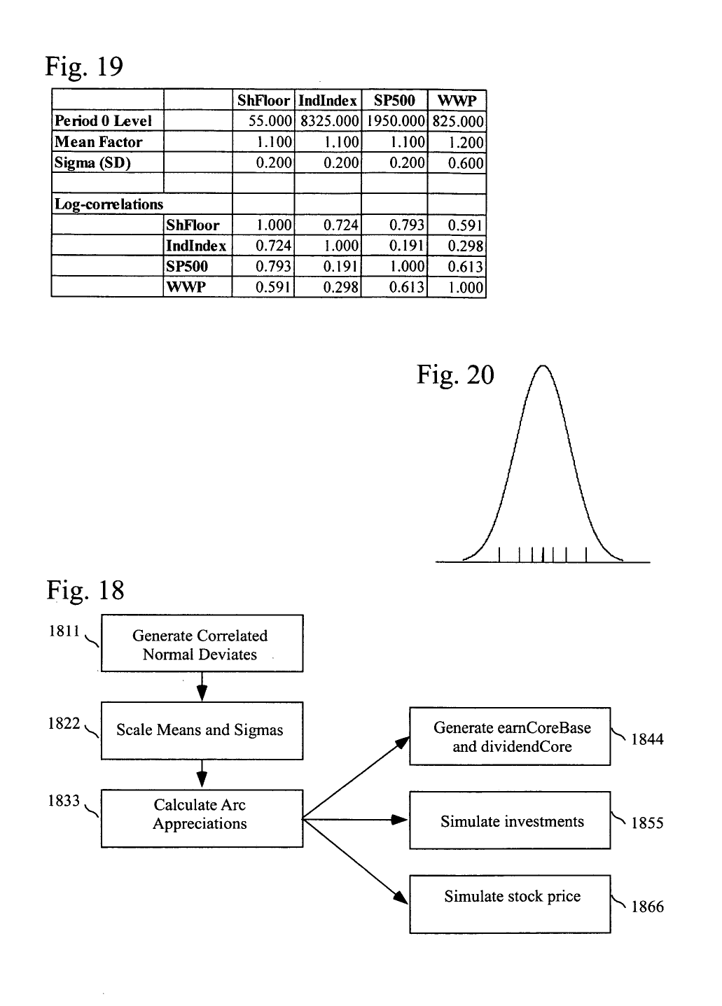

A good place to start is FIG. 18, which shows the main stream of generating random log-normal data that is based upon specified means, sigmas, and correlations. This stream is used to generate perpetually-repeating earnCoreBase and dividendCore values. As will be shown, parts of the stream are also used to generate other data. In Box 1811, a stratified, correlated sample of normally distributed deviates is generated. In Box 1822, the means and sigmas of the generated deviates are scaled. (Box 1811 corresponds to the LnRndBase class in the source code and Box 1822 corresponds to the LnRndGen class in the source code.) In Box 1833, Arc-appreciations are done. An Arc-appreciation is an appreciation between two periods that corrects for the Inflated-Compounding Problem. In Box 1844, earnCoreBase and dividendCore are generated.

As previously mentioned, the Elaborate Example has four Master-driver-variates. FIG. 19 lists these four variates and displays target-scenario-means, sigmas, and correlations. Seven values for each of the four variates will be generated.

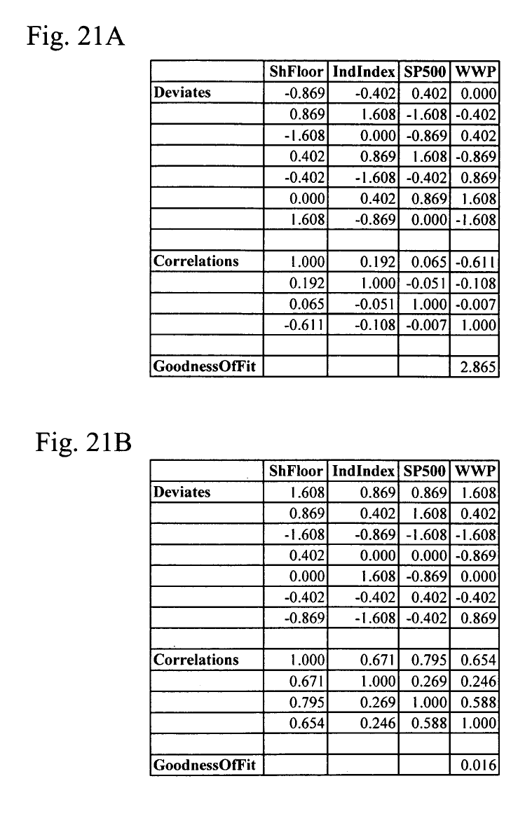

The first step in Box 1811 is to identify a stratified sample of seven normally-distributed deviates for each of the four variates. FIG. 20 shows the normal distribution curve with a mean of 0.0 and a sigma of 1.0. As shown in the source code, seven normally-distributed deviates, each with equal probability of occurrence, are identified (by function RndNormalDiscrete). These deviates' values are marked as vertical line segments in FIG. 20. Now if each of four sets of seven deviates is randomly ordered and arrayed, the result, in this particular case, is the first seven rows of FIG. 21A. Log-correlations between these four variates are shown in the middle of FIG. 21A. Summing the square of the differences between each correlation of FIG. 19 and the corresponding correlation in FIG. 21A yields 2.865—a goodness-of-fit measurement.

Now if the −0.869 and 0.402 of the ShFloor column is swapped, then the correlations and in turn goodnessOfFit also change. In this particular instance, goodnessOfFit desirably decreases to 2.863. In the source code, LnRndBase::DoFitting does an exhaustive search to consider all such possible swaps and employs tactics to expedite the process. In this particular case, the final result is shown in FIG. 21B. Notice how the correlations are reasonably aligned with the correlations of FIG. 19 and how goodnessOfFit has decreased to 0.016. If the number of deviates were increased beyond seven, the final goodnessOfFit would approach 0.000, meaning that a perfect match between target correlations (of FIG. 19) and resulting correlations (of FIG. 21B) would be obtained.

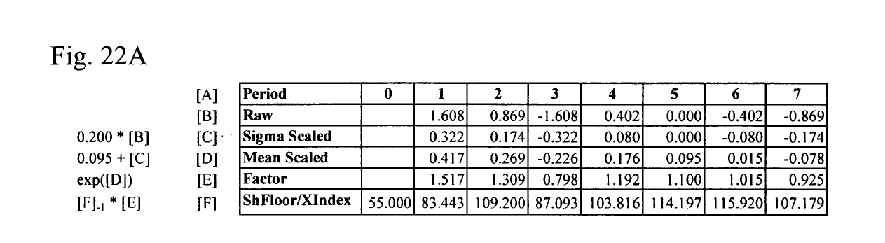

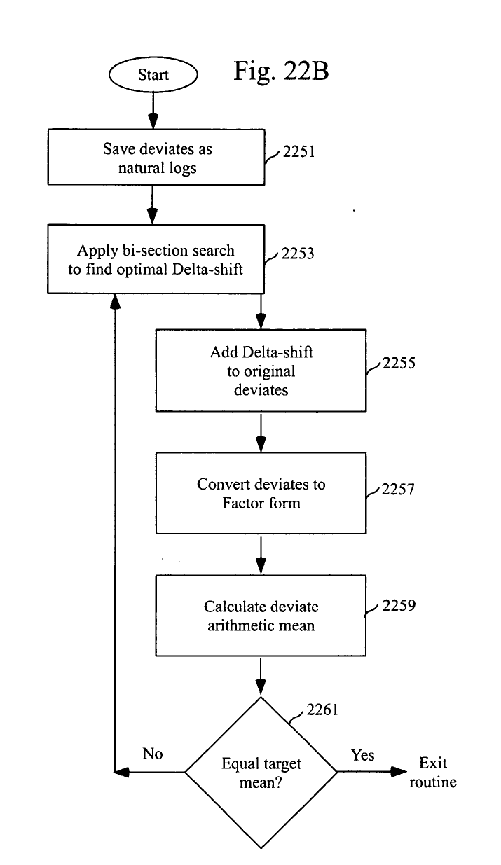

Now if the shFloor column deviates of FIG. 21B are transposed, the result is the Raw row of FIG. 22A. Multiplying this row by 0.200, the sigma of ShFloor, results in the Sigma Scaled row of FIG. 22A. Since the mean is 0.000, 0.095 (natural log of 1.1) is added to each element, resulting in the Mean Scaled row of FIG. 22A. Applying the exponential function to each of these values results in the Factor row of FIG. 22A. Finally, using the initial shFloor value of 55, these Factors are applied to yield the shFloor row in FIG. 22A. This last row is a Scenario-path for shFloor. This same transformation of deviates is applied to the other three log-normal variates, all of which results in the first four rows of FIG. 35A. These first four rows constitute the Master-driver-variates for the scenario at hand.

There are several things to note about these four rows:
1. Each has a log-normal mean and sigma as specified in FIG. 19.

2. The four log-normal variates have log-correlations as specified in FIG. 21B, which reasonably match the log-correlations of FIG. 19. (Means and sigma scaling do not affect the log-correlations.)
3. Between Periods 0 and 7, each log-normal variate exactly appreciates as specified by the mean factors as shown in FIG. 19. (Hence, a perfect “regression towards the mean” is obtained.)
4. Since each deviate is equally likely to occur in each of the four rightward columns cells of FIG. 21A, each of the 7! (5040) possible Scenario-paths for each of the four variates is equally likely to occur.
5. Since the original deviates constitute a stratified sample, the resulting Scenario-paths constitute a stratified sample.

The process of scaling a row to have a specific mean (as was done when transforming the Sigma Scaled row to the Mean Scale row of FIG. 22A) is termed here as Anchoring. It overcomes the Inflated-Compounding Problem when considering a Scenario-path from end-to-end, e.g., the mean appreciation in the bottom row of FIG. 22A is 1.100 since:
55.000*1.100⁷=107.179
   Desirably, mean-reversion is implicitly being addressed and simulated.

The individual Factors, 1.517, 1.309, . . . , however, have a mean of 1.122. Hence the Inflated-Compounding Problem exists for appreciations over a single period.

The description of Box 1822 is now complete.

6.4.6.2. Arc-Appreciations

Building upon Box 1822, Box 1833 calculates Arc-appreciations, and so it makes sense to build upon the sample data shown in FIG. 22A. However, Box 1833 is directly applied to IndIndex, SP500, and WWP, and indirectly applied to shFloor. Hence, to help retain a distinction between shFloor and the functioning of Box 1833, the bottom row of FIG. 22A is synonymously named xIndex and this synonym is used to refer to the generic functioning of Box 1833.

Before addressing the details of Arc-appreciation, considering FIG. 22B, which introduces the procedure to determine Arc-appreciations, can be helpful. A set of log-normal deviates is saved in log format in Box 2251. In Box 2253, a bi-section search is started to determine a Delta-shift value that corrects for the Inflated Compounding Problem. Bi-section search is a well-known computer science technique, and its general functioning is not discussed here. For details on an example implementation, see accompanying source code. For each considered Delta-shift, the bi-section search entails adding Delta-shift to the deviates (Box 2255), converting the deviates into Factor form (Box 2257), calculating the mean (Box 2259), and then in Diamond 2261, determining whether an appropriate arithemetic mean has been obtained.

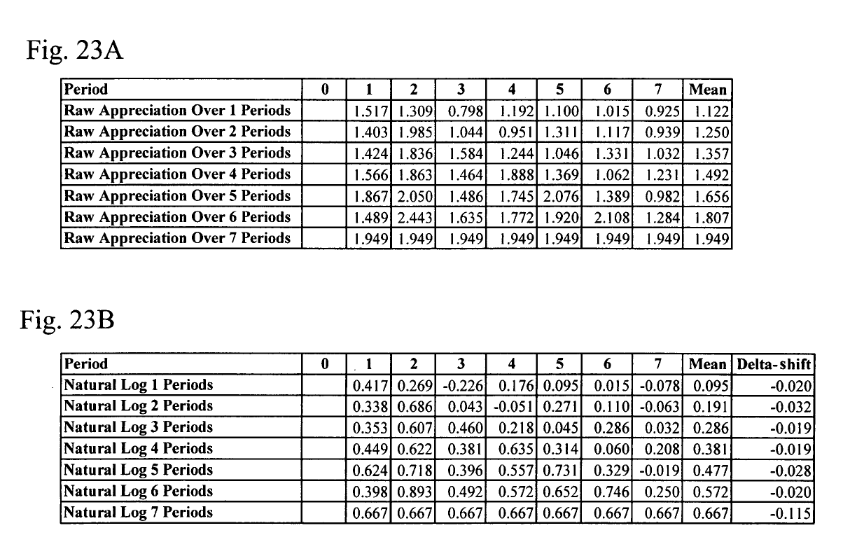

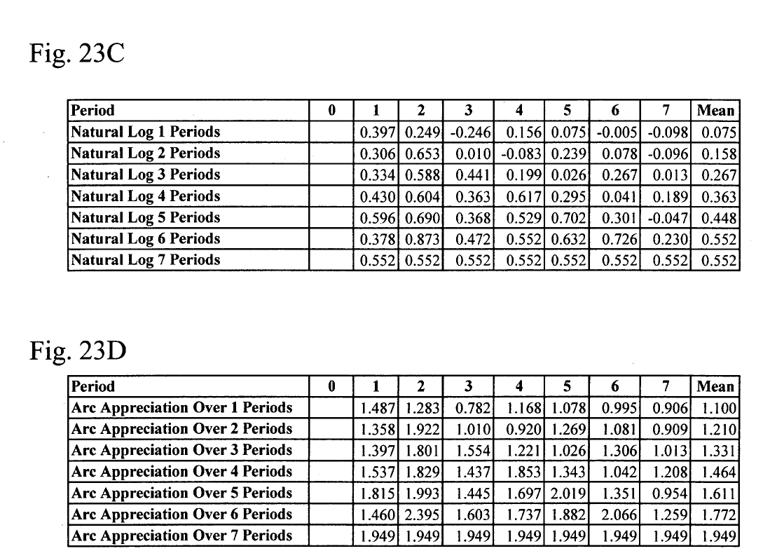

Looking at the xIndex values as shown in the bottom of FIG. 22A, many appreciations become apparent: for example, the appreciation from Period 3 to Period 4; from Period 2 to Period 4; from Period 2 to Period 5, etc. The upper right diagonal portions in Period columns 1 through 7 of FIG. 23A show these appreciations in Factor form: the raw appreciation-over-time, of 1 period, from Period 3 to Period 4 is 1.192 (103.816/87.093=1.192); over 2 periods, from 2 to 4 is 0.951 (103.816/109.200=0.798*1.192); over 3 periods, from Period 2 to Period 5 is 1.046 (114.197/109.200=0.798*1.192*1.100), etc.

Now if the starting point of the Factor row of FIG. 22A is assumed arbitrary, which it is, wrapping around from Period 7 to an earlier Period can be considered and used to determine the lower left portion of FIG. 23A. So, for example, the appreciation-over-time, of 1 Period, going from Period 7 to Period 1 is 1.517, the appreciation-over-time, of 2 periods, going from Period 6 to Period 1 is 1.403 (=0.925*1.517); the appreciation-over-time, of 5 periods, going from Period 5 to Period 3 is 1.486 (=1.015*0.925*1.517*1.309*0.798), etc.

Now the arithmetic mean of each row of FIG. 23A can be calculated as shown in the Mean Column. In comparison with the middle column of FIG. 5B, because of Anchoring, the appreciations (1.949) over 7 periods are equal. The means in FIG. 23A of appreciations-over-time of 1 to 6 periods, however, are consistently larger. What this indicates is that if the appreciations-over-time in FIG. 23A were randomly selected as part of a computer simulation, then overall appreciation is likely higher than it should be: in other words, the Inflated-Compounding Problem has come to fore.

Now if the natural log of Period columns 1 through 7 of FIG. 23A is computed, the result is as shown in FIG. 23B. Means for each row are as shown. These means are exactly what would be mathematically-expected, namely:
Number of Periods*log(1.1)

Now suppose that somehow the Delta-shift values as shown in FIG. 23B are determined. If these Delta-shift values are added to each log value, the result is as shown in FIG. 23C.

If the exponential function is applied to Period columns 1 through 7 of FIG. 23C, the result is FIG. 23D. Row means are calculated as shown. Now, in comparison with the middle column of FIG. 5B, the mean appreciations over each same-length period are equal. So, for example, if an appreciation-over-time of three periods is needed, and the relevant appreciation is selected from the third row of FIG. 23D, the mathematically-expected mean is 1.331, which ties with the 1.331 of FIG. 5B. The result is that if the appreciations-over-time in FIG. 23D are randomly selected as part of a computer simulation, then overall appreciation is likely exactly what it should be: the Inflated-Compounding Problem has been neutralized.

The appreciations-over-time of FIG. 23D are termed here as Arc-appreciations. So, in the present example, the 3-period Arc-appreciation from Period 3 to Period 6 is 1.306. In the source code, Arc-appreciation is determined by the LnRndDeltaShift function. Rather than working with an explicit Delta-shift variable, bi-section search, as described in FIG. 22B, is used to scale what is analogous to each row of FIG. 23C, so that the result is analogous to the corresponding row in FIG. 23D. Specifically, bi-section search is used to solve for Delta-shiftᵢ:
E[e^{l}^{_{i,j}}⁾*e^{(Delta-shift}^{ᵢ}⁾]=1.100¹
   where:
l_{i,j}=value corresponding to iₜₕ row and jₜₕ column of FIG. 23B, i.e., l_{2,3}=0.043
i=Number of Appreciation-over-time Periods
j=Ending period, 1 to nPeriod−1
e=2.71828 . . .
E[ ] is a mathematical-expectation operator

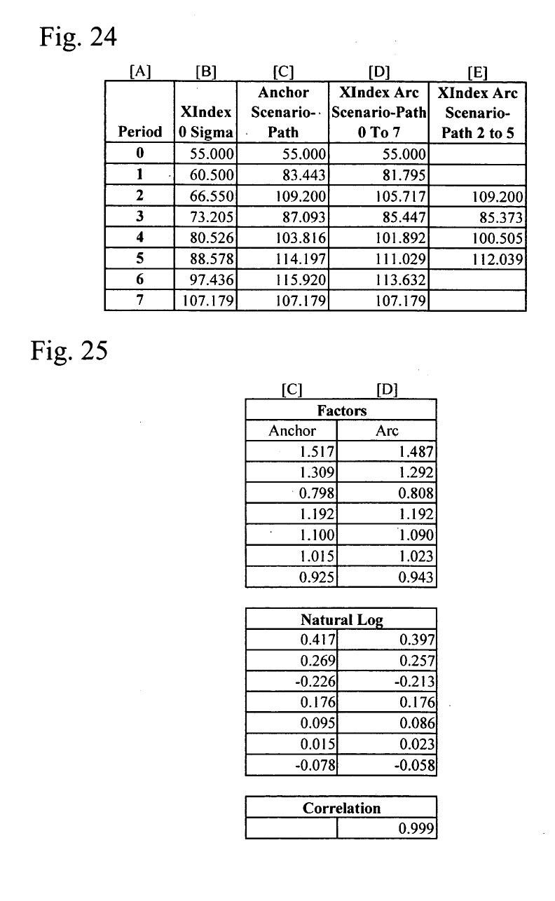

The bottom row of FIG. 22A ([F]), which is ShFloor/xIndex, is called an Anchor Scenario-path and is shown in FIG. 24 as a column [C]. To the left of this column are xIndex levels assuming a constant 10.0% appreciation between periods. To the right is the Arc Scenario-path starting at Period 0 and ending at Period 7. Its level at Period 0 is 55.000, since that is the initial value. The level at Period 1 is 81.795, since (see FIG. 23D):
55.000*1.487=81.795.
   The level at Period 2 is 105.717, since
55.000*1.922=105.717.
   The level at Period 3 is 85.447, since
55.000*1.554=85.447.
   And this can be continued to yield a level of 107.179 for Period 7. (See FIG. 23D.)

Now in comparing the Arc Scenario-path levels with the Anchor Scenario-path levels, with the exception of end Periods 0 and 7, which are equal, all Arc Scenario-path levels are less than the corresponding Anchor Scenario-path levels. This is because the Arc Scenario-path levels reflect a correction for the Inflated-Compounding Problem.

The Arc Scenario-path is highly log-correlated with Anchor Scenario-path as shown in FIG. 25. The top block shows the Anchor Scenario-path and the Arc Scenario-path in Factor form, i.e., Row E of FIG. 22A and Column D of FIG. 24 (1.292=105.717/81.795). The middle block shows the natural log of these factors. The bottom block shows the log-correlation between two columns of the middle block—a very high 0.999.

An Arc Scenario-path does not necessarily need to start with Period 0 and finish with the last period, here Period 7. So instead, for example, it could start with Period 2 and end with Period 5, as shown in the right of FIG. 24. The initial level is the same as the Anchor Scenario-path, in this case 109.200. The level at Period 3 is 85.373, since
109.200*0.782=85.373.
   The level at Period 4 is 100.505, since
109.200*0.920=100.505.
   And this can be continued to yield a level of 112.039 for Period 5.

As before, the log-correlation of the Arc Scenario-path is highly log-correlated with the Anchor Scenario-path.

6.4.6.3. Theorem

The log-correlation between a finite-length Arc Scenario-path and its defining Anchor Scenario-path approaches 1.000, as nPeriod approaches infinity. To see this,

The mean of the first row in FIG. 23B—0.095—is what is to be expected, since it is the basis for scaling in Row D of FIG. 22A. Being simplistic, we would expect that the mean for the second, third, . . . rows in FIG. 23B would be 0.190, 0.285, . . . respectively; i.e., integer multiples of 0.095. But this simplistic expectation is not realized because of randomness, the small sample size, and sample stratification. If, however, the sample size is increased, i.e., nPeriod becomes much greater than seven, then mathematical-expectation becomes an accurate estimate, with the result that the means for the first few rows that would appear in FIG. 23B become simple integer multiples of 0.095, i.e., 0.095, 0.190, 0.285, etc.

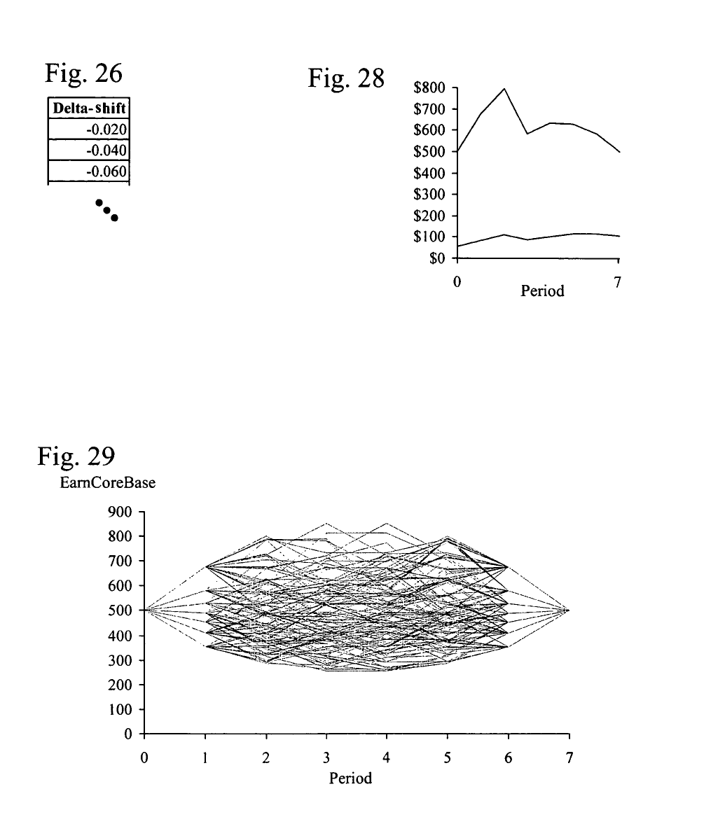

With the means becoming integer multiples of 0.095, the Delta-shifts in turn become multiples of −0.020, as shown in FIG. 26. In general, for small i, as nPeriod approaches infinity:
Delta-shiftᵢ→*Delta-shift₁
   The result is that each element of the first row of FIG. 23B is decremented by the same amount, Delta-shift₁; each element of the second row by twice the amount, Delta-shift₂; etc. But such uniform decrementing only affects the means and it does not affect the log-correlations. In other words, it is as if the Factors of FIG. 22A are multiplied by a constant that is less than 1.0, which does not affect log-correlation. Hence, given nPeriod sufficiently large, the resulting Arc Scenario-path is perfectly log-correlated with the Anchor Scenario-path. Being perfectly log-correlated, the Arc Scenario-path has the same sigma as the Anchor Scenario-path.

This completes the description of Box 1833, which in the source code is handled by the LnRndArc class.

6.4.6.4. EarnCoreBase Generation

After Box 1833, Arc-appreciations are used in several contexts. These contexts are summarized in FIG. 18: in Box 1844, earnCoreBase and dividendCore are generated; in Box 1855, investments and investment returns are simulated; in Box 1866, the stock-price is simulated.

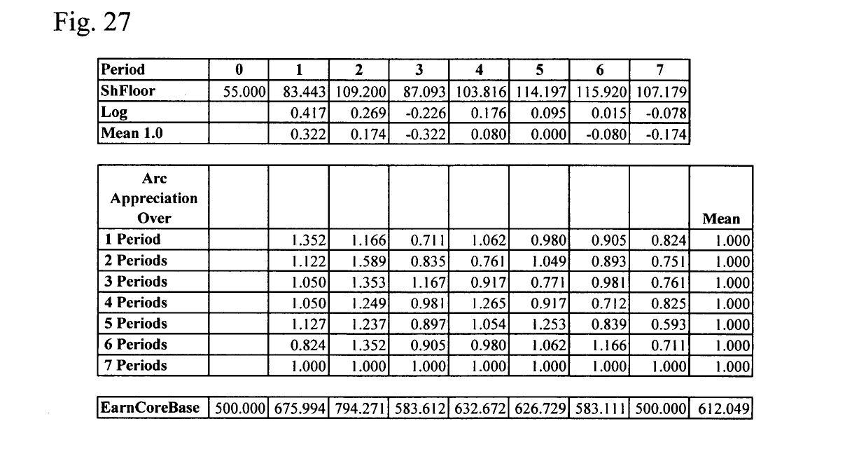

To generate a sequence of earnCoreBases, Box 1844, the natural log of shFloor is determined as shown in the second row FIG. 27, which matches the mean scale row of FIG. 22A. The mean is scaled to 1.000 (Factor format). The scaled row is then used to generate Arc-appreciations, as shown in the middle of FIG. 27. Multiplying the Period 0 earnCoreBase with the diagonals of Arc-appreciations yields an Arc Scenario-path. So, for example, earnCoreBase in Period 3 is:
583.612=500*1.167
   and hence, the value in the bottom row of FIG. 27.

The mathematically-expected value of earnCoreBase for Periods 1, 2, 3, . . . equals the value in Period 0, since the mathematically-expected value of each Arc-appreciation is 1.000 (Factor format). The earnCoreBase at the end period returns to its Period 0 value, since mean appreciation mean has been scaled to 1.000.

The log-correlation between shFloor and earnCoreBase is very high—0.999 in this case. Visually, this is suggested in FIG. 28, where the Scenario-path for earnCoreBase is the upper curve and the Scenario-path for shFloor is the lower curve. Since it is the log values that are used to determine log-correlation, the correlation shown in FIG. 28 is not striking.

FIG. 29 shows 128 randomly selected earnCoreBase Scenario-paths from the 5040 (7!) possible permutations, given the seven normal deviates, and specifically includes Scenario-paths that have extreme earnCoreBases in each period. Note that the extremes (255, 850) occur in the middle of the Scenario-paths and the central tendency occurs about the 500 level. The mean earnCoreBase of FIG. 29 happens to be 493. With a larger sample, the mean would better approach 500. More importantly, however, is the use of weighting to obtain an exact weighted 500 mean. This will be explained later.

For Periods 1, 2, 3, . . . , dividendCore is set to the same proportion to earnCoreBase that it has in Period 0. In other words, The Corporation is assumed to pay as dividends a constant proportion of earnCoreBase, typically between 0.0% and 100.0%, though possibly above 100.0%. Reinvestments and reinvestment returns are assumed reinvested and are never paid as dividends.

(In the source code, EarnCoreBase and DividendCore are generated by the TSEarnDiv [Time-Sequence EarnCoreBase-DividendCore] class, which uses shFloor as its primarily initializing parameter.)

(One could be tempted to bypass Arc-appreciation and simply generate earnCoreBase by scaling the top row of FIG. 27, doing something similar, or using Period 0 earnCoreBase as a constant for subsequent periods. This, however, leads to either the Inflated-Compounding Problem, an incorrect variance, and/or and an incorrect mean across multiple scenarios.)

6.4.6.5. Investments/Reinvestments

6.4.6.5.1. Simple Investments

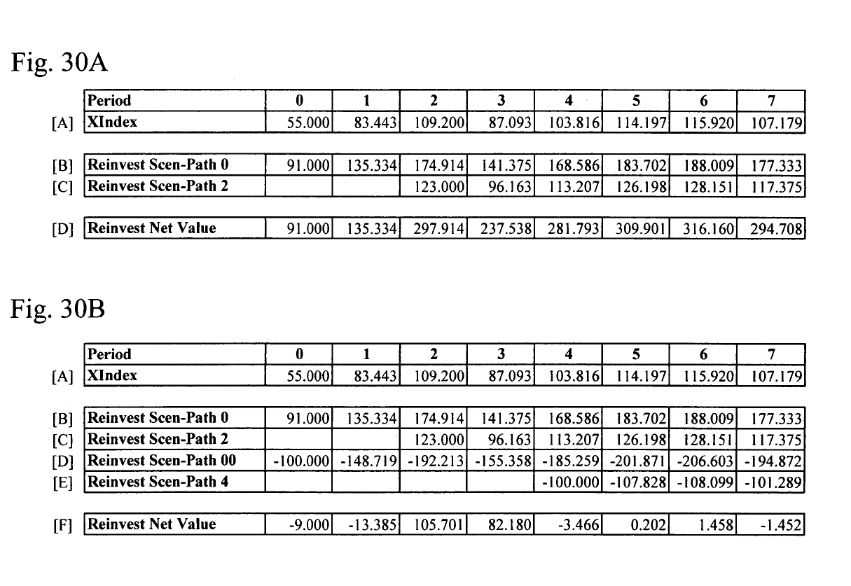

To simulate investments and investment returns, Box 1855 entails noting the amounts invested in each period, using Arc-appreciations to determine the values in each subsequent period, and aggregating the resulting period values. This is shown in FIG. 30A, where the Anchor Scenario-path xIndex has been duplicated from FIG. 22A (alternatively, FIG. 24). Suppose a $91.000 investment is made in Period 0 in xIndex, which for the moment happens to be either a tradable stock index or the price of a particular stock. Per FIG. 23D, the Arc-appreciation from Periods 0 to 1 is 1.487. Hence, in Period 1, the $91.000 is worth $135.334 (91.000*1.487); in Period 2 it is worth $174.914 (91.000*1.922); in Period 6 it is worth 188.009 (91.000*2.066); etc. Suppose a second investment of $123.000 is made in Period 2; it is worth $96.163 in Period 3 (123.000*0.782); etc. The net value in each period is the sum of the time-phased worth of each investment as shown. Negative investments/withdrawals are handled similarly: so, for instance, if in addition to what is shown in FIG. 30A there are $100 withdrawals in Periods 0 and 4, the results are as shown in FIG. 30B. Since each Arc Scenario-path is highly log-correlated with its defining Anchor Scenario-path, the four streams shown in FIG. 30B, Rows B through E, are highly log-correlated.

At a simple level, all investments, investment returns, divestments (loans), divestment costs (interest) are handled as shown in FIGS. 30A and 30B; in the source code, such functionality is handled by the TSlsp [Time-Sequence Long/Short Position]class.

6.4.6.5.2. Corporate Reinvestments

Unfortunately, modeling The Corporation's reinvestments requires additional special handling. In each period, the net gain (or loss) in cash (EarnCoreBase−dividendCore plus what might be paid-in, or withdrawn, by the CSCLs) is reinvested, and such reinvestment appreciates in line with shFloor. With both earnCoreBase and reinvestment performance being derived from the same shFloor, they are, in a manner, highly correlated. On the one hand such is a desirable result, since The Corporation's performance is dictated by Point 201 of FIG. 2 and, as discussed previously, diversification is not allowed by the shareholders. On the other hand, this leads to a downward bias in the resulting, final, investment values. This occurs because the earnCoreBase of, say, Period 2 is based upon appreciation between Periods 0 and 2, while the reinvestment of the Period 2's earnCoreBase is based upon appreciation between Periods 2 to 7. Because of the stratified sampling as shown in FIG. 20, when the appreciation is relatively high between Periods 0 and 2, it is relatively low between Periods 2 and 7. (And vice-versa.) As a consequence, early high earnCoreBases have low subsequent appreciation, while early low earnCoreBases have high subsequent appreciation. (And vice-versa.) Because of non-linearity, the net result is a downward bias in the final resulting terminal reinvestment values.

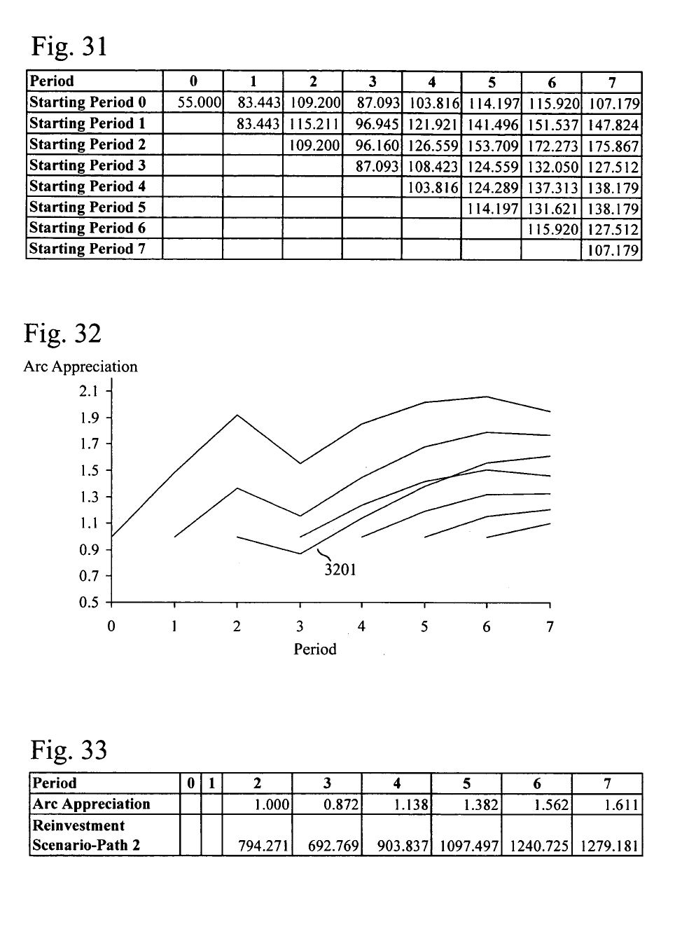

The strategy to overcome this bias is, for each period, to re-scale the rightward portion of shFloor so that the period's reinvestment stream has a mean appreciation of shFloor_MeanAppreciation (1.100) prior to determining Arc-appreciations. So, for example, for starting in Period 0, shFloor is used as is as shown in the top row of FIG. 31. For starting in Period 1, the original Period 1 value of 83.443 is kept, but the subsequent values are scaled so that the ending Anchor Appreciation is 77.2% i.e.,
147.824/83.443=1.772
   This forces the mean over the six periods to be 1.100 on a per period basis. For starting in Period 2, the original Period 2 value of 109.200 is kept, but the subsequent values are scaled so that the ending Anchor Appreciation is 61.1% i.e.,
175.867/109.200=1.611
   And the process is repeated for the other starting periods.

These re-scaled rightward portions of shFloor are then used to determine Arc-appreciations, which are in turn used to determine the subsequent value of reinvestments. So, for example, assume that the earnCoreBase of Period 2 ($794.271, FIG. 27) is reinvested. The right portion of the shFloor of the top row of FIG. 27 is obtained. Taking 109.200 as the starting value for Period 2, the right portion (Periods 2 through 7) is Anchored to have a mean appreciation of 10.0%. The result is the third row in FIG. 31. This row is then used to yield Arc-appreciations in FIG. 32, which are also shown in FIG. 33. The resulting values of the original $794.271 in the different periods are shown in FIG. 33 and are tallied as described in FIGS. 30A and 30B.

FIG. 32 also shows that both the Arc-appreciations between each period and the terminal period is 10.0% and that the Arc-appreciations are log-correlated. As shown in FIG. 32, appreciation between Periods 6 and 7 is 10.0%; between Periods 5 and 7 it is 21.0%; . . . between Periods 0 and 7 it is 94.9%. A very important property to note is that the mathematically-expected terminal reinvestment value is the same as if shFloor_Sigma were zero, or in other words, if a simple deterministic perspective were assumed or applied.

This bias correction is handled by the TSlspFP [Time-Sequence Long/Short Position Funnel Point] class in the source code. TSlspFP is derived from TSlsp and contains multiple LnRndArcs, each of which handles a different starting period.

(As discussed previously, shFloor is the only random variate required in the preferred embodiment of the present invention. It drives or determines earnCoreBase, stockPrice, and reinvestment appreciation. For illustrative purposes, IndIndex, SP500, and WWP are also included in the present Elaborate Example as exogenous random variates that are partly independent from shFloor. If the specified non-diagonal correlations of FIG. 19. were all zero, then IndIndex, SP500, and WWP would be statistically independent of shFloor.)

6.4.6.6. Stock-Price Simulation

At a basic level, simulating the stock-price (Box 1866) entails directly using shFloor for the stock-price, coupled with Arc-appreciations. Hence, the Anchor Scenario-path for shFloor in FIG. 22A could be used to simulate the stock-price and FIG. 23D used for Arc-appreciations. It is because of dividends, however, that something beyond FIGS. 22A and 23D is needed.

The Reference-shareholders receive their return in one of two ways: as dividend payments by The Corporation and through stock-price appreciation. Because the Reference-shareholders demand that The Corporation perform as dictated by Point 201 in FIG. 2, (and because it is assumed that the Reference-shareholders are successful in their demands) without dividends, the stock-price would perform as dictated by Point 201 and in turn shFloor. The presence of stock grants, options, etc. is irrelevant to the stock-price, since the Reference-shareholders demand that the stock-price, for them, perform as dictated by Point 201 and in turn shFloor. The stock-price for a single share is modeled along the lines as suggested by FIGS. 22A and 23D. Adjustments for dividends are made by proportioning the post-dividend stock-prices. So, for example, initially the bottom row of FIG. 22A might be the stock-price Scenario-path. If a per share dividend of 10.920 is paid-in Period 2, because such a payment constitutes 10.0% of the share-price, for Periods 3, 4, . . . , the stock-price is 90.0% of that shown in FIG. 22A. If a per share dividend of 7.838 (78.384=87.093*0.900) is paid-in Period 3, because such a payment constitutes 10.0% of the revised share-price, for Period 4, . . . , the stock-price is 81.0% of that shown in FIG. 22A.

As mentioned before, dividendCore is a fixed proportion of earnCoreBase. Assuming for the moment that earnCoreBase, and in turn dividendCore, are constant, then the per share dividend will decrease as Perpetual-repetition occurs because the constant dividendCore is spread over evermore shares. Thus, the stock-price calculation uses the evermore diluted per share dividend.

There are two types of Arc-appreciations for The Corporation's own stock-price: A) the appreciations that reflect dividend receipt; B) the appreciations that do not reflect dividend receipt. For the former type, for example, suppose that The Corporation makes an open market purchase of two shares to be eventually given to a particular employee, and that until the transfer is made, dividend proceeds are reinvested in The Corporation's own stock. The employee prematurely leaves and surrenders the two shares. The Corporation in turn sells the two shares, plus what was purchased with the dividends, on the open market. What is value of the sale? Since the initial value is known, simple Arc-appreciation as previously described is applied to the initial purchase value. Dividends are ignored. To consider the latter case, suppose that the dividends went to the employee prior to surrender. Obviously, the sale proceeds for The Corporation are less. This is handled by initially ignoring the dividends, determining starting and ending values, subtracting the appreciative value that would have been realized had the dividends been received and reinvested, and then dividing ending value by starting value to obtain an Arc-appreciation.

In the source code, The Corporation's own stock-price is simulated by the TSStockPrice (Time Sequence Stock-price) class.

6.4.6.7. Internal Corporate Scale-Variates

As thus far shown, Point 201 of FIG. 2A is the fundamental driver. It determines the parameters to generate shFloor. ShFloor, in turn, determines stochastic disturbances to earnCoreBase, determines appreciations for reinvestments, and serves, if needed, as the basis for The Corporation's stock-price. Besides shFloor, in the Elaborate Example, there are three other Master-driver variates: IndIndex, SP500, and WWP.

What is lacking, however, is the generation of The Corporation's internal variates, such as the number of employees, which are termed here as Scale-variates. For illustrative purposes, in the Elaborate Example, the Scale-variates are revenue, IWP, and number of employees. As before, in an implementation of the present invention, other Scale-variates could be used as suggested here. Scale-variates are determined by variate corpScale, which in turn is determined by reinvestment, assuming constant economies of scale.

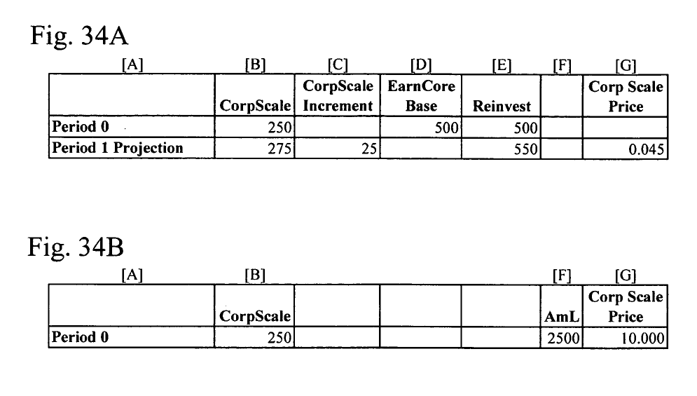

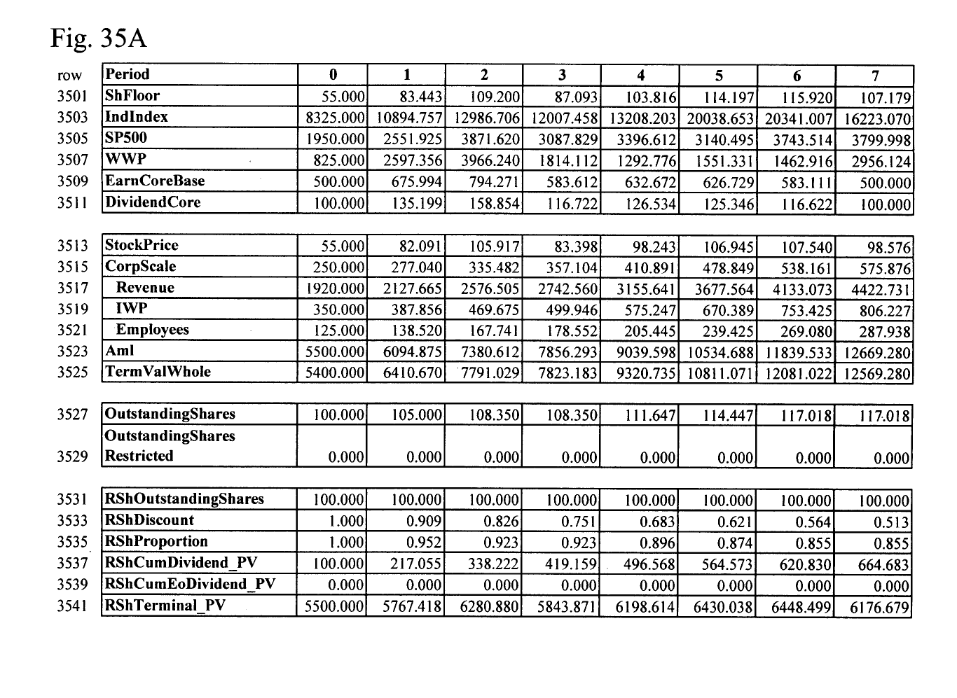

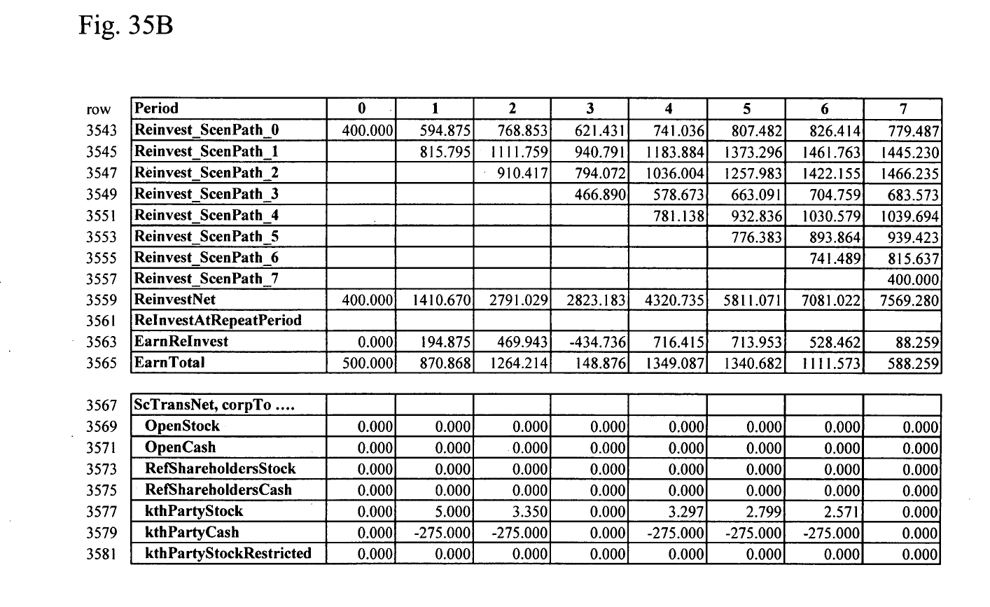

For Period 0, corpScale is set to an arbitrary initial value, say 250. Assuming no dividends and that earnCoreBase in Period 0 is $500, if the $500 were reinvested, the expected investment value in Period 1 would be $550 as shown in FIG. 34A. Per the dictates of Point 201, both The Corporation and corpScale should grow by 10.0%. Hence, projected corpScale in Period 1 is 275, an increment of 25. Dividing 25 by 550 yields 0.045. This 0.045 is termed as corpScalePrice. It is the forward price for buying corpScale increments. So, for example, assume that dividends are 100. This leaves 400 for reinvestment, which would be worth 440 in Period 1. Multiplying the 440 by 0.045 yields 20; hence corpScale in Period 1 is 270.

Though the worth of the $400 reinvestment in Period 0 on average appreciates 10.0%, appreciation is directly tied to shFloor. So, for example, the reinvestment might be worth 594.875 in Period 1. Given this 594.875, corpScale is then 277.040 in Period 1.

Given the corpScale of 277.040 in Period 1, Scale-variates are scaled accordingly. So, for example, if there are 125 employees in Period 0, there are an estimated
125*277.040/250=138.520
   employees in Period 1.

Another way to determine corpScalePrice is shown in FIG. 34B. Given the arbitrary 250 corpScale and given assets minus liabilities, corpScalePrice is the latter divided by the former, as shown in the figure.

The method shown in FIG. 34A is in keeping with the spirit of Perpetual-repetition, avoids the associated errors with cumulative histories that can be embedded in assets minus liabilities values, and is the preferred-embodiment method to determine corpScalePrice. Whether to use the method in FIG. 34A or 34B is specified by a parameter in the source code, paraCSCL_corpScaleType_ReInvest_AmL. Note that corpScalePrice comes into consideration only if one of the active CSCLs needs a Scale-variate determined by corpScale.

6.4.7. Simulation Unification

The point has now been reached to unify what has been shown subsequent to FIGS. 13A and 13B. A tabular time-phase depiction of example ScenStep data is shown in FIGS. 35A and 35B. The steps for generating this single-scenario data will be explained using FIGS. 16 and 17 as a guide.

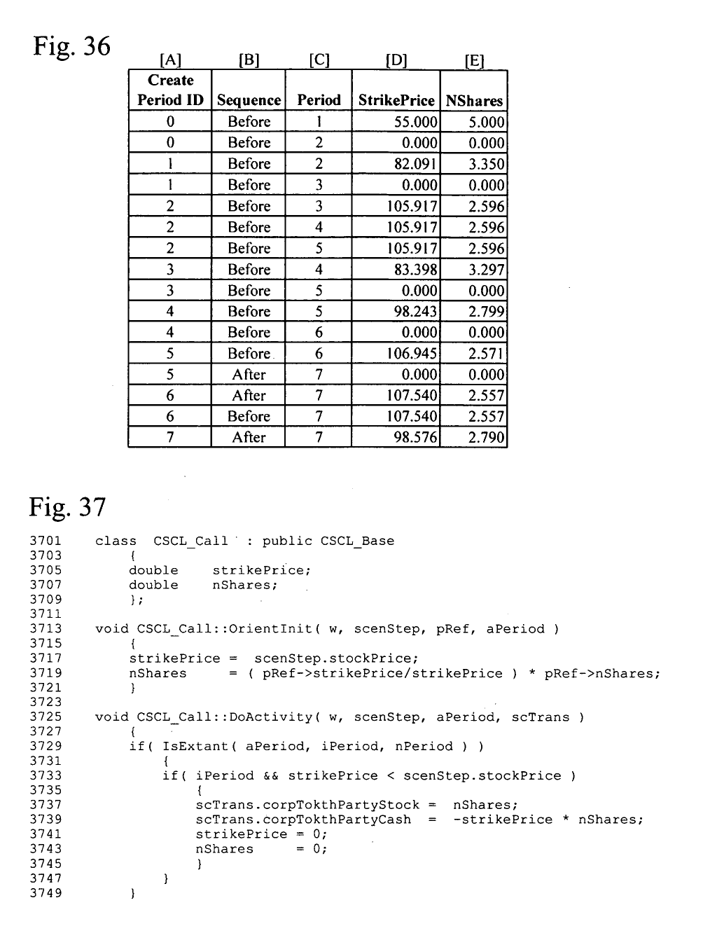

A key feature of this unification is showing the operation of a CSCL that regards an employee call stock option. The option was granted in Period 0 for five shares, has a strike-price equal to the stock-price at the end of Period 0, and expires at the end of Period 1. This particular type of CSCL operation is handled by the CSCL_Call class. Most salient points regarding this class are shown in FIG. 37. To execute the scenario of FIGS. 37A and 37B, eight different instances of this class are created and instance-state data is shown in FIG. 36.

6.4.7.1. Master-Driver-Variate Generation

In Box 1605, shFloor (Row 3501 of FIG. 35A) is generated as previously shown in FIG. 22A. IndIndex, SP500, and WWP are also generated concurrently with shFloor.

6.4.7.2. EarnCoreBase/dividendCore Generation

EarnCoreBase (Row 3509) is generated as previously described with respect to FIG. 27 and dividendCore is set to a constant fraction of earnCoreBase as shown in Row 3511. This constant fraction is the fraction of (preset) dividendCore in Period 0 divided by (preset) earnCoreBase in Period 0.

Rows 3501 through 3511 are completely independent of, and are at least partly determinative of, Rows 3513 through 3523.

6.4.7.3. Initialization

In Box 1607, Period 0 is initialized, processed, and closed. The initialization entails loading the ScenStep object with Period 0 values for Rows 3513 through 3523 and for Rows 3527 and 3529. Both OutstandingShares and OutstandingSharesRestricted are start-period, as opposed to end-period, numbers. OutstandingShares includes OutstandingSharesRestricted. Further initializations include:
RShOutstandingShares (Reference-shareholder Outstanding-shares) is set equal to OutstandingShares.
RShDiscount (Reference-shareholder Discount) is set equal to 1.000.
RShProportion (Reference-shareholder Proportion) is set equal to 1.000.
   6.4.7.4. CSCL Creation and Loading

A CSCL_Call object is created and loaded with initialization data as shown in the top row of FIG. 36, where create period ID=0, sequence=Before, and period=1.

Processing entails calling CSCL_Call member function DoActivity, which in the particular circumstance does nothing in Period 0. (For other CSCLs or under different circumstances, the DoActivity function could cause entries to be generated in Period 0, Rows 3569 through 3581. So, for example, if a CSCL_Call were issued in Period −1, then entries in Rows 3569 through 3581 could be triggered. Generation and handling of such entries is the same as for Periods 1, 2, 3 . . . and will be explained shortly.)

6.4.7.5. Period 0 Closing

Period 0 closing, Box 1607, entails:
Posting the surplus of earnCoreBase—dividendCore (400) to reinvestment, as shown as shown in Row 3543;
Setting rShCumDividend_PV (Reference-shareholder Cumulative Dividend Present-value) equal to 100 *rShProportion*rShDiscount;
Setting term ValWhole (Terminal Value Whole Corporation) equal to reInvestNet (400) plus the present-value of an infinite series of earnCoreBases starting in the next period (5000);
Setting rShTerminal_PV (Reference-shareholder Terminal Present-value) equal to termValWhole*rShProportion*rShDiscount+rShCumDividend_PV+rShCumEoDividend_PV
   6.4.7.6. Open Period

In Box 1713, Period 1 is opened. The stock-price is set as previously discussed. ReInvestNet is set equal to the value of all reinvestments, in this case 594.875. At this point, reInvestNet does not yet include additions and subtractions that might occur in the Period 1. The gain (or loss) in reInvestNet is entered in Row 3563, Period 1. This amount, plus earnCoreBase (675.994), is entered in Row 3565. As shown before, this value of reInvestNet sets corpScale at 277.040, which in turn sets the number of employees at 138.520. Both Revenue and IWP are similarly scaled based upon corpScale. RShDiscount is multiplied by shFloor_Discount so that it is the applicable discount rate for the Reference-shareholders for Period 1. ReInvestNet is added to aml, assets minus liabilities.

6.4.7.7. CSCL DoActivity

In Box 1715, member function DoActivity of each CSCL is called. As shown in Lines 3729-3745, the call arguments include:
w—which has not yet been introduced but which contains potentially useful data
scenStep—in-process/current-state of FIGS. 35A and 35B, e.g., column Period 1 and leftwards
aPeriod—current period, which at the moment is 1
scTrans—an object for defining stock and cash transfers.

In Line 3729 of FIG. 37, the IsExtant function tests whether the CSCL is extant (active) in Period aPeriod. Since the CSCL is extant from Period 0 through Period 2, represented within the class as extantStart and extantEnd, it is extant, given that aPeriod is currently 1. IsExtant sets iPeriod to a class-instance internal representation of aPeriod, in this case 1. It also set nPeriod to the maximum internal period, in this case 2. This nPeriod is local to the class, but conceptually is analogous to the nPeriod of scenStep: in both cases, nPeriod−1 is the last period. In Line 3737, iPeriod is tested to determine whether at least one period has elapsed since the CSCL first became extant. Line 3739 also tests whether the current stock-price (82.091) is greater than the strike-price (55.000). Since the conditions dictate option exercise, in Line 3743 scTrans.corpTokthPartyStock is set to five to indicate that five shares from The Corporation's treasury are going to a k^{th} party; scTrans.corpTokthPartyCash is set to −5*55 to indicate that 275 is being paid by a k^{th} party to The Corporation. Both strikePrice and nShares are then set to zero to prevent an erroneous duplicate transaction. Hence, the instance-state of the CSCL_Call is as shown in the second row of FIG. 36 where create period ID=0, sequence=Before, and period=2.

As Box 1715 is executed, the results of each DoActivity call are aggregated and stored in an scTrans object named scTransNet. Rows 3569 to 3581 of FIG. 35B show such an aggregation for Period 1.

6.4.7.8. Close Period

In Box 1717, the period is closed. This entails posting the results in scTransNet: in this case, the number of outstanding-shares is incremented by five. The net new reinvestment is determined as:
earnCoreBase—dividendCore−scTransNet.corpTokthPartyCash
675.994−135.199+275.000=815.795
   which constitutes the first entry in Row 3545, and which is subsequently Arc Appreciated as shown in the row. TermValWhole is set equal to the present-value of an infinite series of earnCoreBases starting in the next period (5000) plus reInvestNet (1410.670). RShProportion is set to 100/105, which is the proportional ownership of the Reference-shareholders. RShCumDividend_PV is incremented by:
dividendCore*rShProportion*rShDiscount
135.199*0.952*0.909=117.055
   Finally, rShTerminal_PV is set to:
rShCumDividend_PV+rShCumEoDividend_PV+termValWhole*rShProportion*rShDiscount
217.055+0.000+6410.670*0.952*0.909=5767.418
   6.4.7.9. CSCL Duplication

In Box 1719, original repeatPeriod CSCLs are duplicated. Here, the original repeatPeriod CSCL corresponds to the CSCL_Call as shown in the first row of FIG. 36, and not the second row, which reflects updating and alterations. Another instance of CSCL_Call is created (create period ID=1). Member function OrientInit( . . . ) of this second instance is called with arguments:
w—contains potentially useful data,
scenStep—in-process/current-state of FIGS. 35A and 35B, e.g., column Period 1 and leftwards
pRef—pointer to original CSCL_Call that serves as template
aperiod—current accounting period

Member function OrientInit( . . . ) orients (normalizes, situates, locates) the instance with respect to the current period (aPeriod), scenStep, and the original CSCL. In this case, orientation and initialization entail: setting strikePrice equal to the current stock-price, noting the proportional change in the stock-price, and then inversely proportioning the original number of nShares to obtain nShares for the present (i.e., in C++: *this) instance. The result is shown in the third row of FIG. 36 where create period ID=1, sequence=before, period=1.

Generically, the objective of OrientInit is to orient and initialize the class-instance so that the k^{th} party (i.e., counter party to The Corporation) is in the same position as when the original CSCL was first used. In this case, in Period 0, the k^{th} party received options controlling $250 worth of shares with a strike-price equal to the current, i.e., Period 0, stock-price. In Period 1, the k^{th} partly receives the same as shown in the third row of FIG. 36.

Another way of saying this is that the original CSCLs with extantStart equal to repeatPeriod are duplicated, and each duplicate shifted forward to a succeeding accounting period.

As Boxes 1713, 1715, 1717 and 1719 are iteratively applied to Periods 2, 3, 4, . . . , the data in FIGS. 35A and 36B is generated. Once data for the last period has been generated, control passes to Box 1621, which as a generalization, notes scenStep data as of the last period, i.e., column Period 7. After Loop 1603-1621 has been performed multiple times, each time, in part, constituting generating data like that shown in FIGS. 35A and 35B, control passes to Box 1623. In Box 1623, the noted results of Box 1621 are used to generate final results. For convenience, only a single iteration of Loop 1603 to 1621 will be assumed and data as shown in FIGS. 35A and 35B used.

6.4.8. Calculate Reporting Aggregates

Once the scenario simulations are finished, overall results, including, in particular, Steady-state earnings, are calculated.

6.4.8.1. Steady-State Earnings

In Box 1623, aggregate Steady-state earnings are calculated as:
mean(rShTerminal_PP)*(1−shFloor_Discount)
6176.679*(1−0.909)=561.516
   6.4.8.2. Steady-State Dividends

Though termValWhole includes the post Period 7 present-value of an infinite series of earnCoreBases, rShCumDividend_PV does not include any such infinite series. Hence, in Box 1623, an rShPVTermToEternityDividend (Reference-shareholder, present-value, terminal to eternity dividend) is calculated as:
(dividendCore/(1−shFloor_Discount))*mean(rShProportion*rShDiscount)*rShDiscount
(100/(1−0.909))*(0.855*0.513)*0.909=438.615
   Aggregate Steady-state dividends are thus calculated as:
(rShCumDividend_PV+rShPVTermToEternityDividend)*(1−shFloor_Discount)
(664.683+438.615)*(1−0.909)=100.292

Per-share Steady-state earnings and dividends are obtained by dividing by 100, the Period 0 number of Reference-shares. Steady-state per share yield and PE naturally follow.

6.4.8.3. Liquidation01

Steady-state values help Reference-shareholders monitor and value their interest in The Corporation as a going concern. But part of their task is to decide whether to liquidate The Corporation, by perhaps selling it as a whole or in parts. In traditional accounting, it is per share book value that helps shareholders in deciding whether to liquidate a corporation. However, contingent obligations undermine the accuracy of calculating per share book value. This issue is addressed in Box 1623 by what is termed here as Liquidation01, which calculates liquidation value for the point in time between Periods 0 and 1.

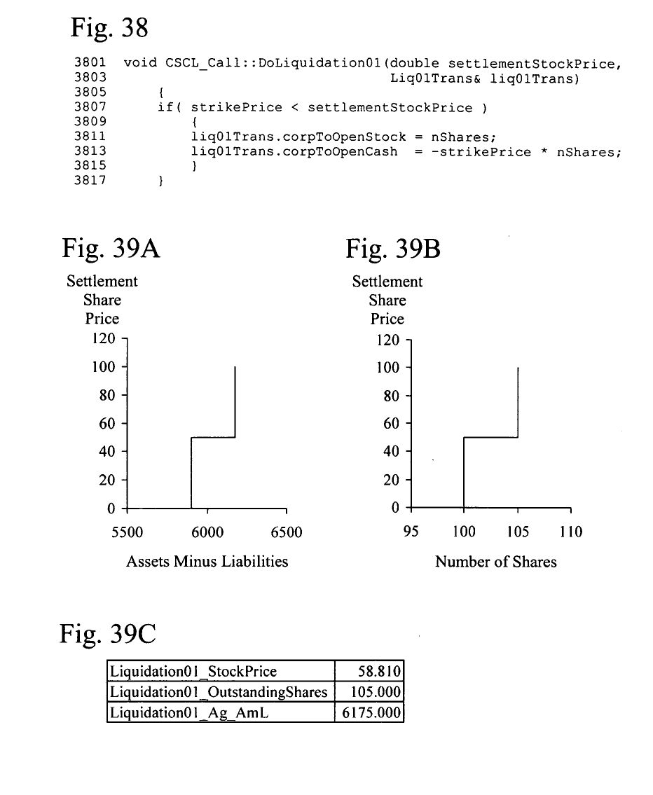

Returning to the previous example, suppose that the employee stock option can be immediately exercised if a special corporate event occurs, for example a merger, a major acquisition, or a liquidation decision by the shareholders. Naturally, the option is exercised only if it is in the interest of the employees: in other words, if the settlement share-price is greater than the strike-price. Such action is simulated by the DoLiquidation01 function. The particulars for CSCL_Call's DoLiquidation01 are shown in FIG. 38. (Object Liq01Trans is a simplification of SCTrans.)

FIG. 39A shows a schedule of assets minus liabilities as a function of share-price: if the settlement price is low, say $18, then assets are 5900 (5500+400 from FIG. 35A, i.e. rows 3525 and 3543 for Period 0); if the settlement price is high, say $88, then assets are 6175 (5900+5*55, i.e. with the addition of strike price premiums). FIG. 39B shows a schedule of number of shares as a function of share-price: if the settlement price is low, say $18, then the number of shares is 100; if the settlement price is high, say $88, then the number of shares is 105, reflecting an increment of five shares.

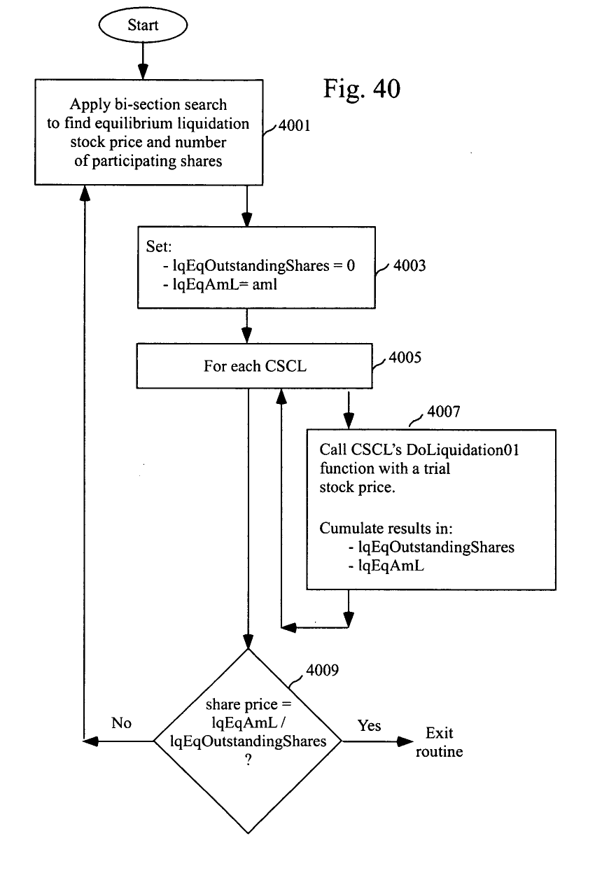

Bi-section search is used to determine the clearing settlement stock-price and number of participating shares, as initiated in Box 4001 of FIG. 40. In Box 4003, lqEdOutstandingShares is initialized with a value of zero; lqEqAml is set to aml, as of the end of Period 0. Box 4005 iterates through each active CSCL. Each active CSCL 's DoLiquidation01 member function is called to determine participation as a function of settlement stock-price (Box 4007). The bi-section search is exited once a reasonably acceptable clearing equilibrium is reached (Diamond 4009), as shown in FIG. 39C. If the shareholders vote for liquidation, then the $5900 assets are sold, if they are not already in cash. The Corporation announces a settlement price (liquidation01_StockPrice) of $58.810. The employees exercise their options. Assets increase to 6175 and the number of shares increases to 105. Each of the shares is paid $58.810, leaving a zero balance. The liquidation01_StockPrice of FIG. 39C is meant to replace the traditional per-share book value.

Besides simply replacing per share book value, liquidation01_StockPrice is meant to assist the Reference-shareholders in monitoring The Corporation. Steady-state earnings are not sufficient for monitoring because of the following. When earnCore is near zero, Steady-state earnings can also be near zero—irrespective of dilution. So, for example, suppose that earnCoreBase and earnCoreCntg are both zero and that The Corporation grants a half interest to the employees in Period 0. Steady-state earnings are zero. Now the risk is that the Reference-shareholders could accept zero earnings on account of general macro economic conditions, yet be unaware of the dilution. A large decrease in liquidation01_StockPrice from one period to the next signals such a dilution. In the immediate case, the decrease would be 50.0%. Hence, besides watching Steady-state per share earnings, the Reference-shareholders should watch for large changes in liquidation01_StockPrice.

What is shown and discussed here is a simple example of Liquidation01 calculation. The DoLiquidation01 function of each type CSCL subclass needs to be written to properly model the contractual arrangements. Such modeling might result in behavior that is very different from the behavior of the DoActivity member function. What is important, however, is that both DoLiquidation01 and DoActivity accurately model real-life behavior.

Providing Liquidation01 metrics that are comparable between corporations—whether or not equity-based compensation is used—is a major benefit of the present invention. Liquidation01 liquidation value metrics support shareholders in perhaps their most important decision: deciding whether to liquidate The Corporation.

6.4.8.4. Forward/Look-Back Calculations

Besides the metrics thus far presented, shareholders frequently use additional per share metrics to monitor their investments. As with per share book value, the accuracy of these additional per share metrics can be undermined by contingent obligations. This is addressed here by the concept of Forward/Look-back, which is handled in Box 1623 and computes current numbers from a perspective of a distant future perspective looking back to Period 0. The first step to compute such a number is to determine fwLkB_OutstandingShares, which is defined as:
Reference outstanding-shares Period 0/(terminal period rShProportion)
100/0.855=117.018
   Afterwards, this fwLkB_OutstandingShares is used as the denominator for any per share calculation to obtain a Forward/Look-back number. For instance, if revenue in Period 0 is 1920.000, then fwLkB_PS_Revenue (Forward/Look-back per share revenue) is:
1920.000/117.018=16.408
   The advantage of a Forward/Look-back number is the removal of the conceptual overhead of contingent claims in an analysis. It is as if for the Reference-shareholders, a 1−rShProportion portion of The Corporation is surrendered in Period 0 in exchange for the reinvestment value of the surrendered proportion. As a result, both the reinvestment and retained proportions can be analyzed in isolation. (An aggregate Forward/Look-back for all Period 0 Reference-shareholders can be obtained by multiplying an aggregate corporate number by terminal period rShProportion.)

FwLkB_PS_Delta Value is perhaps the most important Forward/Look-back metric, since it represents what might be called “per share book earnings.” Conceivably, FwLkB_PS_Delta Value could be used instead of Steady-state per share earnings, though the latter is preferred because of accuracy, direct relevance for the Reference-shareholders, and other reasons. FwLkB_PS_Delta Value is:
(aml_{Period 0}/fwLkB_OutstandingShares_{Period0})−(aml_{Period-1}/fwLkB_OutstandingShares_{Period-1})+per share dividends_{Period 0}

FwLkB_PS_Delta Value provides users with an estimated income that is based upon the assets owned by the shareholder's company, from a Forward/Look-back perspective. (See source code for details.)

6.4.9. Variance Control

6.4.9.1. Sample Size

In order to monitor and manage the variance of rShTerminal_PV, rather than arbitrarily setting the number of scenarios (nScenario) and the number of periods per scenario (nPeriod), in Box 1601 certain strategies are employed. The period at which rShProportion reaches its asymptote is estimated via a simple simulation and this sets nPeriod. A preliminary simplified execution of Loop 1603 to 1621 is performed without CSCLs and the results used statistically to set nScenario so that when Loop 1603 to 1621 is finally executed, an acceptable tolerance is obtained.

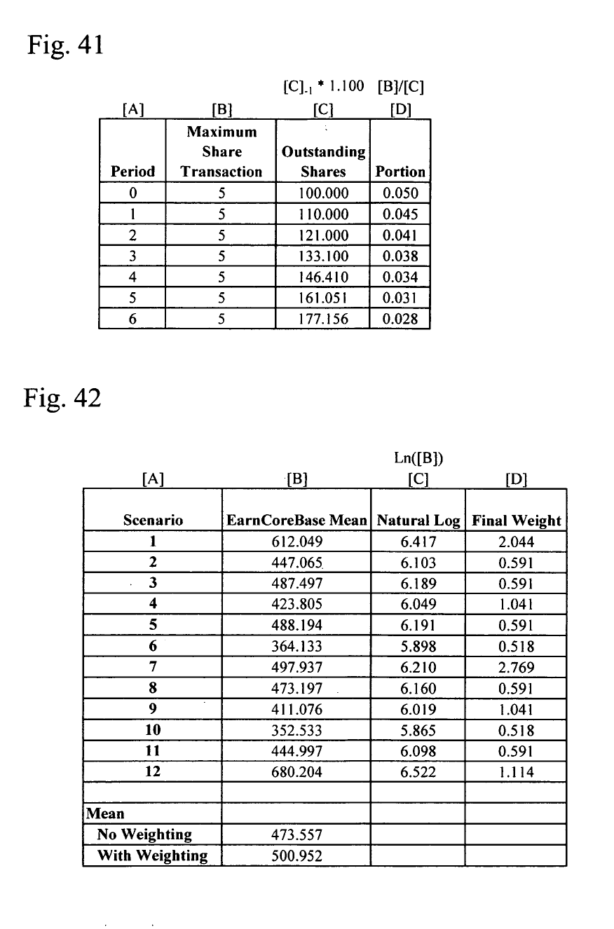

The simple simulation to set nPeriod entails calling each CSCL to obtain an estimated maximum-share transaction. This estimate can be a simple maximum that is likely to be reached near Period 0. Returning to the previous Elaborate Example, the maximum-share transaction might be set at twice times the number of shares, or 10 (in the current example). Such maximums are aggregated across all CSCLs. Assume that no dividend is paid, and that, it if exists, the stock-price remains constant. Under such assumptions, coupled with the dictate that The Corporation perform according to Point 201, then the only solution is to conclude that the number of outstanding-shares increases by shFloor_MeanAppreciation (10.0%) in each period. With the constant stock-price, if it existed, the aggregate maximum transaction is the same in all periods. Given this, a series as shown in FIG. 41 is started and continued. The question then becomes at what period (row) does portion become insignificant because it falls below a threshold? NPeriod is then set to equal that period (row) index.

After nPeriod is set, another simple simulation is done entailing randomly generating earnings, compounding the earnings as a forward projection, and then calculating the resulting terminal value mean and standard deviation. With the resulting mean and standard deviation, nScenario is set so that the expected standard error is a specified percentage of the mean expected termValWhole.

6.4.9.2. EarnCoreBase Alignment

As previously discussed, the mean expected value for earnCoreBase is the value in Period 0. However, the earnCoreBase mean in FIG. 35A, Row 3509, is rather high: 612.049, rather than the expected 500.000. Eleven additional similar scenarios were generated and their earnCoreBase means are as shown in FIG. 42. The twelve scenarios have an overall mean earnCoreBase of 473.557, much lower than 500.000. One obvious solution is to increase the number of scenarios (nScenario), but that significantly increases computer processing requirements. Another solution is to weight each scenario so that the resultant mean is 500.000 across all scenarios. (Twelve is a very small sample, but serves the present illustrative purposes.)

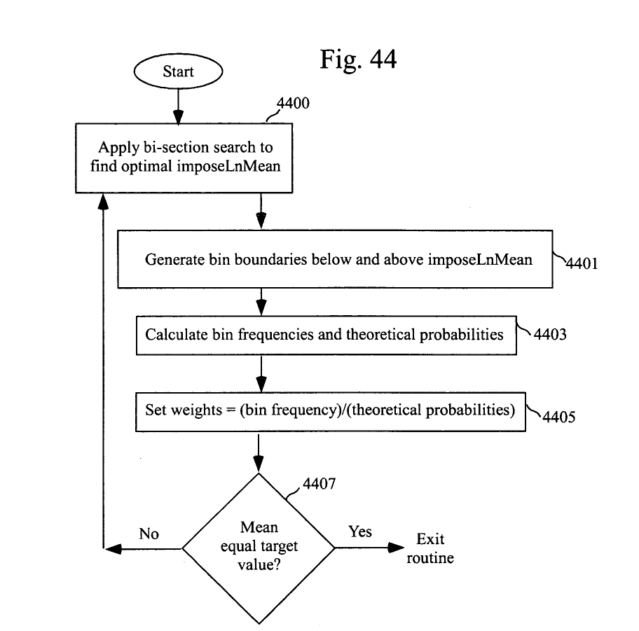

The procedure to determine weights is shown FIG. 44 and entails using bi-section search which is initiated in Box 4400.

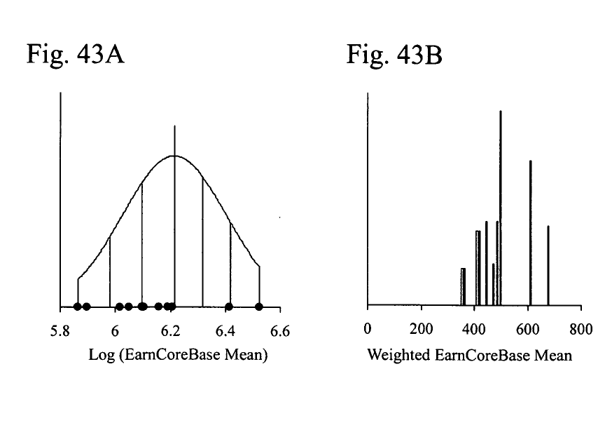

If the twelve scenario earnCoreBase means are converted to natural logarithms and plotted, the result is like that shown in FIG. 43A, where each value is represented as a solid circle, some of which overlap. Scenario earnCoreBase means tend to be log-normally distributed, which is somewhat suggested in FIG. 43A. The standard deviation of these twelve points is 0.189, using n−1 (11), rather than n (12) as the denominator. (This is the only internal place within the present invention that n−1, rather than n, is used when calculating standard deviation.)

Suppose that a variate imposeLnMean is set to the mid-point between the high and low log value at 6.194. This variate, together with the low value of 5.865, define a range that can be split into three equal length segments as shown in FIG. 43A. Similarly, three equal length segments can be defined between imposeLnMean and the high value of 6.522. This constitutes Box 4401 of FIG. 44.

The end points of the six segments define bins, into which the twelve points can be classified. Given the classification, bin frequencies can be tallied. A truncated normal distribution with a mean of 6.194 and standard deviation of 0.189 can be imposed on the twelve points as shown in FIG. 43A. (If the data were from a different distribution, for instance a uniform distribution, then this other distribution would be used.) Given this normal distribution, theoretical probabilities can be calculated for each bin. This constitutes Box 4403 of FIG. 44.

Now if each scenario is weighted:
(theoretical probability)_{iBin}/(bin frequency)_{iBin}
where iBin identifies each scenario's bin
   and an overall weighted earnCoreBase mean determined, the result is likely different from 473.557. This constitutes Box 4405 of FIG. 44. In Box 4407, the resulting overall weighted earnCoreBase mean is evaluated. If it equals the target value (500), the routine is exited.

By setting imposeLnMean to a higher value and reapplying Boxes 4401 to 4405, the resultant overall weighted earnCoreBase mean will increase. Similarly, setting it to a smaller value will decrease the resultant overall weighted earnCoreBase mean. By using bi-section search to adjust imposeLnMean and Boxes 4401 to 4405 to evaluate imposeLnMean, weights for the twelve scenarios can be determined so that the overall weighted earnCoreBase mean becomes close to 500.000. Such final weights are shown in the right of FIG. 42, along with the resulting earnCoreBase means. FIG. 43B shows the weighted earnCoreBase means as a histogram. Hence, besides adjusting overall weighted earnCoreBase mean, this procedure adjusts the sample so that earnCoreBase becomes log-normally distributed.

This weighting is optional, but needs to be done prior to the other calculations of Box 1623. The other calculations of Box 1623, and possibly the subsequent handling following Box 1625, use these weights.

6.4.10. Corporate Internal Planning and Valuation

Thus far the focus has been on assuming the perspective of the Reference-shareholders, perpetually repeating Period 0, and intentionally ignoring Actual expectations, forecasts, and plans of The Corporation. The Corporation, however, does have Actual expectations, forecasts, and plans and does need to consider and formulate them in light of contingent transactions. This will be addressed for the remainder of this section, 6.4.10.

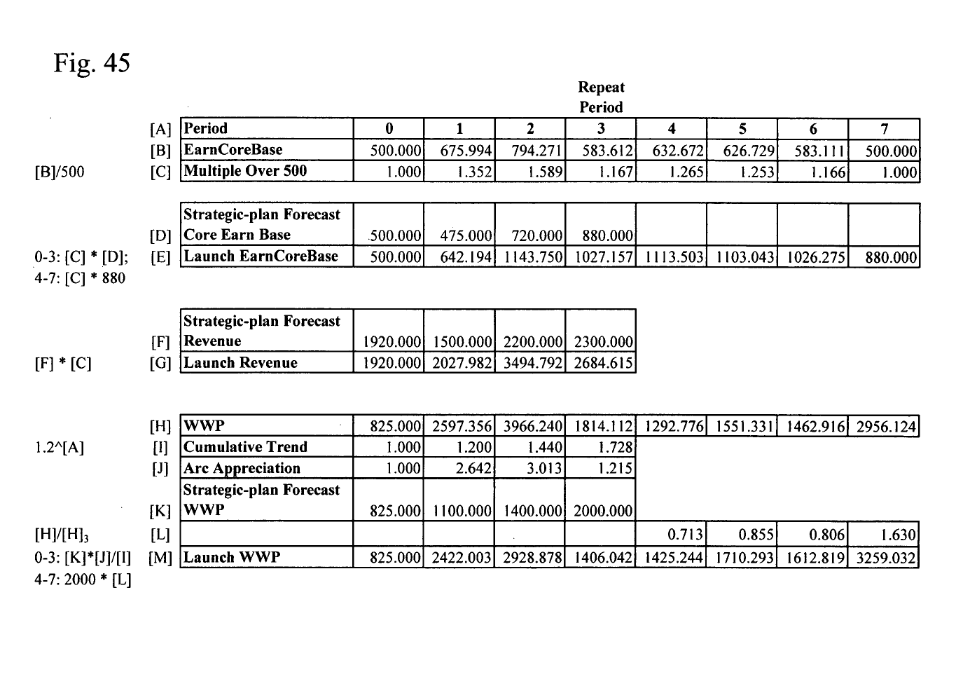

The first thing that needs to be addressed is inserting The Corporation's Actual plans into the scenario generation process as shown in FIGS. 35A and 35B. So, for instance, though earnCoreBase might be $500.000 in Period 0, The Corporation's forecasted earnCoreBase for Period 1 might be $600.000. This is handled by what is termed “launching” as shown in FIG. 45.

With launching, for select variates, forecasted levels are inserted for the first few periods. These forecasted values are disturbed as suggested by the random number generation processes as previously described. Values beyond the first few periods are generated as previously described. So, for example, suppose that The Corporation's strategic plan forecast has earnCoreBase at 500, 475, 720, and 880 for Periods 0, 1, 2, 3 as shown in FIG. 45 ([D]). As will be shown later, these numbers are randomly disturbed (changed, shifted, altered) and then the last of the original numbers, 880 in this example, is used as the basis for generating numbers beyond repeatPeriod, Period 3 in this example.

It is expected here that the forecasts for each period are unbiased and that for the last period, current considerations have dropped away and that the economist's “long-term” has been reached. So, in the present case, the 475 for Period 1 reflects an anticipated drop, while the 880 reflects a long-term average that discards immediate macro-economics and market-dynamic considerations. Since the forecast has reached the start of the “long-term”, the arguments regarding Point 201 again become pertinent. Thus, the last period is perpetually repeated by setting repeatPeriod equal to 3.

FIG. 45 shows the previous earnCoreBases for each period ([B]). It also shows a strategic-plan forecast of earnCoreBase for the first four periods. To disturb these forecasts of earnCoreBase and generate subsequent earnCoreBases, multiples over Period O's earnCoreBase 500 are computed as shown ([C]). These multiples are then applied to the strategic-plan forecasts of earnCoreBase for the first four periods. Hence, for Period 2, the multiple is
794.271/500=1.589
   and the launch earnCoreBase is
720*1.589=1143.750
   For the periods past repeatPeriod, the multiples are applied to the strategic-plan forecast of earnCoreBase in Period 3 (repeatPeriod). Hence the earnCoreBase for Period 6 is
880*1.166=1026.280
   Notice the congruence with non-launching. If the Strategic Plan had earnCoreBase for the first four periods at $500, then the results would be the same as if launching were not used. With the non-500 values, the distributions of each Period's earnCoreBase are the same as before, except for scaling. Including and beyond repeatPeriod, the log-correlation with shFloor is maintained.

For corpScale, revenue, IWP, and employees (Rows 3513 to 3521 of FIG. 35A), launching initially directly works with the earnCoreBase multiples. So, for instance, if the strategic-plan forecast has revenue at 2200 in Period 2, the launch revenue is
2200*1.589=3494.792.

After Period 3, corpScale, revenue, IWP, and employees are calculated as before, except that corpScalePrice, corpScale, revenue, etc. are based on Period repeatPeriod.

Applying launching to Master-driver-variates is shown in the bottom box of FIG. 45 and is analogous to what has been previously presented. WWP ([H]) is copied from Row 3507 in FIG. 35A. The Trend row ([I]) shows 20.0% compounding, in Factor format, starting with Period 0. The next row ([J]) shows Arc-appreciations, with a starting period of Period 0. The strategic-plan forecasts for WWP are also shown and are intended to override row ([H]). A relative, off-trend multiple is determined and applied to the strategic-plan forecast WWP. So, for instance, to obtain the launch level for Period 2:
(3.013/1.440)*1400=2928.878

Because the mathematically-expected value of the Arc-appreciation equals the Trend, the expected value of the multiple is 1.000. Hence, no bias is being introduced and the resulting mathematically-expected values equal the strategic-plan forecasts.

For periods after repeatPeriod, the raw appreciation of the original WWP is applied. So, for instance, launch WWP in period 6 is:
(1462.916/1814.112)*2000=1612.819
   Besides these variate launch definitions, CSCL 's having extantStarts between Periods 0 and 3 are specified. Such CSCL 's model the types of contingent arrangements that are forecasted for Periods 0, 1, 2, and 3. As before, the CSCL 's that have extantStarts of Period 3, i.e., were granted in Period 3, are duplicated as part of the Perpetual-repetition.

If the scenario of FIGS. 35A and 35B were regenerated, though with active launching as indicated by the positive repeatPeriod equal to three, processing would proceed as previously described, except that the launch values would replace what would otherwise be used. Hence, the launch earnCoreBase row of FIG. 45 ([E]) in effect replaces row 3509 in FIG. 35A; the launch revenue row in effect replaces row 3517; and the launch WWP row in effect replaces the start of row 3507. As a result, Rows 3543 to 3565, in addition to other rows, change.

Because of the way the CSCL member function OrientInit is designed to operate, a very convenient property emerges: when specifying the CSCLs for Periods 0, 1, 2, and 3, one can assume the situation or environment of Period 0 and delegate orientation to OrientInit. So for example, a CSCL_Call for Period 3 might be specified as having 5 shares and a strike-price of $55, because $55 is the stock-price in Period 0, and 5 shares are required in Period 0 terms as compensation for The Corporation's counter party in Period 3. When the OrientInit function is called for Period 3, the number of shares and the strike-price will be adjusted to be oriented to Period 3, so that The Corporation's counter party receives, in Period 3 terms, what was originally specified in Period 0 terms. Hence, when specifying a CSCL_Call for Period 3, Period 3 estimates of stock-price and other variates are not needed.

Resuming the consideration of regenerating FIGS. 35A and 35B, once repeatPeriod is closed, CSCL duplication is applied to those CSCLs that have extantStarts equal to 3. A potential problem, however, emerges at this point: whether the reinvestment that occurred in Periods 0, 1, and 2 should be carried forward. On the one hand it should, because the whole purpose is to do a simulation and such reinvestment, which is going to be stochastic, is appropriately part of a real “simulation.” On the other hand it should not, because, earnCoreBase of Period 3 implicitly, presumably, reflects reinvestments that occurred prior to Period 3. The latter perspective is assumed here. In order to implement this, when repeatPeriod period closes, reinvestment value is determined for each subsequent period. These values are stored in reInvestAtRepeatPeriod, which is Row 3561 in FIG. 35B. When reinvestment values are determined for periods subsequent to repeatPeriod, period value is determined as previously described, except that reInvestAtRepeatPeriod values are subtracted out. Hence, it is as if the net reinvestment value at the start of Period 3 is zero.

Given that repeatPeriod is say set to 3, CSCLs with extantStarts between Periods 0 and 3, and the other necessary data, the present invention can then be used as a simulation tool to evaluate plans and possible plans, and perform “what if” analysis. So, for example, if the scenario of FIGS. 35A and 35B were re-run with no CSCL_Call, a comparison of the terminal periods' rShTerminal_PV would suggest the cost to Reference-shareholders of a constant employee stock option plan entailing, in Period 0 terms, five shares with a strike-price of 55.

6.4.11. External Forecasted Earnings

Publicly traded corporations frequently provide forecasted, estimated earnings as part of their ongoing investor/financial community relationship management activities.

What is described in the immediately preceding section (6.4.10 Internal Planning and Valuation) can be used to generate such forecasts. So, for instance, if repeatPeriod were set to 1, then the resulting Steady-state earnings would be the forecasted, estimated Steady-state earnings for Period 1.

Ideally, repeatPeriod is set to the last period of The Corporation's planning horizon, and all data generated by the present invention is provided to investors, potential investors, and others for analysis. This would include the arithmetic means and statistical standard errors of scenStep data, like shown in FIGS. 35A and 35B. Another possibility is for The Corporation to aggregate scenStep data as deemed appropriate and then provide the results to investors, potential investors, and others.

One advantage of using a positive repeatPeriod is that some potential contingent transactions that would otherwise have no or little impact when determining Steady-state earnings for Period 0 would have significant impacts when determining Steady-state earnings for periods beyond Period 0. So, for example, if a contingent activity is based upon a significant increase in earnCoreBase, when repeatPeriod is 0, such a contingent activity would have no or little impact since the random number generation procedure would rarely yield significant increases in earnCoreBase. If, however, repeatPeriod is 1 and if The Corporation were forecasting (via launching) a large increase in earnCoreBase for Period 1, then the contingent activity would have a significant impact, since the random number generation procedure would mostly yield significant increases in earnCoreBase for Period 1. These significant increases would impact, and be reflected in, the Steady-state earnings for Period 1. Stated differently, a positive repeatPeriod can lead to results that reflect potential off-balance sheet transactions that are not fully addressed when repeatPeriod is O- and that are ignored by the standard balance sheet and profit & loss statements.

6.4.12. CSCL Member Functions and Operations

6.4.12.1. Structure

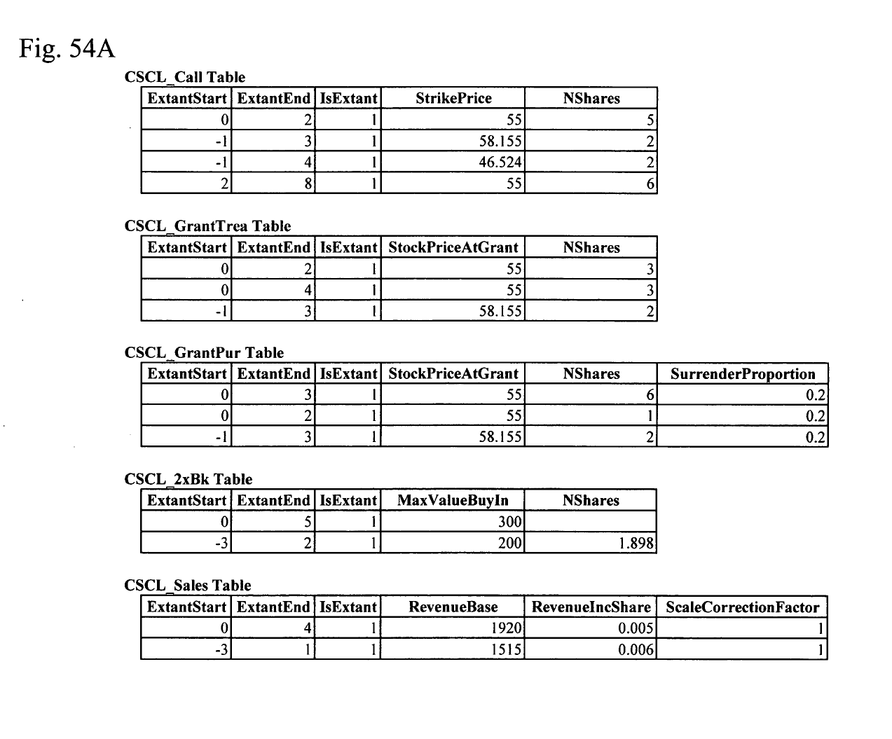

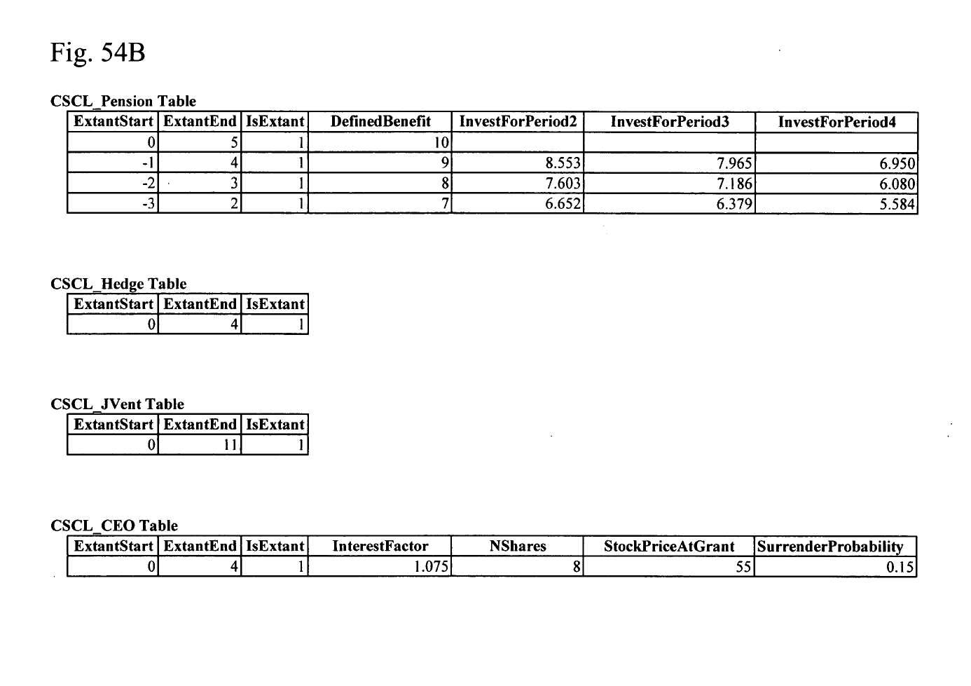

The function, operation, and relation of the CSCL_Call class to the Elaborate Example ScenStep was shown in FIGS. 35A, 35B, and elsewhere. The other eight CSCLs will be presented next. The purpose is not so much to show fixed, fully-defined, directly-usable elements of the present invention, but rather to teach how CSCLs should be programmatically constructed for any embodiment of the present invention. Some of these CSCLs shown, in particular CSCL_Pension, are vast simplifications of what could be used in an embodiment of the present invention. CSCL construction/operation is dependent on The Corporation's contingent arrangements with 3^{rd}/k^{th} parties. The DoLiquidation01 member function is not discussed further, since the previous discussion regarding its function in the CSCL_Call class fully demonstrates its purpose and provides a simple example of its operation. In an implementation of the present invention, DoLiquidation01 is customized for each type of CSCL. The focus here, instead, is on the OrientInit and DoActivity member functions, since they constitute the essence of the CSCL. FIGS. 54A and 54B show member data for the CSCL_Call and other eight CSCLs stored in relational database table format. For the examples discussed here, the first rows of each corresponding table are assumed loaded into the CSCL. So, for example, the first row of Table CSCL_Call corresponds to the example previously presented regarding CSCL_Call. The eight CSCLs are presented in approximate ascending order of complexity.

All CSCLs are derived from the CSCL_Base class, which provides standard supporting functionality. CSCL_Base has variates extantStart and extantEnd, which bound the active life span of the CSCL, and which refer to the ScenStep columns of FIGS. 35A and 35B.

APeriod is an index representing the current accounting period of FIGS. 35A and 35B. Within each CSCL:
iPeriod is the internal accounting period, relative to extantStart, i.e., iPeriod=aPeriod−extantStart;
nPeriod is a class-instance local variable, analogous to the nPeriod of scenStep, and is an internal version of extantEnd, i.e., nPeriod=extantEnd−extantStart.

The CSCL generation process is such that each CSCL is initialized with a likely unique random number generator seed, which can be used as the CSCL sees fit. As described before, member function IsExtant has the following as arguments: aPeriod, iPeriod, and nPeriod. APeriod, as described before, refers to the current column of FIGS. 35A and 35B, i.e., it is the current accounting period. Given aPeriod, iPeriod is the corresponding internal period. NPeriod−1 is the last extant period for the CSCL. Given aPeriod, member function IsExtant determines whether the CSCL is extant and returns a Boolean indicating such status. If the CSCL is extant, iPeriod is set to the corresponding aPeriod and nPeriod is also set. As will become apparent later, argument w (type SSBuf, to be introduced) contains a wealth of data needed by the present invention. This data is provided to the CSCL for use as the CSCL sees fit.

6.4.12.2. Example CSCLs

6.4.12.2.1. CSCL_GrantTrea

Besides the employee stock options, which are handled by CSCL_Call as previously discussed, frequently corporations compensate employees and other parties with restricted stock. So, for example, suppose that The Corporation, in Period 0, promises employees three shares of stock at the start/end of Period 1. During Period 0, the three shares are restricted; afterwards, they are unrestricted. This is modeled by CSCL_GrantTrea (CSCL Grant Treasury).

Exemplary defining data is shown in the first row of the CSCL_GrantTrea Table in FIG. 54A.

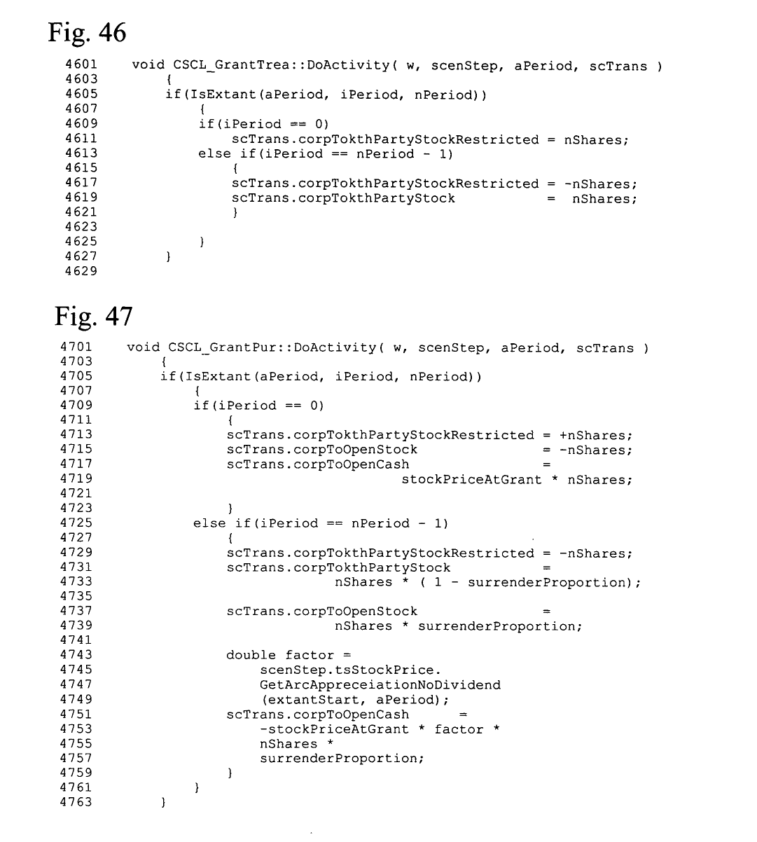

For the first period, i.e., when iPeriod=0, in Line 4611 of FIG. 46, DoActivity sets scTrans.corpTokthPartyStockRestricted to the number of shares (3). This will subsequently trigger an increment of 3 in Rows 3527 to 3529 (of FIG. 35A) for Period 0 (aPeriod). When iPeriod reaches nPeriod−1 (1), the stock status is changed: in Line 4617, the previous restricted stock increment is reversed; Line 4619 specifies a stock transfer from The Corporation to a k^{th} party. All in all, this results in an increment of 3 in Row 3527, Period 1.

The OrientInit function of CSCL_GrantTrea is similar to the same function in CSCL_Call. Given a stock-price, OrientInit sets nShares so that the net value of stock in play is the same: i.e., the k^{th} party receives the same value/potential value.

(Strictly speaking, treasury stock is usually stock that has been repurchased and is consider different from authorized, but never issued stock. This distinction is not made here: if stock is granted out of a pool of available stock, the transaction is handled by CSCL_GrantTrea; if an open market purchase is made, the transaction is handled by CSCL_GrantPur.)

6.4.12.2.2. CSCL_GrantPur

CSCL_GrantPur builds upon CSCL_GrantTrea. The restricted stock is assumed purchased on the open market. Because of various reasons, some of the stock is never transferred. In other words, some of the granted stock is surrendered. Surrendered stock is resold by The Corporation, which internally reinvests the proceeds.

Exemplary defining data is shown in the first row of the CSCL_GrantPur Table in FIG. 54A.

CSCL_GrantPur's DoActivity function is shown in FIG. 47. When iPeriod is 0, as before in Line 4611, DoActivity sets corpTokthPartyStockRestricted to nShares, or 6 in the present example. When iPeriod is the last period, Line 4715 specifies that nShares shares be transferred from Open Interest to The Corporation. Lines 4715 to 4719 specify that the purchase value is also transferred from The Corporation to Open Interest. Conceptually, Open Interest is a virtual entity that serves as a mechanism to split transfers from/to k^{th} parties and to/from reference and non-Reference-shareholders on a pro-rated basis. So when Line 4715 specifies a negative transfer of nShares shares from The Corporation to Open Interest, outstandingShares of Line 3527, FIG. 35A, is decremented by nShares. But most importantly, rShOutstandingShares is also decremented by rShProportion*nShares shares because, when making the open market purchase, some of the purchased shares come from the Reference-shareholders on a pro-rated basis.

Similarly, when Lines 4717 to 4719 specify the cash payments by The Corporation, a pro-rated portion is assumed to go to the Reference-shareholders. The present-values of such pro-rated proportions are cumulated in rShCumEoDividend_PV (Reference-shareholders Cumulative Extraordinary Dividend Present-value) shown as Row 3539 in FIG. 39A. RShCumEoDividend_PV is not included in rShCumDividend_PV, but is included in rShTerminal_PV.

As with CSCL_GrantTrea, when the last period is reached, additional transfers are done. So Line 4729 is the same as Line 4617, which reverses the original increment to outstandingSharesRestricted. Because some of the restricted stock is surrendered, Lines 4731 to 4733 specify that only a fraction of the nShares go to the k^{th} party and Lines 4737 to 4739 specify that the remaining fraction goes to Open Interest. This remaining fraction is what The Corporation sells on the open market.

Lines 4743 to 4749 set Factor equal to the Arc-appreciation of the stock-price since the stock was purchased. Arc, rather than Raw, Appreciation is used in order to avoid the Inflated-Compounding Problem. Arbitrarily, it is assumed that the dividends went to the potential owner of the Reference-shares and did not go to The Corporation, so as a consequence, no-dividend stock-price Arc-appreciation is used. (If the dividends went (back) to the corporation, function GetArcAppreciationDivReInvest, rather than GetArcAppreciationNoDividend, would be used instead.) Given this Factor, the received value by The Corporation is calculated in Lines 4753 to 4757 and corpToOpenCash is set to the negation of this value. When the scTrans is subsequently handled, corpToOpenStock and corpToOpenCash are each split amongst the Reference and non-Reference-shareholders. This split results in rShOutstandingShares being incremented, while rShCumEoDividend_PV is decremented. In essence, what is being reflected is that the Reference-shareholders have repurchased some of their shares.

The OrientInit function of CSCL_GrantPur is similar to the same function in CSCL_Call. Given a stock-price, OrientInit sets nShares so that the net value of stock in play is the same: i.e., the k^{th} party receives the same value/potential value.

6.4.12.2.3. CSCL_{—}2xBk

CSCL_Call, CSCL_GrantTrea, and CSCL_GrantPur seemingly make use of a stock-price as if such a price were readily available, which would be the case if The Corporation were publicly traded. If The Corporation is privately held, then the stock-price can be simulated as a function of assets minus liabilities and/or other variates. The following CSCL generates and uses such a simulated stock-price.

CSCL_{—}2xBk addresses an Actual option plan of an Actual private company, circa 1980s: employees were allowed to buy and sell stock at twice the book value, with a limit on how much stock could be purchased. To keep things simple, here it is assumed that employees purchase the maximum possible amount of stock and that only 20.0% of the employees redeem their shares after two periods.

Example defining data is shown in the first row of the CSCL_{—}2xBk Table in FIG. 54A.

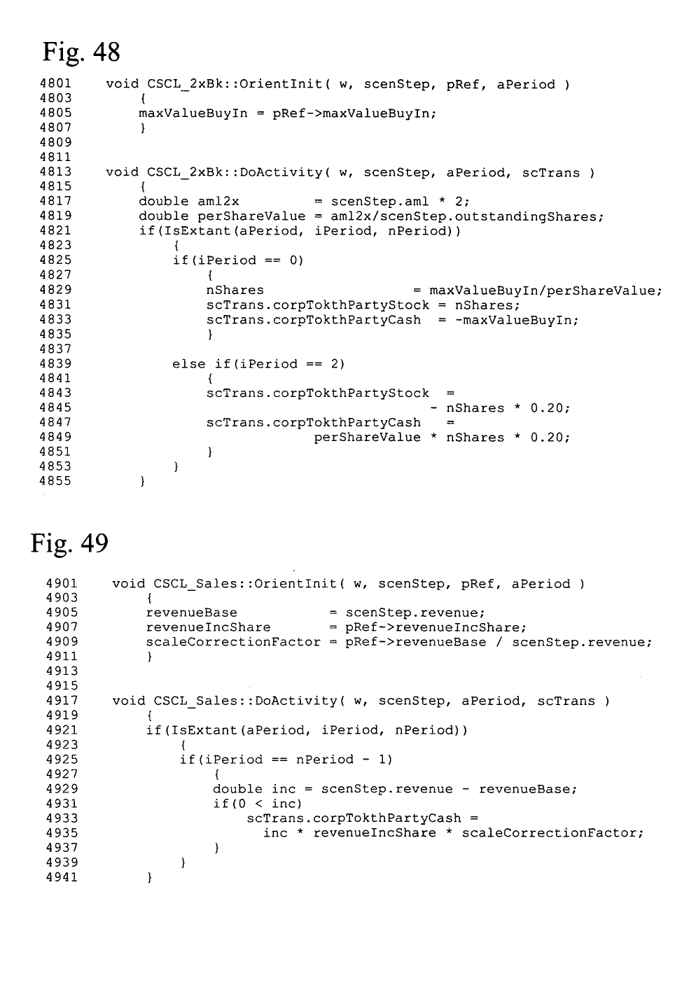

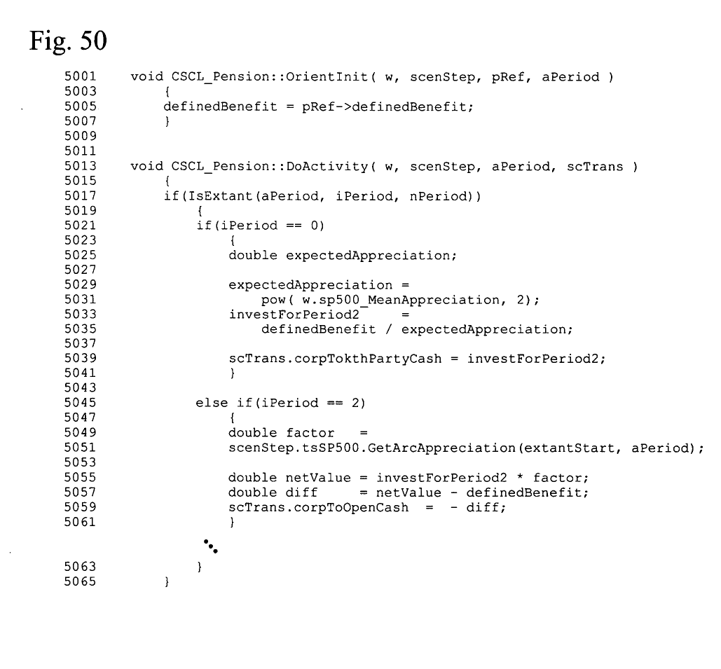

In DoActivity, Lines 4817 to 4819, a stock-price of twice book value is determined. (See FIG. 48.) For internal Period 0, Line 4829 set nShares based upon what can be purchased, given maxValueBuyIn as a maximum monetary amount that can be invested. In Lines 4831 to 4833, corpTokthPartyStock and corpTokthPartyCash are appropriately set. For internal Period 2, corpTokthPartyStock and corpTokthPartyCash are set to reverse 20.0% of the internal Period 0 transactions.

The OrientInit function of CSCL_{—}2xBk notes the original or reference CSCL_{—}2xBk maxValueBuyIn. Assuming that The Corporation's prospects are constant, which is the assumption of Perpetual-repetition, then maxValueBuyIn defines the value/potential value that k^{th} parties receive on grant.

6.4.12.2.4. CSCL_Sales

Sometimes parties are compensated based upon a percentage increase in revenue. CSCL_Sales handles this type of contingent arrangement.

Exemplary defining data is shown in the first row of the CSCL_Sales Table in FIG. 54A. RevenueIncShare is the percentage of revenue increase that is paid as compensation.

The DoActivity function is active at only the last extant period of the CSCL. In FIG. 49, Lines 4929 to 4931, the increase, if any, is determined. Lines 4933 to 4935 determine and set corpTokthPartyCash as a percentage of the increase.

The OrientInit function of CSCL_Sales is different from the other OrientInit functions thus far presented. In Line 4905 of FIG. 49, OrientInit notes the base revenue level in scenStep. In Line 4907, it copies revenueIncShare. Finally, in Line 4909, it determines scaleCorrectionFactor, which is used to base compensation on revenue percentage increase, rather than raw revenue numbers. In other words, it is assumed that revenue percentage increase is a function of effort and skill, rather than the base from which the percentage is calculated. Hence in Line 4909, scaleCorrectionFactor is determined. If revenue has doubled since the original CSCL 's extantStart, then scaleCorrectionFactor is set to 0.5, which then halves the percentage as determined in Row 4935. With this correction, the k^{th} party is in the same position as before in Period 0 (or whatever the repeatPeriod happens to be).

6.4.12.2.5. CSCL_Pension

Some Corporations have defined benefit retirement plans for their employees. The Corporation makes investments, the eventual value of which is used to pay defined (specific-amount) benefits. The Corporation keeps or makes up any difference between the eventual investment value and the defined benefits. This is handled here by CSCL_Pension.

CSCL_Pension makes investments in an SP500 index fund in internal Period 0, and pays defined benefits in internal Periods 2, 3, and 4.

Exemplary defining data is shown in the first row of the CSCL_Pension Table in FIG. 54B.

DoActivity, for internal Period 0, determines the amount that needs to be invested to cover The Corporation's mathematically-expected-value defined-benefits liability in internal Period 2. (See Lines 5025 to 5035.) This amount is added to corpTokthPartyCash. The same is then done for internal Periods 3 and 4. For internal Period 2, in Line 5055, netValue is set to the Arc Appreciated value of investForPeriod2. Arc-appreciation is used to avoid the Inflated-Compounding Problem, which would bias the results as being too favorable for The Corporation. CorpTokthPartyCash is set to the difference between netValue and the defined benefit. Rows 5045 to 5061 are replicated for iPeriod equal to 3 and 4. (The source code has a CSCL_Pension that shows more detail.)

The OrientInit function of CSCL_Pension copies the defined benefit, because it is the specifics that define the value/potential-value the k^{th} party receives on grant. (See Line 5005.)

(In an Actual implementation of CSCL_Pension, multiple investments would be entertained and the defined benefits, liabilities, and their durations, would be stochastic.)

6.4.12.2.6. CSCL_Hedge

Thus far the CSCLs presented are arguably single legs in at-least-two leg transactions. For example, the pension was given in order that the employee do work, which presumably is reflected in earnCoreBase. As mentioned before, CSCLs can be used for two or more legs, as is the case with CSCL_Hedge.

CSCL_Hedge regards a simple exotic option that The Corporation purchased for hedging WWP. Its terms are:
The Corporation paid 100 in Period 0.
If both the SP500 and WWP have depreciated by Period 3, then the settlement payment to The Corporation is the loss that would have occurred had 1000 been invested in a WWP index in Period 0.

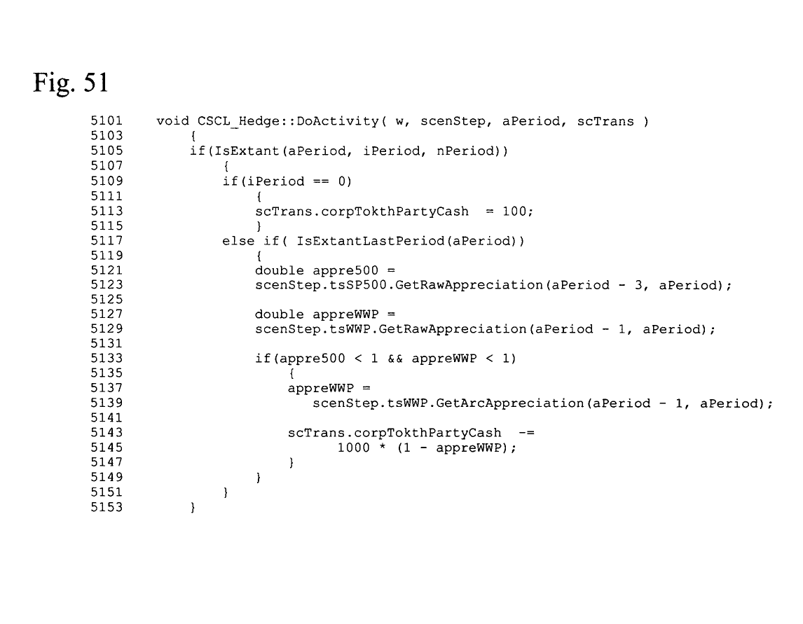

DoActivity is shown in FIG. 51. Line 5113 posts the initial $100 payment. Lines 5121 to 5129 determine the appreciations of SP500 and WWI. Raw-appreciations are used because a Probabilistic-classification is sought. Line 5133 tests whether the SP500 and WWP have both depreciated. Lines 5137 to 5139 obtain the Arc-appreciation of WWP. Arc-appreciation is used here since a monetary level is sought. Lines 5143 to 5145 set corpTokthPartyCash to the negative of the final settlement.

A custom OrientInit function of CSCL_Hedge is not needed, since CSCL_Base::OrientInit is sufficient. Except for handling extantStart and extantEnd, no OrientInit is needed for CSCL_Hedge since its DoActivity does not use any parameters.

6.4.12.2.7. CSCL_JVent

CSCLs can model independent business operations. So, for example, suppose that The Corporation entered a joint venture with another corporation. The terms/expectations are as follows:
The Corporation paid 500 in Period 0.
There is a 20.0% probability that The Corporation will need to pay an additional 100 in Period 1.
The final returns, eleven accounting periods into the future, are contingent upon WWP:
   If WWP grows less than 600.0%, then returns are mediocre:
      40.0% probability of 300
      60.0% probability of 1000.
   If WWP grows more than 600.0%, then returns are attractive:
      60.0% probability of 3000
      40.0% probability of 5000.

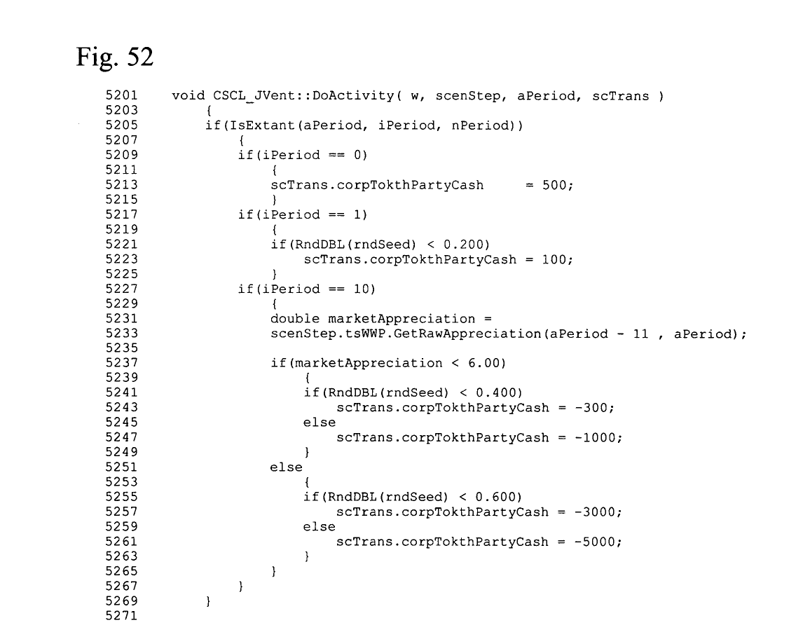

The DoActivity mirrors the terms/expectations as shown above (See FIG. 52). However, it is worthwhile to note that a call to a random number generator is used and that since a Probabilistic-classification is used, Line 5233 entails obtaining a Raw, rather than an Arc, Appreciation.

A custom OrientInit function of CSCL_Hedge is not needed, since CSCL_Base::OrientInit is sufficient. Except for handling extantStart and extantEnd, no OrientInit is needed for CSCL_Hedge since its DoActivity does not use any parameters.

6.4.12.2.8. CSCL_CEO

Suppose, as an illustrative Tour de Force, The Corporation in Period 0 hired a new CEO and the negotiation incentive package/agreement entailed:
The CEO receives 8 shares of restricted stock that converts to full ownership in Period 3, if surrender has not occurred. The Corporation makes a market purchase of these shares. Until the restriction is removed, The Corporation retains and reinvests the dividends; once the restriction is removed, The Corporation transfers the accumulative dividend value to the CEO/k^{th} party.
The CEO makes a good-faith payment of $50. This is returned with 7.5% simple interest in Period 3 if the restricted stock has been surrendered.
In Period 1, if The Corporation's relative share of world widget production has not decreased, then the CEO receives $250 worth of stock, plus $10.
In Period 2, if earnCoreBase has increased over Period 0, then the CEO receives 75 earnings units in Period 2. An earnings unit is a proportional dollar of earnings in Period 0.
In Period 3, if surrender has not occurred, then the restricted stock becomes unrestricted and is fully transferred to the CEO. If surrender has occurred, then the good-faith payment is returned to the CEO with 7.5% interest and The Corporation sells the restricted stock, the proceeds of which are reinvested for the benefit of The Corporation.

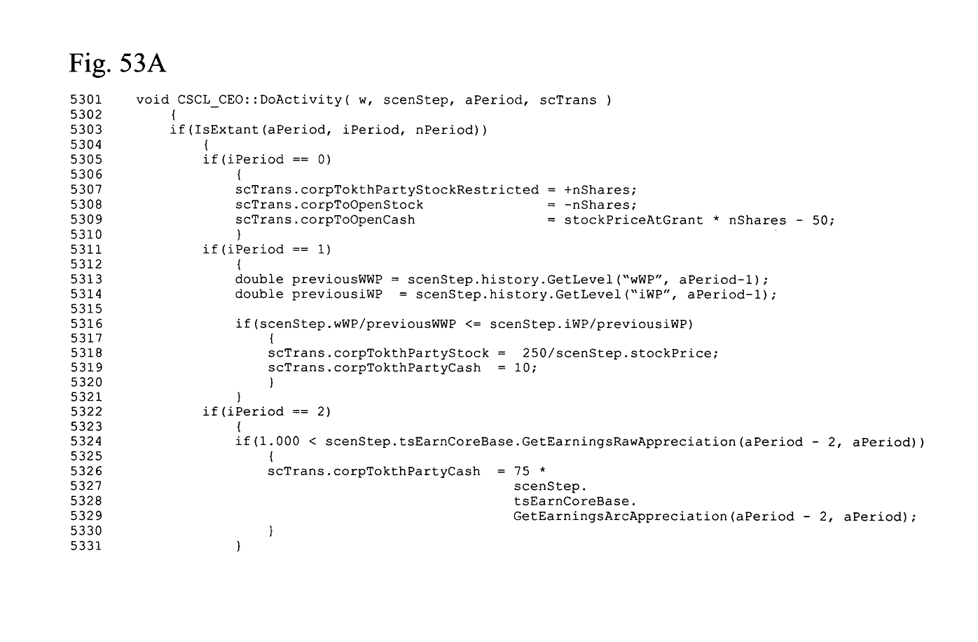

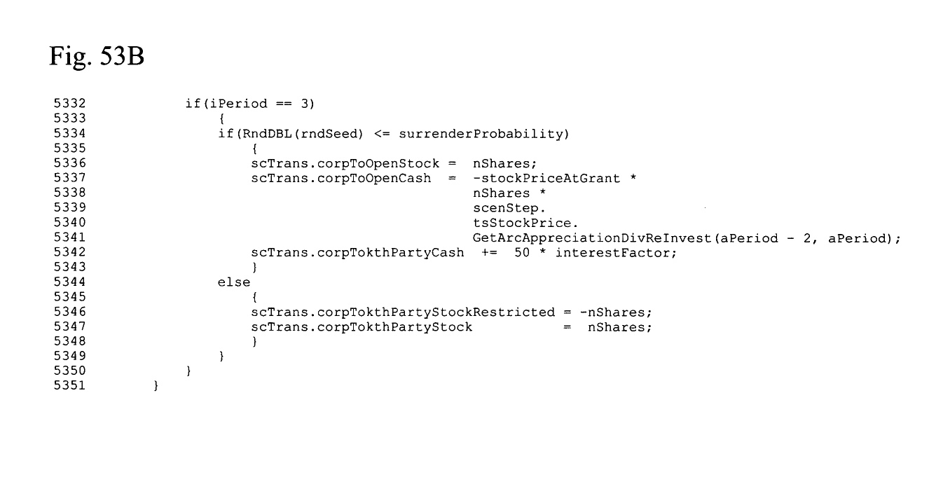

This is handled by the DoActivity function of CSCL_CEO as shown in FIGS. 53A and 53B. Exemplary defining data is shown in the first row of the CSCL_CEO Table in FIG. 54B.

In FIG. 53A, Lines 5307 to 5309 are identical to the previous iPeriod 0's transactions (of CSCL_GrantPur, for instance), except that the $50 paid by the CEO is subtracted from corpToOpenCash in Line 5309.

For iPeriod equal to 1, previous period IWP and WWP are obtained from scenStep 's history member. This history member contains select data for periods prior to Period 0, contains data for Periods 0 to aPeriod (non-inclusive), and is specifically for use by CSCLs as shown here. Line 5317 tests whether The Corporation's relative production share has not decreased. If such is the case, then in Line 5318 a stock transfer is made that is reflective of the CEO's receiving $250 worth of stock; Line 5391 is reflective of the CEO's receiving $10.

For iPeriod equal to 2, in Line 5324 a test is made whether earnCoreBase is increased since iPeriod equal to 0. Raw-appreciation is used because a Probabilistic-classification test is being made. Line 5329 determines the Arc-appreciation of earnCoreBase. Arc-appreciation is used to correct for the Inflated-Compounding Problem. This Arc-appreciation is applied to the 75 earnings units of iPeriod equal 0.

For iPeriod equal to 3, in Line 5334, a test is made to determine whether surrender has occurred. This test entails using the almost-unique random number seed provided to the class-instance to generate a number between 0 and 1. If the generated number is less than surrenderProbability, then surrender has occurred. (This is arguably a simulation, albeit a trivial simulation. However, any sort of simulation can be done in a DoActivity function using the random number seed.) If surrender has occurred, then in Lines 5336 to 5342, the earlier stock purchase is reversed as was previously done with other CSCLs. However, in comparison with CSCL_GrantPur, Arc-appreciation with dividend reinvestment is used (Line 5341), since The Corporation retains and reinvests the dividends. Line 5352 posts the refund of the $50 plus interest. If surrender has not occurred, then Lines 5346 to 5347 changes the stock from restricted to unrestricted. Cumulative dividends are transferred to the CEO.

In CSCL_CEO, a random number is used to determine surrender, while in CSCL_GrantPur a simple proportion (20.0%) is used. In the former case, there is a single CEO who may or may not surrender the position. Either Lines 5336 to 5342 or Lines 5346 to 5347 apply: because the phenomena here is highly non-linear, to use an average for Lines 5336 to 5342 with Lines 5346 to 5347 likely results in distortions. In the latter case, because there are presumably many employees, invoking the “law of large numbers”/using an average is reasonable. Hence, a fixed proportion is used.

(The complexity and types of contingencies handled by CSCLs is without bound. The limiting considerations are the sophistication and needs of the contract parties, and the willingness to implement detail in CSCLs.)

6.4.13. CSCL Multi-Period Alignment

6.4.13.1. Period Spanning

Thus far, it has been explicitly and implicitly assumed in both the nine CSCLs and the prior conceptual CSCLs that all CSCLs of repeatPeriod are perpetually repeated in each period after repeatPeriod. This is not always appropriate and the issue is highlighted by CSCL_CEO: are the terms—spanning 4 periods—based on the CEO working one period (iPeriod 0)? Working two periods (iPeriod 0 and 1)? Working three periods (Period 0,1, and 2)? Or conceivably working five periods (iPeriod 0,1, 2,3, and 4)? If the terms are based on CEO working one period, then CSCL_CEO functions as previously described. However, if the terms are based on the CEO working, say, three periods (iPeriod 0,1, and 2), then CSCL_CEO needs to incorporate this. This can be accomplished by changing Line 5303 to:
if(IsExtant(aPeriod, iPeriod, nPeriod) && !(extantStart % 3))
   The “!(extantStart % 3)” allows the code body (Lines 5305 to 5349) to execute only when extantStart is 0, 3, 6, 9, . . . —thus yielding the desired behavior. The CSCL_CEO, in effect, is issued every third, rather than every single, period.

A less desirable alternative is to attempt to allocate the terms to iPeriods 0, 1, and 2. For instance, allocating the issuance of restricted stock as compensation for iPeriod 0; allocating the $250 worth of stock and $10 as compensation for iPeriod 1; etc. With such allocation, only the period's allocation is handled in a CSCL. So, given the first allocation, then Lines 5311 to 5349 are deleted and the resultant CSCL, say a CSCL_CEO_B, is perpetually repeated in each period after repeatPeriod. Another alternative in constructing, say, a CSCL_CEO_C is to attempt to equally divide (allocate) the full offering into three equal yearly components. (The issue of allocation is a major general issue in accounting that many accountants have encountered and addressed.)

6.4.13.2. EarnCoreBase, EarnCoreCntg, EarnCore, and CSCLs

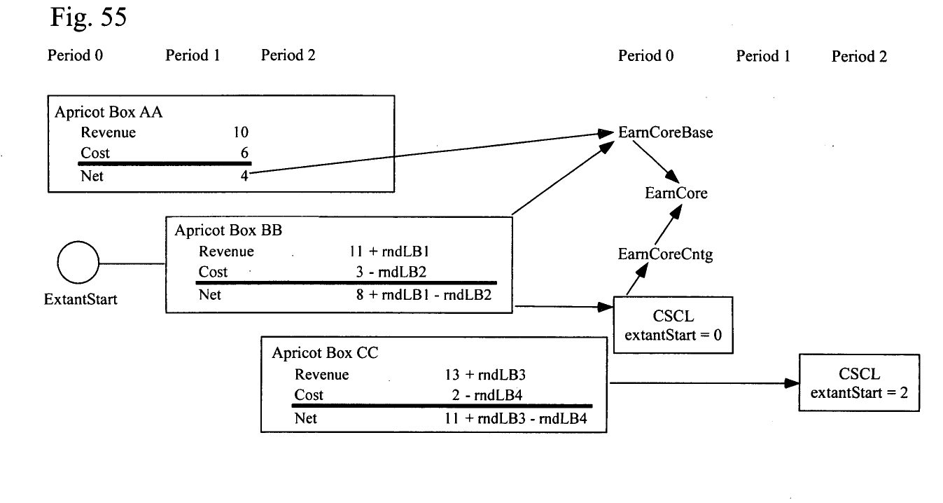

The relationships between earnCoreBase, earnCoreCntg, earnCore, and CSCLs are shown in FIG. 55. Here, where the current moment is on the border between Periods 0 and 1; suppose that:
Just a moment ago in Period 0, The Corporation purchased a Box AA of apricots and sold it. This yields a net of $4 as shown in FIG. 55.
Just a moment ago in Period 0, The Corporation made two agreements: The first is to purchase a Box BB of apricots in Period 1; the second is to sell the Box BB of apricots in Period 1. Both the purchasing and selling prices are unknown. They have mean expected values of 3 and 11 respectively. The mathematically-expected net is 8. Let rndLB1 and rndLB2 be uncertainty variates, each of which has a mean expected value of zero. Hence, the net is 8+rndLB1−rndLB2 as shown in FIG. 55.
Given a recent marketing research report, The Corporation believes that it can purchase a Box CC of apricots in Period 2 and then immediately sell it. Both the purchasing and selling prices are unknown, but have mean expected values as shown in FIG. 55. Variates rndLB3 and rndLB4 are uncertainty variates with a mean expected value of zero and zero correlation. The expected net of the Box CC of apricots transactions is 11.

In terms of earnCoreBase, earnCoreCntg, earnCore, and CSCLs, the net of the transactions regarding Box AA ($4) are included in earnCoreBase. Given that everything both stays the same and is perpetually repeated, via repeating earnCoreBase, the same transaction is repeated perpetually.

Regarding apricots Box BB, it too reflects the efforts and returns for Period 0, so consequently it is a component of earnCore and should be perpetually repeated. The net of 8 could be added to earnCoreBase and perpetually repeated that way. Another, and preferable, way is to construct a CSCL to model the apricots Box BB transaction. The advantage of this approach is that the variability of Box BB transactions affects, and makes more accurate, the final results. Another advantage is that a truer earnCoreCntg, with an associated statistical distribution, results.

As a practical matter, a CSCL does not need to simultaneously handle both legs, or the sides, of a transaction. So, for instance, regarding apricots Box BB, the purchase cost ($3) could be included in earnCoreBase (and thus reduce earnCoreBase) and the revenue simulated by a CSCL. Or the reverse could be done. So, for example, CSCL_GrantPur regards compensating employees with stock, but without any direct regards to what the employees might have contributed to The Corporation.

Regarding apricots Box CC, it does not really reflect the efforts and returns for Period 0. Apricots Box CC is simply a forecast of what might happen in Period 2. Hence, it is not included in earnCore or perpetually repeated when repeatPeriod is 0. Instead, it is included in a CSCL that has an extantStart of 2.

What is shown in FIG. 55 is a guideline for determining whether an item or transaction should be included in earnCoreBase or handled by a CSCL, and if the latter, the appropriate extantStart. A professional accountant has the knowledge to apply and extend this guideline, since determining the time period for transactions, i.e. matching, is a significant part of an accountant's standard work.

6.4.14. Comparison with BBL Model Valuation Expensing

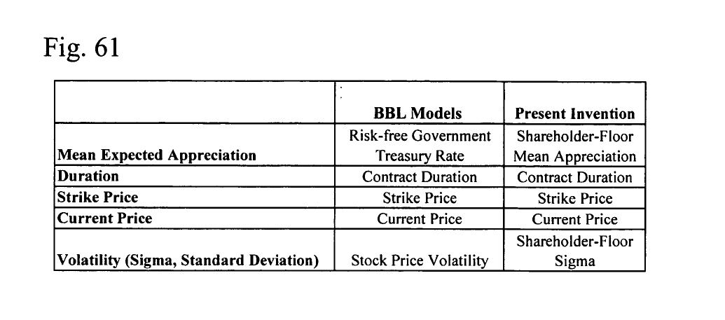

In comparison with all of the above, using the BBL Models to determine an expense is significantly different. FIG. 61 shows a comparison with respect to the five parameters of BBL Models.

The first difference regards the mean expected appreciation: the BBL Models use a risk-free interest rate, while the present invention uses Shareholder-floor mean appreciation. Though the BBL Models are unquestionably appropriate for what they attempt to accomplish—determining a no-arbitrage equilibrium between the five parameters—because of the analysis of FIGS. 2A, 2B, 2C, and 2D, arguably the risk-free interest rate is irrelevant for the Reference-shareholders and the relevant rate is Shareholder-floor mean appreciation, and in turn, mean stock-price appreciation.

With regards to strike-price and current price; there is no significant difference between the BBL Models and the present invention.

A major difference between the BBL Models and the present invention regards volatility. For convenience, assume that the strike-price equals the current price when an option is first granted, and that the stock-price has a positive expected mean appreciation. Per the BBL Models, as volatility increases from zero to infinity, option value increases from a finite quantity to infinity.

For the present invention, stock-price volatility has two impacts: the first impact is on the probability of option exercise; the second impact is, in the context of the simulation, on stock-price and in turn on the number of shares that need to be given. With the aforementioned assumptions and zero volatility, the probability of option exercise is 1.0, and the stock-price increases at a constant rate. The resulting impact on the Reference-shareholders is along the lines suggested by example cases: AEC #1, AEC #2, and AEC #3.

As volatility approaches infinity, the probability of option exercise decreases. Furthermore, as volatility approaches infinity, the simulated stock-price has a larger and larger range of possible values. Since the stock-price cannot go below zero, but yet can approach infinity, the higher volatility results in a higher average stock-price. But the higher average stock-price means that the option (CSCL) being perpetually repeated needs, on average, to cover fewer shares or a smaller proportion of The Corporation. Hence, Reference-shareholders benefit from increased volatility since such an increase both reduces the probability of option exercise and inflates the prices paid for the shares upon option exercise.

Assuming that option exercise is possible only at termination, the second major difference between the BBL Models and the present invention regards duration. Per the BBL Models, as duration increases from zero to infinity, option value increases from zero to the stock price. For the present invention, however, as duration increases from zero to infinity, the impact approaches zero: the impact itself is being pushed further and further into the future, which when discounted, ultimately leads to a null net impact for the Reference-shareholders.

If the argument in this section (6.4.14) thus far presented is accepted, then the conclusion emerges that it is inappropriate to use the BBL Models for expensing employee stock options and that instead the present invention should be used to calculate Steady-state earnings, Steady-state dividends, and other metrics disclosed here.

6.5. Example Embodiment

The present invention can operate on most, if not all, types of computer systems.

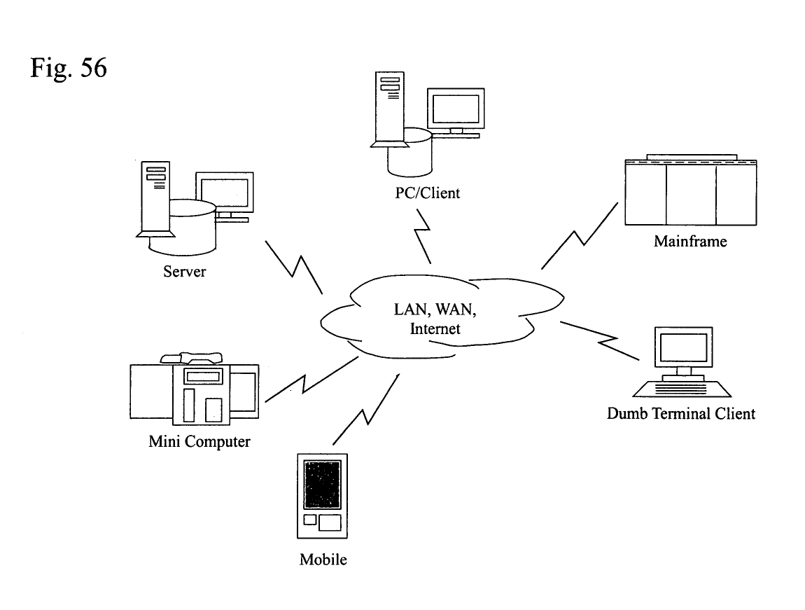

FIG. 56 shows a possible computer system, which itself is a collage of possible computer systems, on which the present invention can operate. Note that the invention can operate on a stand-alone hand-held mobile computer, a stand-alone PC system, or an elaborate system consisting of mainframes, mini-computers, and servers—all connected via LANs, WANs, and/or the Internet. The invention best operates on a computer system that provides each individual user with a GUI (Graphical User's Interface) and with a mouse/pointing device, though neither of these two components is mandatory.

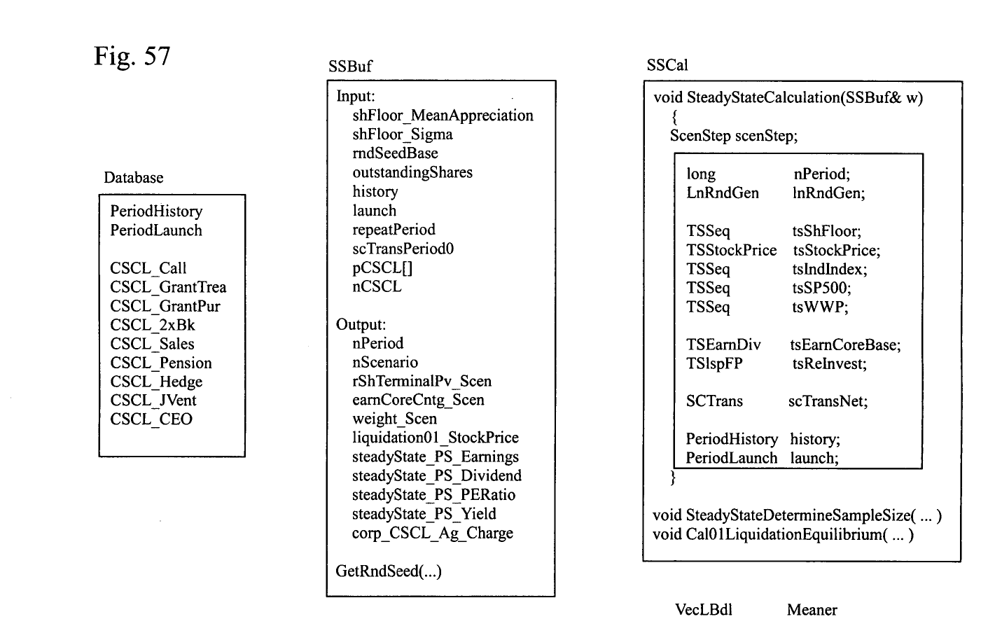

There are three major computer-system components as shown in FIG. 57: 1) a relational database that contains mainly defining parameters (specifications) for each type of CSCL, 2) a class SSBuf (Steady-state buffer) that holds input and output data, and 3) an SSCal (Steady-state calculation) module that contains the SteadyStateCalculation function, which performs, or manages, all calculations. (In reference to FIG. 14, Master-drivers-variates 1405, status-variates 1407, and one or more scTrans objects 1409 are loaded from the database and class SSBuf into objects and data structures of SSCal.)

The database contains a table for each type of CSCL as, for example, shown in FIGS. 54A and 54B. The relational database also contains a PeriodHistory and PeriodLaunch table. Sample data and fields are included with the source code. The Period History Table contains historic information that is potentially useful to the DoActivity Functions of CSCLs: The TSSeq class, for instance, can access this data in order to blend, say Raw (Actual) Appreciation from Period −5 to 0 and Arc-appreciations from Periods 0 to 6. The Period Launch Table contains specified values to launch select variates. So, for instance, it contains earnCoreBase for several periods.

(As with current accounting computer systems, in which each finance department staff member takes individual responsibility for a small part, analogously, each finance department staff member can take responsibility for one or two tables of the database of FIG. 57. Ultimately, all data needed by the present invention could be stored on the database, and all output of the present invention written to the database for subsequent processing. In this way, no one person needs to comprehend the totality of the invention's operation. Nevertheless, and this is a key benefit of the present invention, company- and economy-wide correlations are considered when determining mathematically-expected values and statistical distributions are generated for key financial numbers.)

SSBuf serves as a general input and output buffer to SSCal. Many of its data members serve as input fields; many of its other data members serve as output fields. Function GetRndSeed uses rndSeedBase to provide unique different random number seeds, in particular, for use by the CSCLs.

SSBuf in its entirety is passed to function SteadyStateCalculation by reference. Within SteadyStateCalculation, scenStep is the most important data object, and corresponds to the scenStep of FIGS. 35A and 35B.

Class VecLDbl is a general, frequently used, vector, array, 1-dimensional-container class that holds floating-point values. Elements can be accessed via a “[ ]” operator. Class Meaner accepts (notes) multiple values and then provides the mean (GetMean( )), standard deviation with n−1 (GetSD( )), standard deviation with n (GetSDInf( )), and other statistics.

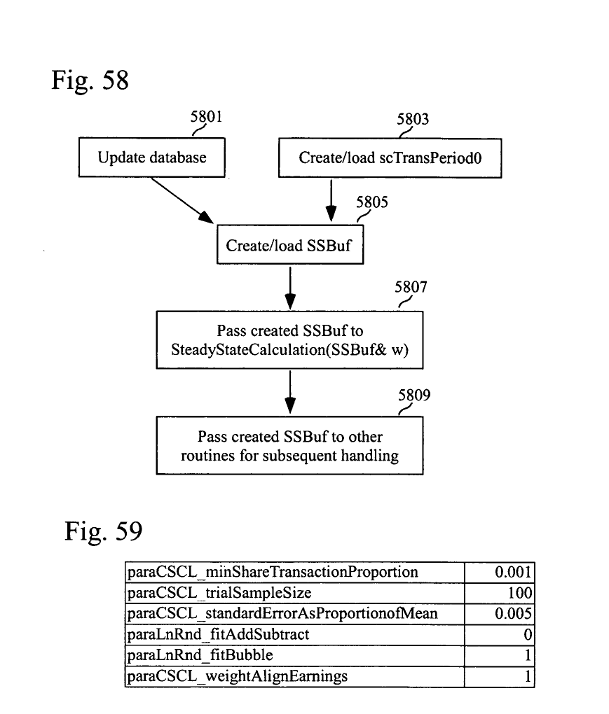

FIG. 58 shows the typical sequence that is followed to use the present invention and places FIGS. 16 and 17 in a broader context. A database (Box 5801) is first updated. So, for example, if one accounting period has passed since the last invocation of the present invention, all the extantStart and extantEnd data fields are decremented by one and new, Period 0, rows are added. So, the first row of the CSCL_Call table might be added as shown in FIG. 54A. (Ideally extantStart, extantEnd, etc. are in a YYMMDD-HHMMSS [year, month, date, hour, minute, second] format, as used in existing accounting software systems, and consequently decrementation is not needed. The Period . . . −2, −1, 0, 1, 2 . . . format is used here because it is conceptually simpler.)

An instance of SCTrans, scTransPeriod0, is created and loaded with Period 0 transaction data that is not part of either earnCoreBase or an active CSCL, nor included in the basic outstanding share count as of the start of Period 0. (See Box 5803) So, for example, if in Period 0 a k^{th} party exercised a previously granted employee stock option, then scTransPeriod0 would include such a transaction. ScTransPeriod0 is an aggregate of all such Period 0 transactions. Its purpose is three-fold. First, it allows field outstandingShares to contain the number of Reference-shares at the start of Period 0. Second, it eases the burden of updating the database. Three, it provides a sharp split between handling expiring CSCLs and handling existing and new CSCLs. So, returning to the immediate example, scTransPeriod0 allows the simple deletion of the expiring CSCL record from the database and provides a convenient means to specify the last final transactions of such an expiring CSCL.

An instance of SSBuf is created and loaded with scalar, vector, and matrix data, in addition to data from the database. (See Box 5805) Scalar data includes shFloor_MeanAppreciation, shFloor_Sigma, rndSeedBase, and repeatPeriod. Vector data includes Period 0/initial levels for the four log-normal random variates; matrix data includes log-correlations between the four log-normal random variates. (Input vector and matrix data is not shown in FIG. 57, which displays only the most salient data fields.) Database tables PeriodHistory and PeriodLaunch are directly loaded into the history and launch objects of SSBuf. For each CSCL Table record with extantStart less than or equal to repeatPeriod, a type-appropriate CSCL is created and loaded with record data. Pointers to these CSCLs are stored in array pCSCL; the number of such pointers is contained in nCSCL. (These Boxes 5801, 5803, and 5805, correspond with Box 1601 of FIG. 16.)

The SSBuf is then passed to function SteadyStateCalculation (Box 5807) by reference. SteadyStateCalculation initializes and maintains a scenStep object as each scenario is generated and considered. ScenStep contains all the data shown in FIGS. 35A and 35B, but also contains an LnRndGen object to generate Scenario-paths for the four log-normal random variates. (Some of the major fields of scenStep are shown in FIG. 57.) SteadyStateCalculation calls both SteadyStateDetermineSampleSize and Cal01LiquidationEquilibrium, respectively determining simulation sample size and Liquadation01 stock-prices. Note that the name of the passed SSBuf within SteadyStateCalculation is w—the same w that is also passed to the functions of the CSCLs as previously described. (Box 5807 corresponds to Boxes 1603 thru 1623 of FIG. 16; Box 5809 corresponds to Box 1625.)

Once SteadyStateCalculation is complete, the calling routine's SSBuf(w) contains the output of SteadyStateCalculation, the most important output being (PS, per share):
Liquidation01_StockPrice
SteadyState_PS_Earnings
SteadyState_PS_Dividend
SteadyState_PS PERatio
SteadyState_PS_Yield

Data for each scenario is also contained in SSBuf. RShTerminalPv_Scen is a vector containing each scenario's rShTerminal_PV. Weight_Scen is a vector containing scenario weights. EarnCoreCntg contains each scenario's Period 0 earnCoreCntg. EarnCoreCntg is calculated by considering only the CSCLs with extantStart equal to zero and determining the net present-value of their cash flows. NPeriod and nScenario are the results of SteadyStateDetermineSampleSize.

Corp_CSCL_Ag_Charge (Corporate CSCL Aggregate Charge) is the difference between earnCoreBase and steadyState_Ag_Earnings (Steady-state aggregate earnings). Its purpose is as follows. Though it is preferable to use and report Steady-state earnings, The Corporation's existing MIS infrastructure, along with the existing MIS infrastructure of companies that report The Corporation's financial results, might not initially be able to handle reporting steadyState_Ag_Earnings and steadyState_PS_Earnings. As a work-around (temporary fix) Corp_CSCL_Ag_Charge could be included in the P&L. It might be entered as “CSCL Activities” or “Stock-option Plan Charges.” The resulting P&L bottom line would correspond to steadyState_Ag_Earnings, which when divided by the number of outstanding-shares would yield a per share earnings that corresponds with steadyState_PS_Earnings. This steadyState_PS_Earnings, however, is likely based upon the average number of outstanding-shares in Period 0, as opposed to the number of outstanding-shares at the beginning of Period 0.

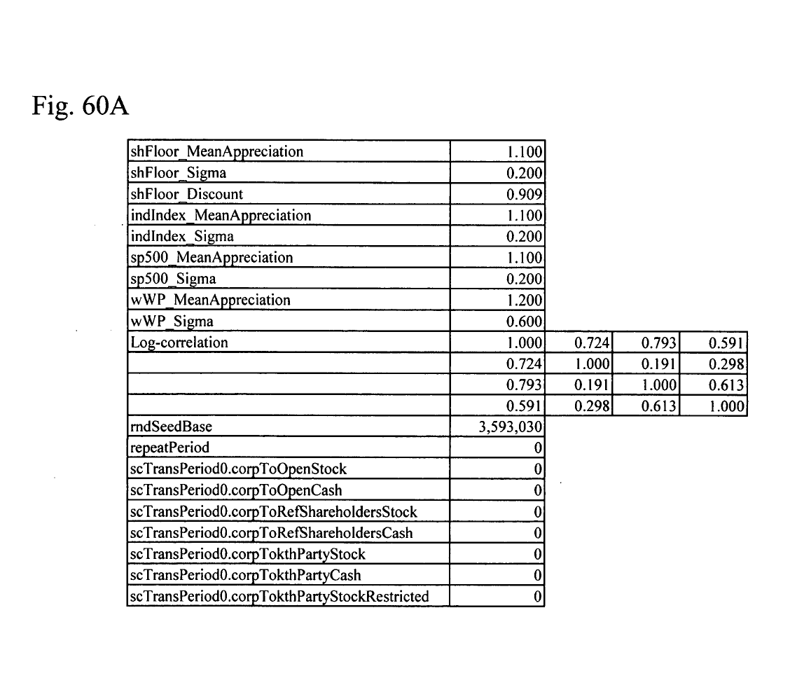

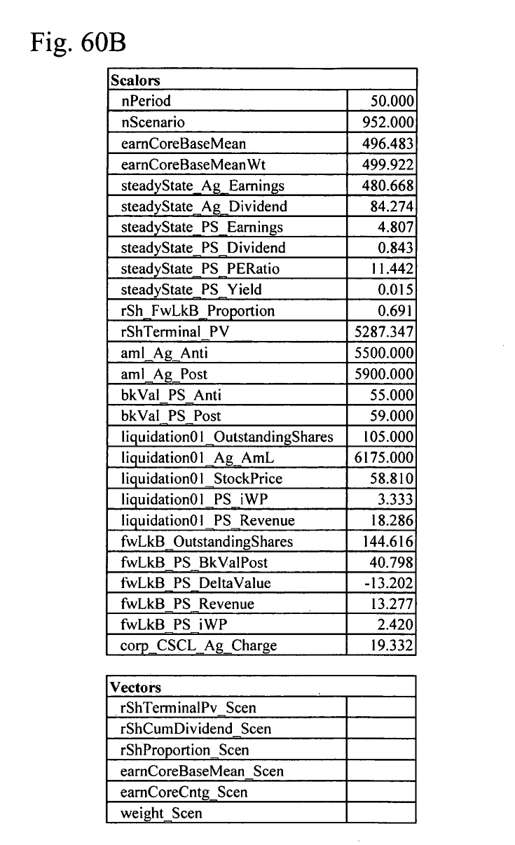

Given the output data contained in SSBuf (w), this data is passed to other routines for display, further processing, storage, or other types of handling. (See Box 5809) The display might entail printing what is shown in FIG. 60B. Further processing might entail using earnCoreCntg_Scen to create a histogram that depicts the distribution of earnCoreCntg, thus meeting a need of investors to better understand The Corporation's earning power and associated risk.

Besides what is specified in SSBuf, quasi-permanent controls are also specified via define statements. Some of these define statements, with associated values, are shown in FIG. 59:
paraCSCL_minShareTransactionProporation—tolerance for minimum needed proportion of maximum CSCL share transactions divided by outstanding-shares. See discussion regarding FIG. 41.
paraCSCL_trialSampleSize—sample size to estimate statistics that are in turn used to determine nPeriod and nScenario.
paraCSCL_standardErrorAsProportionofMean—nScenario is set such that the expected standard error of terminal value equals paraCSCL_standardErrorAsProportionofMean times the expected mean of terminal value (in the log space).
paraLnRnd_fitAddSubtract—triggers strategy to obtain correlated random numbers by adding normal deviates to working sample.
paraLnRnd_fitBubble—triggers strategy to obtain correlated random numbers by pivoting, as described with regards to FIGS. 21A and 21B.
paraCSCL_weightAlignEarnings—triggers scenario weighting, as described with regards to FIG. 44.

As an example of all of this, a trial calculation was made. An SSBuf object was loaded as shown in FIG. 60A with earnCoreBase at $500.000, with dividendCore at $100, with outstanding shares at 100, data of FIG. 19, and a CSCL_Call defined by the first row of the CSCL_Call relational-database table of FIG. 54A. This SSBuf was passed to the SteadyStateCalculations function, which had additional parameters as shown in FIG. 59. The SteadyStateCalculations function's output results are shown in FIG. 60B. SteadyStateDetermineSampleSize set the sample size as nPeriod equal to 50 and nScenario equal to 952. The 952 scenarios had a mean earnCoreBase of 496.483, instead of $500.000. After weighting, the mean becomes 499.922. Steady-state aggregate earnings and dividends are $480.668 and $84.274 respectively. A per Reference-share basis yields Steady-state earnings of $4.807 and dividends of $0.843. The per share price-to-earnings ratio and yield are as shown.

On average, at Terminal Period 50, the Reference-shareholders have a 69.1% interest in The Corporation. Average Reference-shareholder terminal value is $5287.347.

Assets minus liabilities at the start of Period 0 were $5500 and at the end were $5900, which on a per Reference-share basis is $55 and $59 respectively. Liquidation01_OutstandingShares, liquidation01_Ag_AmL, and liquidation01_StockPrice are the same as shown before in FIG. 40. Liquidation01_OutstandingShares can be used to compute Liquidation01 per share levels. So, for instance, on a per share liquidation basis, the “owned interest” in IWP and revenue is 3.333 and 18.286 respectively. These are the Period 0 levels (350.000 and 1920.000 respectively, from FIG. 35A) divided by the number of outstanding-shares at liquidation, 105.

FwLkB_OutstandingShares is 144.616 (100/0.691), which leads to a Forward/Look-back book value of 40.798 at the end of Period 0. Given the Forward/Look-back book value at the beginning of Period 0 of 55.000 (5500/100) yields a decline of 13.202 (55−40.798−1) in assets minus liabilities for the Reference-shareholders. This is a tip to the Reference-shareholders that they are foregoing $13.202 in current assets (given to the new shareholders), on the expectation that through reinvestments (of new shareholder pay-in strike-price premiums), earnings will prove to be $4.807 per share per-period.

Corp_CSCL_Ag_Charge is $19.332, the difference between earnCoreBase ($500.00) and Steady-state earnings ($480.668). As explained previously, this $19.332 could be charged to earnings (in the P&L) as “Cost of Employee Call Options” as a means of incorporating the results of the present invention into a standard accounting framework.

Besides these scalars, SteadyStateCalculation loads, for ultimate output, the following vectors. Each vector is of length nScenario and the datum in the iₜₕ position corresponds to the iₜₕ scenario:
rShTerminalPv_Scen—Reference-shareholder Terminal Present-value. Each element corresponds to the 6176.679 of Row 3541 in FIG. 35A.
rShCumDividend_Scen—Reference-shareholder Cumulative Dividend. Each element corresponds to the 664.683 of Row 3537 in FIG. 35A.
rShProportion_Scen—Reference-shareholder Proportional Ownership. Each element corresponds to the 0.855 of Row 353 in FIG. 35A.
earnCoreBaseMean_Scen—The raw mean of earnCoreBase in each scenario.
earnCoreCntg_Scen—The value of earnCoreCntg in each scenario
weight_Scen—The weight assigned to each scenario by the procedure described with regards to FIGS. 43A, 43B, and 44.

Note that the mathematical dot-product of weight_Scen with any of the other five vectors yields a weighted overall scalar. For instance, the 499.922 in FIG. 60B is the dot-product of earnCoreBaseMean_Scen and weight_Scen. The dot product of earnCoreCntg_Scen and weight_Scen is earnCoreCntg, which when added to the original inputted earnCoreBase ($500), yields earnCore.

6.6. Conclusion, Ramifications, and Scope

While the above description contains many particulars, these should not be construed as limitations on the scope of the present invention; but rather, as an exemplification of one preferred embodiment thereof. As the reader who is skilled in the invention's domains will appreciate, the invention's description here is oriented towards facilitating ease of comprehension. Such a reader will also appreciate that the invention's breadth of scope and computational performance easily can be both improved by applying both prior-art techniques and readily apparent improvements.

Many variations and many add-ons to the preferred embodiment are possible. Examples of variations and add-ons include, without limitation:

1. Many variations to the process of generating random numbers and determining Arc-appreciations are possible:
Rather than generating a stratified sample of a normal distribution (FIG. 20), a simple random sample could be drawn by using any log-normal random number generator.
Rather than pivoting elements in order to improve goodness-of-fit correlations (FIGS. 21A and 21B), normal deviations could be added to each log-normal sample prior to scaling. (This is done in the source code when paraLnRnd_fitAddSubtract is set to TRUE.)
Rather than using Arc-appreciations, Raw-appreciations could be used if the Inflated-Compounding Problem can be considered insignificant.
Rather than determining a custom Delta-shift (for each Row of FIG. 23B), a generic correction multiple could be used and directly applied to Raw-appreciation. This entails performing a simulation to estimate the generic correction multiple and then using it to convert Raw-appreciations to Arc-appreciations. So, LnRndArc:: GetArcAppreciation could be replaced with:
   long rndseed=43535;
   Meaner mm;
   for(q=0; q<simulation sample size; q++)
      mm.Note(exp(LnRndNormal(rndSeed, meanorg, sigmaOrg)));
   correction=pow(meanorg/mm.GetMean( ), iperiod−iBasePeriod);
   return GetRawAppreciation(iBasePeriod, iperiod)*correction
(Naturally, it would be desirable to save the value of meanOrg/mm. GetMean( ) for subsequent reuse. Conceivably, a generic value of meanOrg/mm. GetMean( ) could be analytically determined, thus dispensing the “for loop” shown above.)

2. In addition to tracking the interests of the Reference-shareholders, the present invention, in an analogous manner, could also track the interests of the preferred-stock shareholders. Since dividend preferences and conversions impact the Reference-shareholders, a CSCL should be created to simulate preferred-stock dividend payments and conversions, post payments to the scTrans object, which in turn posts values in scenStep, which in turn are used to tally the interests of preferred stockholders.
Furthermore, the present invention, in an analogous manner, could also track the interests of any k^{th} party.
The structure and framework presented here can easily track the interests of multiple parties simultaneously.

3. Liquidation01 could be done between Boxes 1607 and 1609, and if this is done, then scenStep data could desirably be used in DoLiquidation01. Individual scenario results could be aggregated by determining Liquidation01 means across all scenarios.
Besides determining Liquidation01, a Liquidation12 (liquidation between Period 1 and 2), Liquidation23 (liquidation between Period 2 and 3), Liquidation1011 (liquidation between Period 10 and 11), etc., could be calculated as suggested by the DoLiquidation01 function. These liquidations would be done between Boxes 1713 and 1715 of FIG. 17. Individual scenario results could be aggregated by determining scenario means.

4. There is a natural trade-off between data and logic that is hard-wired in a CSCL and the data and logic that is saved in a database table, such as the tables of FIG. 54A, and that is loaded into a CSCL. As could be expected, data and logic that is hard-wired in a CSCL is simpler to implement, but lacks future updating flexibility.

5. CSCLs can be aggregates or disaggregates. So, if The Corporation has 800 employees, and all are given stock options, all could be aggregated, stored as a single row in the database, and handled as a unit by SteadyStateCalculation. Alternatively, the 800 individual stock option plans could be handled disaggregatedly: each stored in a separate row of the database and SteadyStateCalculation would handle each individually.

6. One of the key features of the present invention is the separation of scenario data (stored in scenStep) and the simulation/reaction component handled by the CSCLs. This allows a computer programmer to focus on individual CSCLs and not be particularly concerned about the broader picture. Nevertheless, it is the philosophy here that CSCL member functions should be called so as to make all data available. Hence, frequently, the arguments of CSCL functions have included SSBuf w, and ScenStep scenStep. Conceivably, additional data could be generated within, or outside, of a CSCL for subsequent use by the same or different CSCLs.

7. Different sequencings and timings could be used. So, for instance, rather than most of the data being end-of-period, data could be beginning- or mid-period. Similarly, rather than the number of outstanding Reference-shares being based upon the number of outstanding-shares at the start of Period 0, it could be the based upon the number of outstanding-shares at the end of Period 0. Some the functioning of scenStep. OpenNextPeriod and scenStep.ClosePeriod could be shifted both within and between themselves.

8. The weighting procedure shown in FIGS. 43A and 43B can be applied to other variates, in addition to earnCoreBase. So, for example, if a priori it is expected that rShProportion, across all scenarios in the terminal period should have an arithmetic mean of, say, 0.65, then the procedure shown in FIGS. 43A and 43B could be applied to this single variate. By iteratively applying the procedure to earnCoreBase, then to rShProportion, then back-again to earnCoreBase, etc.; and each time using the previous iteration's weights when tallying bin frequencies, the resulting earnCoreBase and rShProportion means of the weighted sample will have target values. (The source code implementation has this capability to use previously defined weights.)
This is analogous to the Iterative Proportional Fitting Procedure (IPFP) used by statisticians to weight sample data. The IPFP is described in detail in PatSF.
All of this, naturally, is to reduce the variance of the sample estimates, and in turn obtain more accurate results.
Naturally, this weighting procedure can be applied to data generated by other computer simulations—that are completely separate from the present invention—to improve result accuracy.

9. The processes of generating random log-normal deviates and determining and using Arc-appreciations can, by themselves, be used in financial and other types of modeling contexts that are otherwise completely separate from the present invention.
So, for example, an insurance company may use what is described in FIG. 18, or a part of what is described in FIG. 18, in a simulation regarding a new type of insurance. Simiarly, hedge funds and others engaged in short-term trading of financial interests could use what is described in FIG. 18, or a part of what is described in FIG. 18, in a simulation regarding evaluating a strategy, pricing financial instruments, or the like. Yet similarly again, a computer simulation model regarding biological population growths could use what is described in FIG. 18, or a part of what is described in FIG. 18.
Furthermore, what is described in FIG. 18 is not limited to log-normal distributions, as discussed in point 15 below.

10. The capability of the present invention, coupled with some current publicly circulating ideas, could easily evolve and expand to overshadow the present-day accounting theory and practice and present-day computerized accounting systems.
This could result in all aspects of the P&L being modeled by CSCLs. So, for instance:
   Rather than depreciating a machine, a single, non-duplicating CSCL would model the machine: once the useful life has been reached, i.e., once aPeriod equals the end-of-life period for the machine, the CSCL would set corpTokthPartyCash equal to the replacement cost of a new machine. Afterwards, the CSCL would wait until aPeriod again equals the end-of-life period for the (replacement) machine. Then again, the CSCL would set corpTokthPartyCash equal to the replacement cost of a new machine. This processing of waiting until aPeriod equals the end-of-life period for the (replacement) machine, then setting corpTokthPartyCash equal to the replacement cost of a new machine, then waiting again, is perpetually repeated. The advantage of this approach is eliminating the debate about the type of depreciation to use, i.e., straight-line versus accelerated, and accurately modeling cash flow.
   Leases would also be handled by a CSCL: the CSCL would model lease payments by appropriately setting corpTokthPartyCash, would model decisions to exercise purchase rights and renew leases, and would appropriately set corpTokthPartyCash to reflect decisions to exercise purchase rights and renew leases.
   As appropriate, ScenStep would contain additional useful data. For example, a data field might be the tally of machine usage. One type of CSCL might set and increment this field depending upon a machineConsumption variate. This data field in turn might be used by another CSCL to determine when to replace the machine—along the lines as described above.
   Rather than computing discounted present-values of a contingent transaction and including the net result in earnCoreBase, the transaction's cash increments and decrements would be modeled by a CSCL, which would appropriately set corpTokthPartyCash depending upon iPeriod and in turn aPeriod.
   A CSCL would handle financing expenses: floating interest rates would be modeled using the log-normal random capability as previously discussed. A CSCL would, depending upon the aPeriod 's interest rates, appropriately set corpTokthPartyCash. (Arguably, this type of CSCL should not be used when repeatPeriod is 0. This is because a change in interest rates is not consistent with the ideal of constancy in Perpetual-repetition. However, this type of CSCL would be very appropriate when repeatPeriod is greater than 0, since the focus in such a situation is upon forecasting.)
   A CSCL would handle all other components that would otherwise be used to tally earnCoreBase.
Given that the present invention is handling the P&L function, the balance sheet is thus free to be generated by mark-to-market procedures. (In time, the current, generally used, definition of corporate net income might evolve to become the present invention's definition of earnCore.)
Note that a possible desirable result of this is to have the value of a financial hedging derivative shown at the current market value on the balance sheet, and have the distribution of Steady-state earnings reflect the benefits of the derivative to hedge business risks.

11. Besides what is shown in FIG. 60B and what is contained in SSBuf, as each period of each scenario is being generated and considered, in-process results could be passed to other routines for display, further processing, storage, or other types of handling. In particular, all the data of FIGS. 35A and 35B could be passed to other routines.
One particularly worthwhile further processing function is to tally scTrans.corpToOpenCash, scTrans.corpToRefShareholderCash, and scTrans.corpTokthPartyCash (when the CSCL that loads the scTrans object has an extantStart that is less than or equal to repeatPeriod) to create a cash flow report with results by period; in terms of mean and variance, or another statistical distribution.
An industry consortium is presently defining the Extensible Business Report Language (XBRL) to allow electronic financial reporting and downloading. All and any results of the present invention could be included in XBRL, thus allowing custom evaluation of the invention's results.
Another variation on this is to have The Corporation provide interested parties with an SSBuf containing appropriate data. The interested party would then edit the SSBuf as deemed appropriate and would use the present invention to calculate Steady-state earnings, etc.
Yet another variation is to have interested parties, i.e., investors and investment advisors, assemble SSBuf data from public sources and their own guess-estimates (“guesstimates”) and then use the present invention for their own private analysis.

12. Extraordinary earnings and charges, e.g., merger-and-acquisition costs, should be included in a CSCL that sets scTransNet.corpToOpenCash to the appropriate value only when aPeriod equals 0. This desirably results in Steady-state earnings, etc. appropriately encompassing extraordinary earnings and charges.

13. EarnCoreBase as described above is assumed to include the appreciation of assets, such as the real estate The Corporation might own for its office buildings. Rather than including the appreciation in earnCoreBase, an alternative is to generate a Scenario-path for real estate value, (i.e., a Scenario-path like shown in rows 3503, 3507, and 3509 of FIG. 35A), whose appreciation from the start of Period 0 is then included in termValWhole. This is considered here less desirable, since if the appreciation of the asset is different from sh_FloorAppreciation: A) the results become contingent upon nPeriod, and B) the requirement/assumption that The Corporation shall operate at Point 201 is compromised. (Naturally, the appreciation of assets, such as the real estate, does not necessarily need to be included in the calculations. Such an exclusion might be done in order to focus specifically on operating performance.)

14. Though described and required in the preferred embodiment above, technically shFloor can be disregarded in some special situations/implementations of the present invention. Furthermore, conceivably, a special implementation of the present invention could entail no Master-driver-variates. This could occur, for instance, if all earnings are paid as dividends and if no cash is transferred between The Corporation and any other party. Other variation entails combinations of the following:
EarnCoreBase could be set to a constant—thus dispensing with using shFloor to generate random earnCoreBases;
Each CSCL could use its internal rndSeed, autonomously generate random numbers, and set scTrans values based upon the generated random numbers—thus dispensing with needing Master-driver-variates variates;
ShFloor_Sigma could be set to zero—thus trivializing shFloor to become a constantly increasing variate;

15. Rather than generating a single sample of nPeriod elements, LnRndBase could generate a fractional sample of say nPeriod/4 elements, which in turn would be concatenated to itself to yield a sample of nPeriod elements, which in turn would be randomly ordered. This reduces the bias that TSlspFP corrects: if the fractional sample is sufficiently small relative to nPeriod, then TSlspFP can be replaced with TSlsp.
At an extreme, the smallest fractional sample consists of two elements, which results in Scenario-paths being identical to Scenario-paths of binary trees, but with forced mean reversion. Class LnRndGen could include capability to generate all Scenario-path permutations of binary trees with mean reversion, and nScenaro set so that all such permutations are considered.
Alternatively, rather than generating a fractional sample of nPeriod elements, a meta sample of say nPeriod*4 elements could be generated, which in turn would be randomly ordered, which in turn would be truncated to yield a final sample of nPeriod elements.
Other types of theorical statistical distributions, besides the log-normal distribution that has been the focus here, could become the basis for variations on classes LnRndBase, LnRndGen, and LnRndArc. Besides theorical statistical distributions, empirical distributions could be used: direct empirical data could be sampled and randomly ordered and handled/used analogously to what has been described here as regards to log-normal variates, though possibly with some adaptation.
Whatever the distribution, Arc-appreciations may need to be calculated if the Inflated-Compounding Problem, or perhaps a “Deflated-Compounding Problem”, is an issue. The basis for Arc-appreciations depends upon the basis for the nPeriod deviates:
   If a fractional sample is concatenated to generate nPeriod deviates, then Arc-appreciation needs to be based upon all nPeriod deviates;
   If a meta sample is used, then Arc-appreciation needs to be based upon all deviates of the meta sample;
   If an empirical distribution is used, then Arc-appreciation needs to be based upon all elements of the empirical distribution.
Using some distributions, Arc-appreciation calculation may not even entail transformations between log and Factor formats of the same fundamental deviates, but rather other transformations. At the simplest level, this could entail simply scaling the deviates to have higher and lower mean values as the Arc-appreciation calculation proceeds. No transformation would be required for a uniform distribution. Naturally, the transformation depends upon the distribution.

16. Other types of statistical distributions can be used to generate Master-driver-variates. In other words, Master-driver-variates do not always need to be log-normally distributed. So, for example, a uniform distribution might be used to represent the occurrence of an important event, such as weather temperatures. (The procedure to generate correlated random normal deviates can easily handle deviates obtained from non-normal distributions: initial deviates would simply be drawn from the non-normal distributions.)

17. Multiple scenarios could be optimized by using Patent '123 and the results used as input for the present invention. Increments to WI-Cash for each period and each scenario could be determined and used to launch earnCoreBase as described here. As appropriate, period variate levels generated by Patent '123 could also be used to launch Scale-variates of the present invention.

18. CorpScalePrice could be set based upon earnCore, rather than earnCoreBase. This would entail making a preliminary execution of SteadyStateCalculation, setting:
earnCoreAggregate=earnCoreBase+dot-product of weight_Scen and earnCoreCntg_Scen
and using the resulting earnCoreAggregate, rather than earnCoreBase, to determine CorpScalePrice.

19. Besides handling equity-based compensation that might be considered an accounting expense, i.e., giving employees stock options for work done, the present invention could also handle equity-based compensation that might be considered an accounting capital expenditure. So, for example, if The Corporation obtains new machinery by giving the machine supplier stock in The Corporation, a CSCL could model such a transaction: after the useful life has expired, the CSCL would trigger an equal type (stock) and value (stock value) transaction, thus simulating replacing machines in Perpetual-repetition on the same terms.

20. ScenStep, CSCLs, and/or scTrans could consider taxes that The Corporation would need to pay each period of each scenario. Such tax consideration could result in a reduction of reinvestment.

21. Option repricing, sometimes termed bailouts, can and should be handled by the CSCLs. As of this writing, many companies will reset the strike-price of employee stock options if the strike-price is too much above the current market stock price, i.e., if the options are underwater. Such repricing constitutes an aspect of the contract, and consequently, should be handled by a CSCL. At a most simplistic level, this could entail the DoActivity function resetting strikePrice equal to stockPrice, when the former is, say, 20% less than the latter. At a more advanced level, the resetting could be contingent upon a Scale-variate. Additionally, to model the possible, but not certain, repricing decision by The Corporation, the CSCL 's random number seed could be used to simulate repricing decisions.
When the terms of a contract modeled by a CSCL are changed, the CSCL should be updated/corrected and possibly previous calculations redone and results reported/restated.

22. The ScenStep object could include the capability to interpolate between end-period stock prices. Such interpolated results would then be made available to the CSCLs to do modeling on a finer time-gradation. So, for example, Periods 0, 1, 2, etc. could be based upon a time unit of a calendar quarter. ScenStep could note the stock-price appreciation between periods, covert sh_Floor_Sigma to a daily value, randomly generate intra-period stock prices that are both scaled to have the calculated daily sigma and that begin and end with the aPeriod 's starting and ending stock prices. The CSCLs could, in turn, base calculations upon, for example, the stock prices of the 37^{th} day of the quarter. The benefit of basing calculations on the 37^{th} day of the quarter is that the CSCL model accuracy is improved.

23. Conceivably in some situations dividendCore could be negative. This might occur, for instance, if The Corporation were actually a partnership and the partners were required to make a cash infusion on a pro-rated basis. The logic presented above can handle such a negative dividendCore.

24. Though perhaps not explicit in the above, each and every variate of each scenario can be stored and passed to subsequent routines for further processing, in particular, display as histograms in order to provide investors and others with a sense of risk/variance as regards each and every variate. Each scalar of FIG. 60B, except for the first four listed, in particular steadyState_PS_Earnings and steadyState_PS_Dividends, could be calculated on a scenario by scenario basis, stored, and passed to subsequent routines for further processing, in particular, displayed as histograms in order to provide investors and others with a sense of risk/variance/statistical distribution.

25. The weighting procedure disclosed in FIG. 44 could be applied utilizing other distributions, for example the uniform distribution.

26. Though the present disclosure is based upon object oriented programmng, it could be implemented using a non-object oriented programming language, such as Fortran 66. CSCLs would still be duplicated, for instance, by copying original CSCLs to unused array space.

Furthermore, as the reader who is skilled in the invention's domains will appreciate, public policy, as dictated by either legislators and/or accounting boards, may eventually prescribe how the present invention is implemented and used. Such policy might not be directly aligned with the invention as presented here, but would nevertheless constitute a variation to the preferred embodiment of the present invention. (Though not recommended here, public policy might, for instance, require the use of the risk-free interest rate for shFloor_MeanAppreciation.)

1: A computer system comprising:
means for using data regarding a Company in least at one accounting period; said data including data regarding equity interests in said Company, said equity interests held by said Company's equity-interest holders;
means for modeling at least one scenario comprising at least one repetition of said Company's said at least one accounting period;
means for modeling in said at least one scenario changes in equity interests;
means for tracking said at least one scenario interests of at least one of said Company's equity-interest holders; and
means for making available for subsequent use at least some of said tracked interests of said at least one of said Company's equity-interest holders.

2: A computer system comprising:
means for using data regarding a Company in least at one accounting period; said data including specifications data regarding at least one of the following:
contingent future cash receivables,
contingent future cash payables;
means for generating at least one random value for at least one variable;
means for modeling at least one scenario comprising a time-serial sequencing of at least one accounting period;
means for loading at least some of said specifications data into at least one CSCL object; said at least one CSCL object includes means to determine at least one cash transfer affecting said Company;
means for duplicating and orienting said least one CSCL object;
means for tracking said at least one scenario interests of at least one entity; and
means for making available for subsequent use at least some of said tracked interests of said at least one entity.

3: A computer system comprising:
means for using parameters for a statistical distribution;
means for generating a sequence of random numbers based upon said parameters of said statistical distribution;
means for determining an Arc-appreciation value; and
means for making available for subsequent use at least one Arc-appreciation value.

4: A computer system comprising:
means for accessing a set of numerical values;
means for determining a statistical distribution of said set of numerical values;
means for obtaining a target statistical mean for said set of numerical values;
means for determining weights for each value of said set of numerical values, said set of numerical values, with application of said weights, having:
a mean approximately equal to said target statistical mean,
a statistical distribution that approximately equals said determined statistical distribution; and
means for making available for subsequent use said determined weights of said each value of said set of numerical values.

5: A computer system comprising:
means for accessing data regarding equity interests in a Company;
means for accessing specifications regarding rights and obligations of k^{th} parties in the event that said Company is liquidated; said rights and obligations include at least one of the following:
rights to purchase stock,
obligations to forfeit stock,
rights and obligations that are contingent upon liquidation per share price;
means for obtaining an estimated value of net assets of said Company;
means for estimating an equilibrium per share clearing price that would be paid in the event said Company is liquidated; and
means for making available for subsequent use said equilibrium per share clearing price.

6: The computer system of claim 1, further comprising means for determining and for making available for subsequent use at least one of the following:
a earnCoreBaseMean scalar,
a earnCoreBaseMeanWt scalar,
a steadyState_Ag_Earnings scalar,
a steadyState_Ag_Dividend scalar,
a steadyState_PS_Earnings scalar,
a steadyState_PS_Dividend scalar,
a steadyState_PS_PERatio scalar,
a steadyState_PS_Yield scalar,
a rSh_FwLkB_Proportion scalar,
a rShTerminal_PV scalar,
a liquidation01_OutstandingShares scalar,
a liquidation01_Ag_AmL scalar,
a liquidation01_StockPrice scalar,
a liquidation01_PS_iWP scalar,
a liquidation01_PS_Revenue scalar,
a fwLkB_OutstandingShares scalar,
a fwLkB_PS_BkValPost scalar,
a fwLkB_PS_Delta Value scalar,
a fwLkB_PS_Revenue scalar,
a fwLkB_PS_iWP scalar,
a corp_CSCL Ag_Charge scalar,
a earnCoreCntg scalar,
a earnCore scalar,
a rShTerminalPv_Scen vector,
a rShCumDividend_Scen vector,
a rShProportion_Scen vector,
a earnCoreBaseMean_Scen vector,
a earnCoreCntg_Scen vector,
a weight_Scen vector.

7: The computer system of claim 2, further comprising means for determining and for making available for subsequent use at least one of the following:
a earnCoreBaseMean scalar,
a earnCoreBaseMeanWt scalar,
a steadyState_Ag_Earnings scalar,
a steadyState_Ag_Dividend scalar,
a steadyState_PS_Earnings scalar,
a steadyState_PS_Dividend scalar,
a steadyState_PS_PERatio scalar,
a steadyState_PS_Yield scalar,
a rSh_FwLkB_Proportion scalar,
a rShTerminal_PV scalar,
a liquidation01_OutstandingShares scalar,
a liquidation01_Ag_AmL scalar,
a liquidation01_StockPrice scalar,
a liquidation01_PS_iWP scalar,
a liquidation01_PS_Revenue scalar,
a fwLkB_OutstandingShares scalar,
a fwLkB_PS_BkValPost scalar,
a fwLkB_PS_Delta Value scalar,
a fwLkB_PS_Revenue scalar,
a fwLkB_PS_iWP scalar,
a corp_CSCL_Ag_Charge scalar,
a earnCoreCntg scalar,
a earnCore scalar,
a rShTerminalPv_Scen vector,
a rShCumDividend_Scen vector,
a rShProportion_Scen vector,
a earnCoreBaseMean_Scen vector,
a earnCoreCntg_Scen vector,
a weight_Scen vector.

8: The computer system of claim 2, further comprising means for determining an Arc-appreciation value.

9: The computer system of claim 3, wherein said statistical distribution is one of the following:
a log-normal statistical distribution,
an empirical statistical distribution,
a uniform statistical distribution.

10: The computer system of claim 4, wherein said statistical distribution is one of the following:
a log-normal statistical distribution,
a uniform statistical distribution.

11: A computer implemented method comprising:
using data regarding a Company in least at one accounting period; said data including data regarding equity interests in said Company, said equity interests held by said Company's equity-interest holders;
modeling at least one scenario comprising at least one repetition of said Company's said at least one accounting period;
modeling in said at least one scenario changes in equity interests;
tracking said at least one scenario interests of at least one of said Company's equity-interest holders; and
making available for subsequent use at least some of said tracked interests of said at least one of said Company's equity-interest holders.

12: A computer implemented method comprising:
using data regarding a Company in least at one accounting period; said data including specifications data regarding at least one of the following:
contingent future cash receivables,
contingent future cash payables;
generating at least one random value for at least one variable;
modeling at least one scenario comprising a time-serial sequencing of at least one accounting period;
loading at least some of said specifications data into at least one CSCL object; said at least one CSCL object determines at least one cash transfer affecting said Company;
duplicating and orienting said least one CSCL object;
tracking said at least one scenario interests of at least one entity; and
making available for subsequent use at least some of said tracked interests of said at least one entity.

13: A computer implemented method comprising:
using parameters for a statistical distribution;
generating a sequence of random numbers based upon said parameters of said statistical distribution;
determining an Arc-appreciation value; and
making available for subsequent use at least one Arc-appreciation value.

14: A computer implemented method comprising:
accessing a set of numerical values;
determining a statistical distribution of said set of numerical values;
obtaining a target statistical mean for said set of numerical values;
determining weights for each value of said set of numerical values, said set of numerical values, with application of said weights, having:
a mean approximately equal to said target statistical mean,
a statistical distribution that approximately equals said determined statistical distribution; and
making available for subsequent use said determined weights of said each value of said set of numerical values.

15: A computer implemented method comprising:
accessing data regarding equity interests in a Company;
accessing specifications regarding rights and obligations of k^{th} parties in the event that said Company is liquidated; said rights and obligations include at least one of the following:
rights to purchase stock,
obligations to forfeit stock,
rights and obligations that are contingent upon liquidation per share price;
obtaining an estimated value of net assets of said Company;
estimating an equilibrium per share clearing price that would be paid in the event said Company is liquidated; and
making available for subsequent use said equilibrium per share clearing price.

16: The computer implemented method of claim 11, further comprising determining and making available for subsequent use at least one of the following:
a earnCoreBaseMean scalar,
a earnCoreBaseMean Wt scalar,
a steadyState_Ag_Earnings scalar,
a steadyState_Ag_Dividend scalar,
a steadyState_PS_Earnings scalar,
a steadyState_PS_Dividend scalar,
a steadyState_PS_PERatio scalar,
a steadyState_PS_Yield scalar,
a rSh_FwLkB_Proportion scalar,
a rShTerminal_PV scalar,
a liquidation01_OutstandingShares scalar,
a liquidation01_Ag_AmL scalar,
a liquidation01_StockPrice scalar,
a liquidation01_PS_iWP scalar,
a liquidation01_PS_Revenue scalar,
a fwLkB_OutstandingShares scalar,
a fwLkB_PS_BkValPost scalar,
a fwLkB_PS_Delta Value scalar,
a fwLkB_PS_Revenue scalar,
a fwLkB_PS_iWP scalar,
a corp_CSCL Ag_Charge scalar,
a earnCoreCntg scalar,
a earnCore scalar,
a rShTerminalPv_Scen vector,
a rShCumDividend_Scen vector,
a rShProportion_Scen vector,
a earnCoreBaseMean_Scen vector,
a earnCoreCntg_Scen vector,
a weight_Scen vector.

17: The computer implemented method of claim 12, further comprising determining and making available for subsequent use at least one of the following:
a earnCoreBaseMean scalar,
a earnCoreBaseMean Wt scalar,
a steadyState_Ag_Earnings scalar,
a steadyState_Ag_Dividend scalar,
a steadyState_PS_Earnings scalar,
a steadyState_PS_Dividend scalar,
a steadyState_PS_PERatio scalar,
a steadyState_PS_Yield scalar,
a rSh_FwLkB_Proportion scalar,
a rShTerminal_PV scalar,
a liquidation01_OutstandingShares scalar,
a liquidation01_Ag_AmL scalar,
a liquidation01_StockPrice scalar,
a liquidation01_PS_iWP scalar,
a liquidation01_PS_Revenue scalar,
a fwLkB_OutstandingShares scalar,
a fwLkB_PS_BkValPost scalar,
a fwLkB_PS_Delta Value scalar,
a fwLkB_PS_Revenue scalar,
a fwLkB_PS_iWP scalar,
a corp_CSCL_Ag_Charge scalar,
a earnCoreCntg scalar,
a earnCore scalar,
a rShTerminalPv_Scen vector,
a rShCumDividend_Scen vector,
a rShProportion_Scen vector,
a earnCoreBaseMean_Scen vector,
a earnCoreCntg_Scen vector,
a weight_Scen vector.

18: The computer implemented method of claim 12, further comprising determining an Arc-appreciation value.

19: The computer implemented method of claim 13, wherein said statistical distribution is one of the following:
a log-normal statistical distribution,
an empirical statistical distribution,
a uniform statistical distribution.

20: The computer implemented method of claim 14, wherein said statistical distribution is one of the following:
a log-normal statistical distribution,
a uniform statistical distribution.
